(19) United States
(12) Patent Application Publication
(10) Pub. No.: US 2010/0185967 A1
(43) Pub. Date: Jul. 22, 2010

(54) Information Processing Device, and File Managing Method

(76) Inventor: Masatsugu Noda, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 11/992,774

(22) PCT Filed: Sep. 29, 2006
(86) PCT No.: PCT/JP2006/319600

§ 371 Date: Mar. 31, 2010

(30) Foreign Application Priority Data
Sep. 29, 2005 (JP) 2005-284462

(51) Int. Cl. G06F 3/048

(52) U.S. Cl. 715/770

(57) ABSTRACT

Problem

The object is to provide a method wherein in a file managing method using a composite file managing table form generated by combining a plurality of table formats hierarchically wherein users cannot figure visibly the totality of stored files, while they can manage the files without a restriction of the number of managing item names, users can fetch and store icons of managed files speedily with little effort of user operation and further can reconstruct the hierarchical constitution freely and speedily with good man-machine interface.

Means to Solve Problem

Provided with the method wherein after setting a cell included in a composite file managing table form as the first “existing cell”, the following steps is repeated as far as the next “disposing table form” described below can be obtained,
recognizing for the “existing cell”, related data, that is, data to be referenced concurrently with the data in said cell on the table form on which said cell exists, on said table form based on a disposing rule of entered data;
recognizing a “disposing table form” and a “disposing cell” therein into which the icon of the file data representing the table form on which the “existing cell” exists, is pasted;
setting the recognized “disposing cell” as the new “existing cell”;
   the product of related data obtained for the corresponding cell on each execution of the sequence is recognized as the total related data of said composite file managing table form, and the icons stored thereon are copied onto another file managing table form or composite file managing table form, or icons stored on another file managing table form or composite file managing table form, are copied onto said composite file managing table form, by comparing the total related data obtained for each constituent cell between the both file managing table forms.

### TECHNICAL FIELD

The invention relates to an information processing apparatus which manages many files or folders using a table form in a desktop environment.

### BACKGROUND ART

In the field of the computer application technique, a lot of data which share same attribute items or same data constitution are generated on hand by users in general and so it has been a important problem that user can store or manage these many similar files as easily to retrieve as possible. In addition, with the notable prevalence of digital image recording products in recent years, the application of managing or storing much files information easy to retrieve spreads increasingly.

Recently as the method of managing many files in a desktop environment which has prevailed nearly as the standard end-user environment, we use usually the method wherein we paste an icon representing a file to a position corresponding to the attribute parameters of the file on a table form provided in a screen of a display. We can recognize the corresponding attribute parameters of the file obviously at a glance on a table form, and can retrieve files of desired attribute parameters by designating in block a row or a column on a table form.

But as the problem of the method of managing files by using a table form, the number of attribute items to be disposed on a table form is restricted while the number of attributes by which a file data is described is many intrinsically.

We use much what is called “many columns” table form wherein each data-field corresponding to each attribute item is disposed in parallel rows or columns in the top part or in the leftmost part of a table form and each data-field at a right or lower position in parallel rows or columns is disposed repeatedly corresponding to each data belonging to a data-field at the adjacent left or upper position. But the application of the “many columns table form” is restricted in itself owing to the large size which resulting from the disposition wherein a whole data-field of an item is repeated corresponding to one data of another item.

As the method wherein we can manage files without the restriction of the number of attribute items, we can find a method using a hierarchical composition of table forms. Therein first we assign an specific icon to a table form on which icons of files that are objects to manage or restore are pasted, next we can paste the icon of the table form on another table form, attribute items disposed on the both table forms being different each other, and in that way we repeat the process of pasting an icon of a table form on another table form. That is to say, in the hierarchical composition the plural table forms are disposed in a tree form and icons of objects to manage or restore are disposed on the lowest table forms. In the patent specification the set of the table forms combined by the hierarchical composition is called hierarchical table form for file managing or composite table form for file managing.

The method of the hierarchical composition of table forms enables the file management without the restriction of the number of attribute items by disposing different items on each hierarchy level. But therein at the same time, in the case where attribute items which a user is concerned in and so wishes to use as the key item to retrieve the stored object files are disposed on a table form of lower level, the user are compelled to open all the corresponding table forms of lower level by repeating the icon click operations from the click on the top table form

Therefore the selection of stored or managed object information at a glance utilizing the characteristics of a table form above mentioned is possible only on a single table form. When using the composite table form for file managing, the apparentness or plainness which is the aim of the file management method utilizing table form is lost, and in reversal user operation which take a lot of time and effort is inevitable.

For instance in the case of file management where an icon of stored object information is pasted on a table form illustrated in FIG. 6 mentioned later and an icon of the table form illustrated in FIG. 6 is pasted on a table form illustrated in FIG. 5 mentioned later, if a user wishes to retrieve object information by “BRANCH” and “YEAR” as key items, the user can perform it only by operation of selecting icons on the table form illustrated in FIG. 5, but if desired key items include “DESTINATION” or “QUARTER”, the user is compelled to open all table forms illustrated in FIG. 6 by clicking all icons on the table form of top level illustrated in FIG. 5 and subsequently to select the desired files in each opened table form.

Items which a user wishes to use as keys in retrieving stored files are not necessarily disposed on the table form of the top level and it is usual that the disposal of items on table forms of each level depends on user' s application and interest on demand. Therefore in the file management method using the hierarchical composition of table forms, at first it is desired as a basic requirement that desired file is retrieved easily and speedy irrespective of key items for retrieving stored files. Furthermore at the same time when files are stored in a composite table form for file managing, the operation is easy and speedy, needless to say.

Furthermore in the case where many icons of desired condition are retrieved from composite table form for file managing, it is desired that the group of icons are retrieved not in the form of a set as it is, but in the form where each icon is disposed, its attribute being obvious at a glance.

Furthermore, it is desired that files can be stored in a composite table form for file managing so that they can be retrieved some time from it as more viewpoints as possible

Furthermore when retrieving desired files in the form of a table form, it is desired that they can be retrieved easily on a table form representing anew angle or a new viewpoint needed on demand, that is, on a table form on which a set of items are disposed, the set of items not being necessarily same as each set of items which is assigned to a table form of each level of the present composite table form.

Furthermore with regard to a whole of a composite table form, it is desired that the whole constitution of it can be freely changed according to current interest and viewpoint of user, for instance, the level of constituent table forms can be replaced freely, or attribute items assigned to a table form of each level can be changed freely etc. Needless to say, these operations must be easily and speedy as end-user operation.

Furthermore it is required regarding the user freedom in handling a composite table form for file managing that table forms constituting a part of it can be taken out freely from the whole composite table form to store in another place or to incorporate in another composite table form

On a table form, icons of files are usually sorted according the attribute data related to each files as daily job in the present art, for instance we sort them according to the date in which a file is generated. But there is no precedent example where icons are reallocated on a table form in which a new set of attribute items are disposed, the set of attribute items being different from the set of attribute items assigned to the original table form.

Furthermore we can find the example wherein files managed by a composite file managing table form as above described, are rearranged on a different table form or on a

To require the purpose above mentioned using present technique, it is required to repeat coping a icon stored in a first table form to a desired position in a destination table form one by one, which is operation of lot of effort and trouble.

### DISCLOSURE OF THE INVENTION

### Problem to be Solved by the Invention

The object of the invention is to propose the method wherein files stored in a composite file managing table form of hierarchical constitution are easily retrieved whatever key items for retrieving are, and files provided with key data are easily stored easily and speedily in a composite file managing table form described above whatever key items provided therein are.

The another object of the invention is to propose the method wherein files with desired conditions can be retrieved with attributes of the icons recognized at a glance among icons representing files stored in a composite table form.

The another object of the invention is to propose the method wherein in storing files into a composite file managing table form they can be stored in the way where they can be retrieved from more viewpoints in retrieving them again.

The another object of the invention is to propose the method wherein a plurality of file managed by a first composite file managing table form can be rearranged easily and speedily on another second composite file managing table form composed of table forms on which a new set of item names are disposed different from the set of item names disposed on each table form constituting the first composite file managing table form, or table forms on which a new set of item names are disposed.

The another object of the invention is to propose the method wherein a table form constituting a composite file managing table forms can be fetched freely out of the composite file managing table form, and can be managed composed freely each other outside of the composite file managing table form, so that table forms constituting a composite file managing table form, can be handled independently and freely with good man-machine interface.

The another object of the invention is to propose the method wherein a composite file managing table form can be created and reallocated speedily with good visibility for users.

### Means to Solve the Problem

In order to achieve the above objects, a method in an information processing apparatus according to the invention as defined in claim 1 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;

said method comprising the steps of:

repeating a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;

recognizing the sum of the related data recognized on each file managing table form followed as above, as the total related data to be referenced as the attribute of an icon in said cell selected first;

recognizing the cell on a second file managing table form specially provided into which an icon in said cell designated first on said hierarchical file managing table form is to be copied or moved, or the cell on said second file managing table form an icon in which is to be moved or copied into said cell on said hierarchical file managing table form,

by comparing the total related data above recognized with related data recognized for each cell within the icon disposing field on said second file managing table form; and

copying or moving said icon between said cell on said hierarchical file managing table form and said cell on the second file managing table form.

The method in the information processing apparatus according to the invention as defined in claim 2 is the method of claim 1, comprising the steps of:

recognizing the total related data for each icon recognized sequentially in a first hierarchical file managing table form, that represents file information other than those of the type of file managing table form;

recognizing the total related data for each cell within the icon disposing field of each file managing table form of the lowest layer in a second hierarchical file managing table form, recognized sequentially; and

copying or moving said icon from said first hierarchical file managing table form into said second hierarchical file managing table form.

The method in the information processing apparatus according to the invention as defined in claim 3 is the method of claim 1, comprising the steps of:

recognizing the total related data for each icon recognized sequentially in a first hierarchical file managing table form, that represents file information other than those of the type of file managing table form;

setting the top file managing table form of a second hierarchical file managing table form provided in addition as the icon disposing destination, as the “existing file managing table form” that is a processing target of the following steps;

judging if the set of item names constituting the related data defined on the “existing file managing table form” is not included by the set of item names constituting the total related data for an icon on said first hierarchical file managing table form;

if the above judgment is not obtained, reading index words for each cell within the icon disposing field of the “existing file managing table form” as the related data of an icon disposed in said cell based on a determined rule;

recognizing subsequently on the “existing file managing table form” a cell each related data for which includes the corresponding related data of the same item name for an icon of the first hierarchical file managing table form;

fetching subsequently as the “existing file managing table form”, the “child” file managing table form the icon of which is disposed in said recognized cell;

returning subsequently to the above judgment; and

if the above judgment is obtained, copying or moving said icon on said first hierarchical file managing table form into the corresponding cell in the “parent” file managing table form wherein the icon of the “existing file managing table form” is disposed.

In order to achieve the above objects, a method in an information processing apparatus according to the invention as defined in claim 4 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method outputting an icon to satisfy an outputting condition prepared in the form of the product of data for each item, from a hierarchical file managing table form that is obtained by repeating to paste an icon specified for a file managing table form onto another file managing table form,
wherein an icon of file information is managed located in a relation with index words of the table format defined as the related data representing the attribute of said file information;

said method comprising the steps of;

setting the top file managing table form as the existing file managing table form;

reading index words for each cell within the icon disposing field of said file managing table form” constituting said hierarchical file managing table form, as the related data of an icon disposed in said cell based on a determined rule;

recognizing on said file managing table form a cell each related data for which is included by the corresponding data of the same item name of the outputting condition, by comparing related data for each cell within the icon disposing field of said file managing table form with the corresponding data of the outputting condition regarding each item name;

judging if regarding all item names constituting the outputting condition, above comparison of data thereof with the corresponding data of each cell within the icon disposing field of each file managing table form fetched from said hierarchical file managing table form is not yet done;

if the above judgment is obtained, fetching another file managing table form represented by the icon disposed in said recognized cell on said file managing table form;

returning to the above step of reading index words on the existing file managing table form; and

else if the above judgment is not obtained, outputting the definition information represented by the icon disposed in said recognized cell on the existing file managing table form, into a specially provided area in the data memorizing means.

The method in the information processing apparatus according to the invention as defined in claim 5 is the method of claim 4, wherein the related data is recognized for each cell within the icon disposing field of a second file managing table form specially provided, and then an icon output from said hierarchical file managing table form is copied or moved into the appropriate cell on the second file managing table form based on the recognized related data for it as the outputting condition.

In order to achieve the above objects, a method in an information processing apparatus according to the invention as defined in claim 6 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;

said method comprising of the steps:

setting the top file managing table form of said hierarchical file managing table form, as the “existing file managing table form” that is a processing target of the following steps;

judging if the set of item names constituting the related data defined on the “existing file managing table form” is not included by the set of item names constituting the attribute data provided for said disposing target icon;

if the above judgment is not obtained, reading index words for each cell within the icon disposing field of the “existing file managing table form” as the related data of an icon disposed in said cell based on a determined rule;

recognizing subsequently on the “existing file managing table form” a cell each related data for which includes the corresponding data of the attribute data, provided for an disposing target icon;

fetching subsequently as the “existing file managing table form”, the “child” file managing table form the icon of which is disposed in said recognized cell;

returning subsequently to the above judgment; and

if the above judgment is obtained, copying or moving said disposing target icon into the corresponding cell in the “parent” file managing table form wherein the icon of the “existing file managing table form” is disposed.

The method in the information processing apparatus according to the invention as defined in claim 7 is the method of claim 6, wherein the related data is recognized for each cell within the icon disposing field of a second file managing table form specially provided, and then an icon disposed in each cell is copied or moved into the appropriate cell on the corresponding file managing table form included in said hierarchical file managing table form, based on the recognized related data for said cell as the attribute data condition of said icon.

The method in the information processing apparatus according to the invention as defined in claim 8 is the method of claim 6, comprising the steps of:

displaying the file managing table form including the disposing destination cell in the screen, and

providing said disposing destination cell or the icon moved or copied therein with a special display.

In order to achieve the above objects, a method in an information processing apparatus according to the invention as defined in claim 9 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method copying or moving a icon representing a file managing table form onto another file managing table form,
wherein in a file managing table form, an icon is managed located in a relation with index words of the table format defined as the related data representing the attribute of said icon;

said method comprising the steps of:

recognizing as the attribute data of said file managing table form itself, data that is defined as the related data on a copy source file managing table form or a copy destination file managing table form, and further is written located apart from the matrix of the icon disposing field, and further located at a determined relational position with the icon disposing field;

recognizing subsequently on said copying destination file managing table form or said moving destination file managing table form, a cell each related data for which includes the corresponding data of said attribute data, by repeating a comparison of said attribute data with related data recognized for each cell within the icon disposing field of said destination file managing table form; and

copying or moving an icon representing said copying source file managing table form or said moving source file managing table form into the corresponding cell.

In order to achieve the above objects, a method in an information processing apparatus according to the invention as defined in claim 10 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method providing the common condition recognized for a file managing table form, wherein an icon is managed located in a relation with index words of the table form defined as the related data representing the attribute of said icon;

said method comprising the steps of:

receiving a copying or moving operation by a user of an icon representing a first file managing table form into the icon disposing field of a second file managing table form;

reading the index words for a cell that is the copying or moving destination of the disposing target icon representing the first file managing table form” on the second file managing table form, as the related data of said icon based on a determined rule;

providing the recognized related data with information that represents the related data distinguished from the other written information; and

writing said related data provided with the distinguishing information at the location that is apart from the icon disposing field and in the predetermined relation with the icon disposing field on the first file managing table form, the copying or moving target as the common condition data of said file managing table form.

The method in the information processing apparatus according to the invention as defined in claim 11 is the method of claim 11, wherein related data written at the corresponding position outside of the matrix of the table format on the first file managing table form is written in the form of the couple consisting of the item name and the data name, and further an written item name and a written data name is provided respectively with a specified indication that represents the item name or the data name.

In order to achieve the above objects, a method in an information processing apparatus according to the invention as defined in claim 12 is the method, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said method making a hierarchical file managing table form that is obtained by repeating to paste an icon specified for a file managing table form onto another file managing table form,
wherein an icon of file information is managed located in a relation with index words of the table format defined as the related data representing the attribute of said file information;

said method comprising the steps of:

receiving a designation of a specified operation for a designated file managing table form constituting a first composite file managing table form;

recognizing each file managing table form belonging to the same layer as said designated file managing table form in the composite file managing table form;

generating a file data representing a second table form designated specially, for each cell within the icon disposing field of each file managing table form recognized above; and

disposing an icon corresponding to said file data in the corresponding cell.

In order to achieve the above objects, a method in an information processing apparatus according to the invention as defined in claim 13 is the method, having an user operation environment;

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

In order to achieve the above objects, an information processing apparatus according to the invention as defined in claim 14 is the apparatus, having a user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said apparatus copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;

said apparatus comprising:

a means that is repeats a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;

a means that recognizes the sum of the related data recognized on each file managing table form followed as above, as the total related data to be referenced as the attribute of an icon in said cell selected first;

a means that recognizes the cell on a second file managing table form specially provided into which an icon in said cell designated first on said hierarchical file managing table form is to be copied or moved, or the cell on said second file managing table form an icon in which is to be moved or copied into said cell on said hierarchical file managing table form, by comparing the total related data above recognized with related data recognized for each cell within the icon disposing field on said second file managing table form; and

a means that copies or moves said icon between said cell on said hierarchical file managing table form and said cell on the second file managing table form.

In order to achieve the above objects, an information processing apparatus according to the invention as defined in claim 15 is the apparatus, having an user operation environment, wherein file information is represented by an icon, that

is an image specified for each type of file information on its display screen, and further by a specified designation to the corresponding icon by a user, is set in its memorizing means wherein the corresponding process can be executed, while a screen displaying the content of said file information is provided on its apparatus screen;

said apparatus outputting an icon to satisfy an outputting condition prepared in the form of the product of data for each item, from a hierarchical file managing table form that is obtained by repeating to paste an icon specified for a file managing table form onto another file managing table form,
wherein an icon of file information is managed located in a relation with index words of the table format defined as the related data representing the attribute of said file information;

said apparatus comprising:

a means that sets the top file managing table form as the existing file managing table form;

a means that reads index words for each cell within the icon disposing field of said file managing table form” constituting said hierarchical file managing table form, as the related data of an icon disposed in said cell based on a determined rule;

a means that recognizes on said file managing table form a cell each related data for which is included by the corresponding data of the same item name of the outputting condition, by comparing related data for each cell within the icon disposing field of said file managing table form with the corresponding data of the outputting condition regarding each item name;

a means that judges if regarding all item names constituting the outputting condition, above comparison of data thereof with the corresponding data of each cell within the icon disposing field of each file managing table form fetched from said hierarchical file managing table form is not yet done;

a means that fetches another file managing table form represented by the icon disposed in said recognized cell on said file managing table form if the above judgment is obtained;

a means that returns to the above step of reading index words on the existing file managing table form; and

a means that outputs the definition information represented by the icon disposed in said recognized cell on the existing file managing table form, into a specially provided area in the data memorizing means, else if the above judgment is not obtained.

In order to achieve the above objects, an information processing apparatus according to the invention as defined in claim 16 is the apparatus, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said apparatus copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;

said apparatus comprising:

a means that sets the top file managing table form of said hierarchical file managing table form, as the “existing file managing table form” that is a processing target of the following steps;

a means that judges if the set of item names constituting the related data defined on the “existing file managing table form” is not included by the set of item names constituting the attribute data provided for said disposing target icon;

a means that reads index words for each cell within the icon disposing field of the “existing file managing table form” as the related data of an icon disposed in said cell based on a determined rule if the above judgment is not obtained;

a means that recognizes subsequently on the “existing file managing table form” a cell each related data for which includes the corresponding data of the attribute data, provided for an disposing target icon;

a means that fetches subsequently as the “existing file managing table form”, the “child” file managing table form the icon of which is disposed in said recognized cell;

a means that returns subsequently to the above judgment; and

a means that copies or moves said disposing target icon into the corresponding cell in the “parent” file managing table form wherein the icon of the “existing file managing table form” is disposed if the above judgment is obtained.

In order to achieve the above objects, a computer control program and/or a medium encoded with the program for use with a computer according to the invention as defined in claim 17 is the apparatus, having an user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said program and/or a medium copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;

said program and/or a medium comprising the steps of:

repeating a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;

recognizing the sum of the related data recognized on each file managing table form followed as above, as the total related data to be referenced as the attribute of an icon in said cell selected first;

recognizing the cell on a second file managing table form specially provided into which an icon in said cell designated first on said hierarchical file managing table form is to be copied or moved, or the cell on said second file managing table form an icon in which is to be moved or copied into said cell on said hierarchical file managing table form, by comparing the total related data above recognized with related data recognized for each cell within the icon disposing field on said second file managing table form; and

copying or moving said icon between said cell on said hierarchical file managing table form and said cell on the second file managing table form.

In order to achieve the above objects, a computer control program and/or a medium encoded with the program for use with a computer according to the invention as defined in claim 18 is the apparatus, having a user operation environment, wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said program and/or a medium outputting an icon to satisfy an outputting condition prepared in the form of the product of data for each item, from a hierarchical file managing table form that is obtained by repeating to paste an icon specified for a file managing table form onto another file managing table form,;

wherein an icon of file information is managed located in a relation with index words of the table format defined as the related data representing the attribute of said file information;

said program and/or a medium comprising the steps of:

setting the top file managing table form as the existing file managing table form;

reading index words for each cell within the icon disposing field of said file managing table form” constituting said hierarchical file managing table form, as the related data of an icon disposed in said cell based on a determined rule;

recognizing on said file managing table form a cell each related data for which is included by the corresponding data of the same item name of the outputting condition, by comparing related data for each cell within the icon disposing field of said file managing table form with the corresponding data of the outputting condition regarding each item name;

judging if regarding all item names constituting the outputting condition, above comparison of data thereof with the corresponding data of each cell within the icon disposing field of each file managing table form fetched from said hierarchical file managing table form is not yet done;

if the above judgment is obtained, fetching another file managing table form represented by the icon disposed in said recognized cell on said file managing table form;

returning to the above step of reading index words on the existing file managing table form; and

else if the above judgment is not obtained, outputting the definition information represented by the icon disposed in said recognized cell on the existing file managing table form, into a specially provided area in the data memorizing means.

In order to achieve the above objects, a computer control program and/or a medium encoded with the program for use with a computer according to the invention as defined in claim 19 is the apparatus, having a user operation environment,

wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

said program and/or a medium copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;

said program and/or a medium comprising the steps of:

setting the top file managing table form of said hierarchical file managing table form, as the “existing file managing table form” that is a processing target of the following steps;

judging if the set of item names constituting the related data defined on the “existing file managing table form” is not included by the set of item names constituting the attribute data provided for said disposing target icon;

if the above judgment is not obtained, reading index words for each cell within the icon disposing field of the “existing file managing table form” as the related data of an icon disposed in said cell based on a determined rule;

recognizing subsequently on the “existing file managing table form” a cell each related data for which includes the corresponding data of the attribute data, provided for an disposing target icon;

fetching subsequently as the “existing file managing table form”, the “child” file managing table form the icon of which is disposed in said recognized cell;

returning subsequently to the above judgment; and

if the above judgment is obtained, copying or moving said disposing target icon into the corresponding cell in the “parent” file managing table form wherein the icon of the “existing file managing table form” is disposed.

### Effect of the Invention

According to the present invention, in a composite file managing table form which manages files in the form of hierarchical configuration, by recognizing the total related data obtained in the whole of the composite file managing table form for an managing target icon or the cell storing it, the desired file can be retrieved readily with arbitrary retrieval items. Further in storing a file in a composite file managing table form, by comparing attribute parameters with which the file are provided, with the related data described above obtained for each cell on the composite file managing table form, the disposing position of the storing target file on the composite file managing table form is immediately found.

Furthermore according to the present invention, in fetching files having desired condition among icons of files managed on a composite file managing table form, the plurality of icons are fetched out disposed on another composite file managing table form, that is, disposed so that the attributes of each of the fetched icons can be understood obviously at a glance.

Furthermore according to the present invention, because in storing a managing target file in a composite file managing table form, the icon of the file can be stored in a file managing table form the layer of which is as low as possible, in fetching out the icon again from the composite file managing table form, a user can retrieve it with more viewpoints.

Furthermore according to the present invention, because a plurality of managing target icons can be collectively in a lump copied automatically between file managing table forms at least one of which is a composite file managing table form, by fetching all disposing destination cells of icons of management target files and recognizing the total related data for the disposing destination cells fetched in a composite file managing table form, the icons of the management target files can be newly with ease disposed on another file managing table form created freely in response to a new viewpoint needed on demand and furthermore the total composite file managing table form can be easily reconstructed.

Furthermore according to the present invention, because a arbitrary file managing table form constituting a composite file managing table form can be fetched separately out of the corresponding composite file managing table form with the related data retained which are recognized for files stored in the file managing table form from the whole of the composite file managing table form, users can do individual handling of a file managing table form freely such that he can fetch apart of file managing table forms constituting the composite file managing table form, then storing them out of the composite file managing table form, or can build again file managing table forms once fetched out of the composite file managing table form, into another composite file managing table form, so that he can reconstruct the file management using the hierarchical configuration of table forms freely by user operation.

Furthermore according to the present invention, because an individual file managing table form which is created separately or is fetched out of a composite file managing table form can be build into another composite file managing table form automatically, user scan construct a composite file managing table form freely, without effort, and speedily.

Furthermore according to the present invention, because all file managing table forms belonging to the same layer in a composite file managing table form can be created automatically by an user operation

Which dispose an icon representing a file managing table form in another file managing table form constituting a composite file managing table form, a composite file managing table form wherein table forms of the same layer have the same format, can be created speedily without effort.

Furthermore according to the present invention, because all the related data are recognized by users obviously at a glance, which are obtained for a managing target file stored in a composite file managing table form, including those obtained from file managing table forms other than the file managing table form where the icon of the corresponding file is disposed, he can give various free operations easily to understand to an individual file stored in a composite file managing table form or an individual table form constituting an composite file managing table form.

### BRIEF DESCRIPTION OF THE DRAWINGS

FIG. 1 is a block diagram of an example of a system configuration on hardware of an information processing apparatus according to one embodiment of the present invention;

FIG. 2 depicts a desktop screen displayed by an environment controlling program in a system of the embodiment;

FIG. 3 depicts a table form management application screen in the system of the embodiment;

FIG. 4 is a block diagram of an inventive functional configuration in the system of the embodiment;

FIG. 5 depicts a format of a file managing table form of the “disposing destination” in the system of the embodiment;

FIG. 6 depicts a format of a file managing table form of the “disposing source” in the system of the embodiment;

table form in the system of the embodiment;

FIG. 8 depicts an example of a data format of character string data in the system of the embodiment;

FIG. 9 depicts an example of a data format of ruled-line data in the system of the embodiment;

FIG. 10 depicts an example of a data format of cell data in the system of the embodiment;

FIG. 11 depicts a list of definition element symbols in the system of the embodiment;

FIG. 12 depicts a format of a file managing table form of the “disposing destination” with format definitions added in the system of the embodiment;

FIG. 13 depicts a format of a file managing table form of the “disposing source” with format definitions added in the system of the embodiment;

FIG. 14 depicts an example of terms included in an applied term dictionary in the system of the embodiment;

FIG. 15 depicts an example of a data format of “applied term definition data” in the system of the embodiment;

FIG. 16 depicts an example of a data format of specification target data in the system of the embodiment;

FIG. 17 depicts an example of a data format of item definition data in the system of the embodiment;

FIG. 18 depicts an example of a data format of “icon pointer data” in the system of the embodiment;

FIG. 19 depicts a format of a file managing table form of the “copy destination” in the system of the embodiment;

FIG. 20 depicts a format of a file managing table form of the “copy destination” with format definitions added in the system of the embodiment;

FIG. 21 depicts a input tray for designating file managing table form of the copy sources in the system of the embodiment;

FIG. 22 depicts the total sequence of the file icon batch copy process in the system of the embodiment;

FIG. 23 depicts the configuration of the copy worktable in the system of the embodiment;

FIG. 24 depicts a sequence for selecting files to be copied into a cell within the icon disposing field of a copy destination fetched currently among managing target files stored in a composite file managing table form of the copy source in the system of the embodiment;

FIG. 25 depicts a sequence for recognizing a “beginning cell” to be fetched first from a composite file managing table form of the copy source in the system of the embodiment;

FIG. 26 depicts a image of a “beginning cell” to be fetched first from the whole of a composite file managing table form in the system of the embodiment;

FIG. 27 depicts a sequence for recognizing a related data from the whole of a composite file managing table form of the copy source in the system of the embodiment;

FIG. 28 depicts a sequence for recognizing a “next cell” from a composite file managing table form of the copy source in the system of the embodiment;

FIG. 29 depicts a image of a “next cell” from a composite file managing table form of the copy source in the system of the embodiment;

FIG. 30 depicts a second sequence for selecting files to be copied into a cell within the file field of a copy destination fetched currently among managing target files stored in a composite file managing table form of the copy source in the system of the embodiment;

FIG. 31 depicts a format of a file managing table form of the “disposing source” with common condition data written or displayed in the system of the embodiment;

FIG. 32 depicts a example wherein an icon representing a table form is disposed and displayed related the common condition data of the table form in the system of the embodiment;

FIG. 33 depicts a sort order menu in the system of the embodiment;

FIG. 34 depicts a sequence for selecting a file managing table form and a cell therein of disposing destination into which an icon of a copy source is to be copied in a composite file managing table form of copy destination in the system the embodiment;

FIG. 35 depicts a sequence for selecting a disposing destination in a composite file managing table form of copy destination, by fetching each file managing table form constituting a composite file managing table form of copy source sequentially in the system the embodiment;

### EXPLANATIONS OF SIGNS

10 color image scanner

12 keyboard

14 mouse

15 digitizer

16 internal memory

18 external memory

20 displaying apparatus

24 CPU

27 communicating apparatus

31 main menu

32 application menu

33 table form processing application screen

41 input designating unit

43 table form data memorizing unit

45 related data recognizing unit

47 related data memorizing unit

51 file data storage unit

55 icon disposing destination table form recognizing unit

57 file data fetching unit

59 icon disposing destination cell recognizing unit total controlling unit

81 character input button

82 ruled line button

90 definition sub-screen

94 execution button

150 definition button

151 input button

153 copy button

155 sore button

157 environment set button

159 sort

160 input tray

165 copy execution button

166 move execution button

170 sort order menu

171 designated data order button

181 table form creating button

183 retrieval button

185 retrieval condition input screen

186 input field

187 item name

189 execution button

190 automatic disposing button

191 disposing destination tray

193 execution button

### BEST MODES FOR CARRYING OUT THE INVENTION

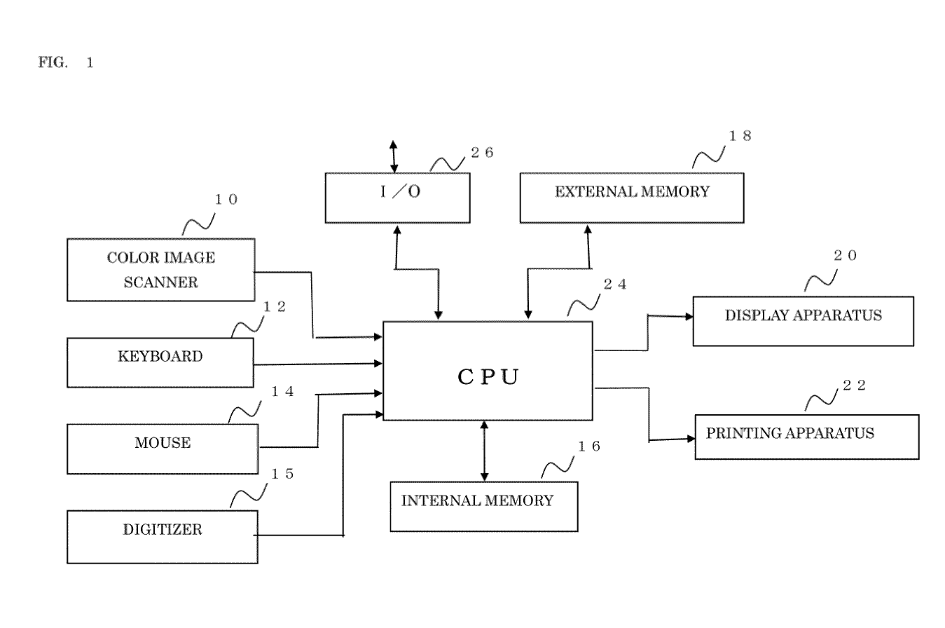

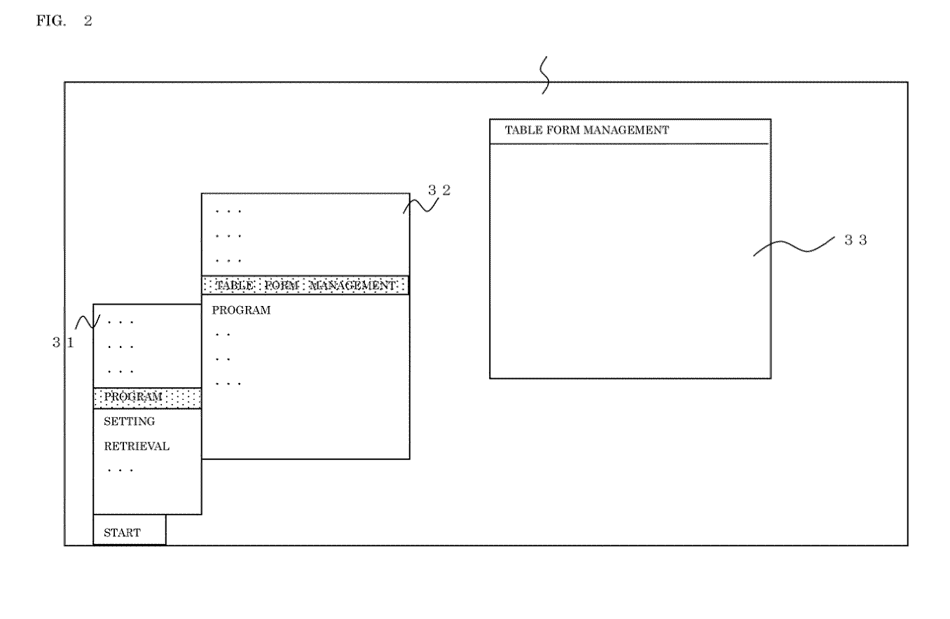

FIG. 1 depicts a system configuration on hardware of an information processing apparatus according to one embodiment of the present invention. This system includes a color image scanner 10, a keyboard 12, a mouse 14, and a digitizer 15 acting as input apparatuses, an internal memory 16 and an external memory 18 acting as storage apparatuses, and a displaying apparatus and a printing apparatus 22 acting as output apparatuses, which are connected to a CPU 24 through appropriate interface circuits (not shown). The CPU 24 is also connected to a telephone line or communication line 27 through a communicating apparatus 26.

The color image scanner 10 reads characters, symbols, and graphics in a document written on a paper sheet as color image information. The internal memory 16 and the external memory 18 have stored thereon various programs regulating processes and control operations of the CPU 24 as well as various electronic dictionaries, character fonts, files, etc. The communicating apparatus 26 has a facsimile communication function.

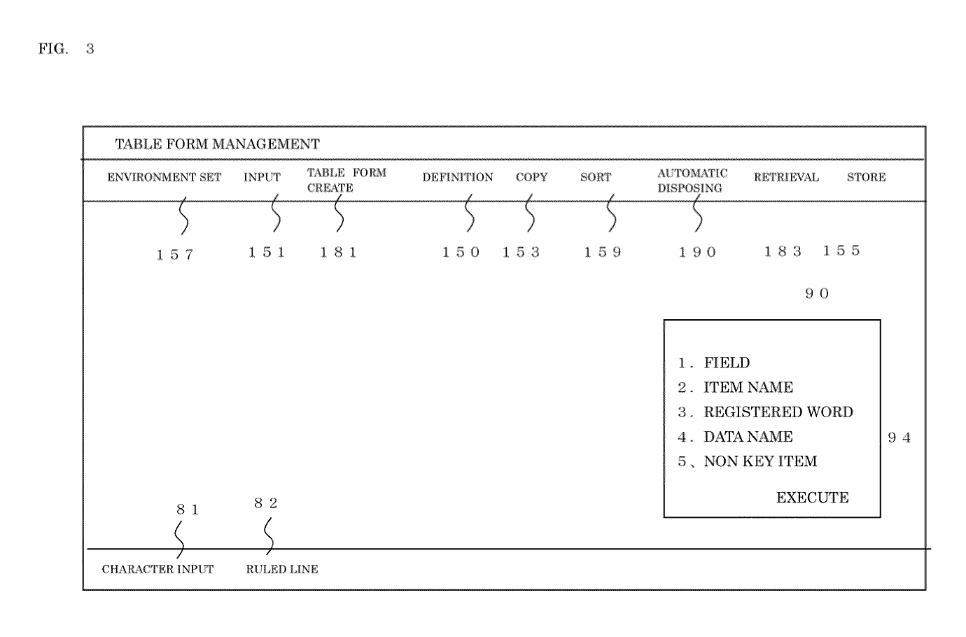

When the apparatus is powered on, an environment control program controlling a GUI environment of the apparatus is automatically activated to display, for example, a desktop screen shown in FIG. 2 on a display screen 20a of the displaying apparatus 20. If a “start” button always displayed at the lower left corner is selected and specified on this desktop screen, a “main menu” 31 having a list of selection buttons such as “program”, “set”, and “retrieve” appears on the display screen 20a, and if a “program” button is clicked and specified on this “main menu” 31, a “program menu” 32 showing a list of application programs installed on the apparatus appears on the display screen 20a. FIG. 2 depicts a state after clicking and specifying the “program” to display the “program menu” 32.

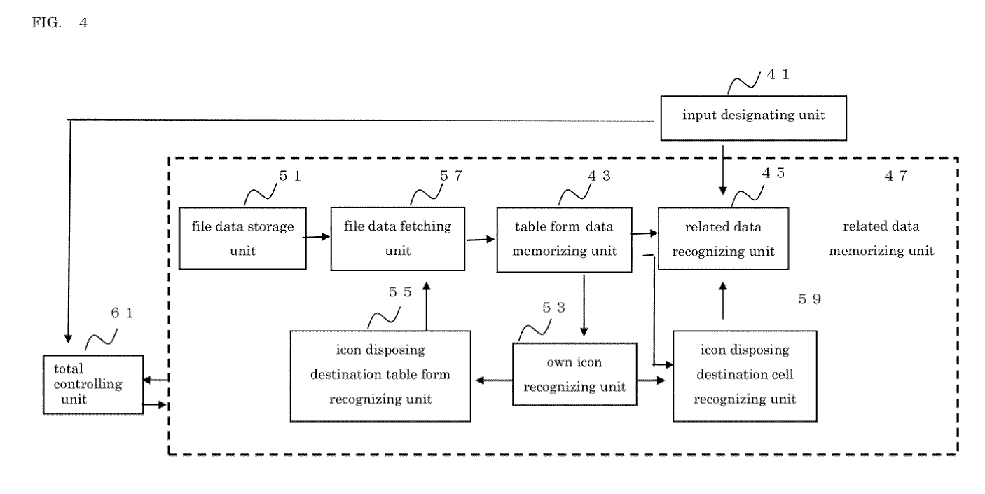

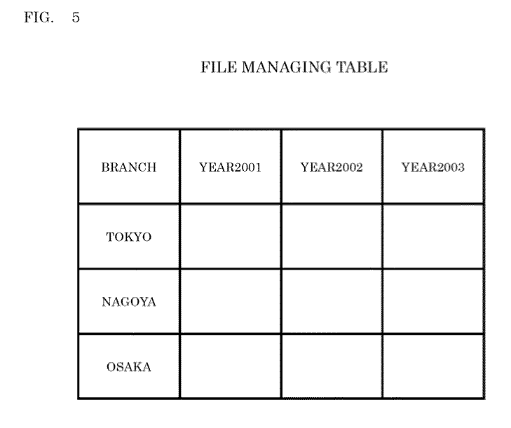

If a corresponding button is clicked and specified for a “table form management application program” that is an application program controlling a function related to the present invention, the environment control program fetches a source program of the “table form management application program” from a predetermined storage position on the external memory 18 of the apparatus, activates the program after deploying the program in the execution format on an appropriate area of the external memory 16, and displays, for example, a table form management application screen 33 shown in FIG. 3 on the display screen 20a.

Information generated and displayed within a table form management application screen 33 is managed as a file information linked to the table form management application program by the environment control program. The table form management application is provided with functions related to the present invention, such as “document creation”, “definition”, “input”, and “environment setup”. The document creation function enables a user to freely create documents including table form with the use of a “character input” button and a “ruled line” button always displayed on the table form management application screen 33. The format defining function enables a format of a table to be defined as a data format such that data with a defined item name may uniquely be fetched from various table documents arbitrarily created by a user on the table form management application screen 33. This is performed with the use of a menu on a sub-screen 90 (described later) displayed by specifying a “definition” button” 150 always displayed on the table form management application screen 33.

The input function enables data or icons to be copied in a lump on a table form generated and given the format defining function. This is performed with the use of a input tray 160 displayed by specifying a “input” button 151 always displayed on the table form management application screen 33. The environment setup function enables a user to perform functions such as setting colors and line types added to differentiate character strings and ruled lines additionally entered for the format definition from originally entered character strings and ruled lines at the time of the format definition. This is performed with the use of a sub-screen (not shown) displayed by specifying an “environment setup” button always displayed on the table form management application screen 33.

The above functions are implemented by a system where the table form management application program cooperatively operates with the environment control program and the hardware making up the apparatus.

The input designating unit 41 designates a cell for which the related data is recognized on a table form. The table form data memorizing unit 43 memorizes a file data fetched from the file data memorizing unit 51, representing a table form. The related data recognizing unit 45 recognizes the related data for a cell designated by the input designating unit 41 or the icon disposing destination cell recognizing unit 59 on a table form memorized in the table form data memorizing unit 43. The related data memorizing unit 47 memorizes the related data recognized by the related data recognizing unit 45.

A file data storage unit 51 memorizes a plurality of file data. The own icon recognizing unit 53 recognizes the icon definition information representing a file data corresponding to a table form fetched in the table form data memorizing unit 43. The icon disposing destination table form recognizing unit 55 recognizes a table form on which an icon recognized by the own icon recognizing unit 53 is disposed.

The file data fetching unit 57 fetches a file data representing the table form recognized by the icon disposing destination table form recognizing unit 55, from the file data storage unit 51. The icon disposing destination cell recognizing unit 59 recognizes a cell in which the corresponding icon is disposed on the table form fetched in the table form data memorizing unit 43 as the icon disposing destination table form recognized by own icon recognizing unit 53.

The total controlling unit 61 controls the operating sequence of the related data recognizing unit 45, the own icon recognizing unit 53, the icon disposing destination table form recognizing unit 55, the icon disposing destination cell recognizing unit 59, and the file data fetching unit 57 as described above, based on the input designating unit 41, the related data memorizing unit 45, the own icon recognizing unit 53, the icon disposing destination table form recognizing unit 55, the icon disposing destination cell recognizing unit 59, and the file data fetching unit 57 as described above.

The details of the functions related to the invention in the embodiment apparatus are explained in the example wherein a group of CSV data files is managed, which share the same data configuration and in the other hand have respectively different file common conditions. Each of the data files consists of records having a common data configuration for example, of “PRODUCT”, “CATEGORY”, “MONTHLY”, “SALES VOLUME”, AND “SALES AMOUNT”, and is created for the same “BRANCH”, the same “QUARTER”, the same “YEAR”, and the same “DESTINATION”, which are the file common conditions. The common conditions, i.e., the data of the items “BRANCH”, “QUARTER”, “YEAR”, and “DESTINATION” are not included in the record constituent data.

Each of the above data files is managed in a form of a file information, which is a unit of data handling of the environment control program in the system and is assumed to be stored as, for example, a CSV-format data file at a predetermined position in the file data storage unit 40 allocated in the external memory 18.

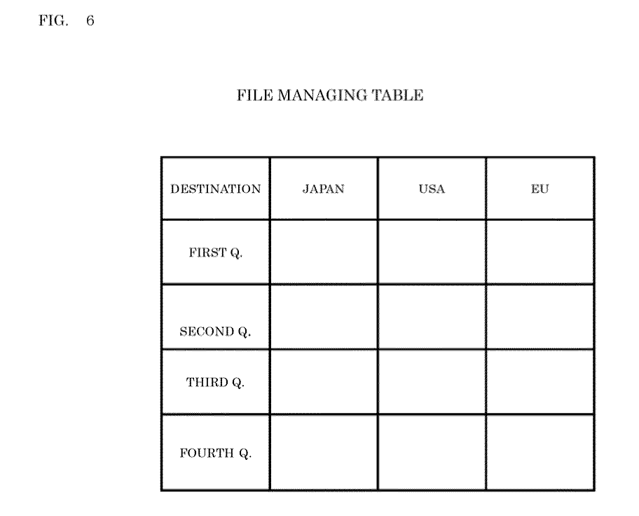

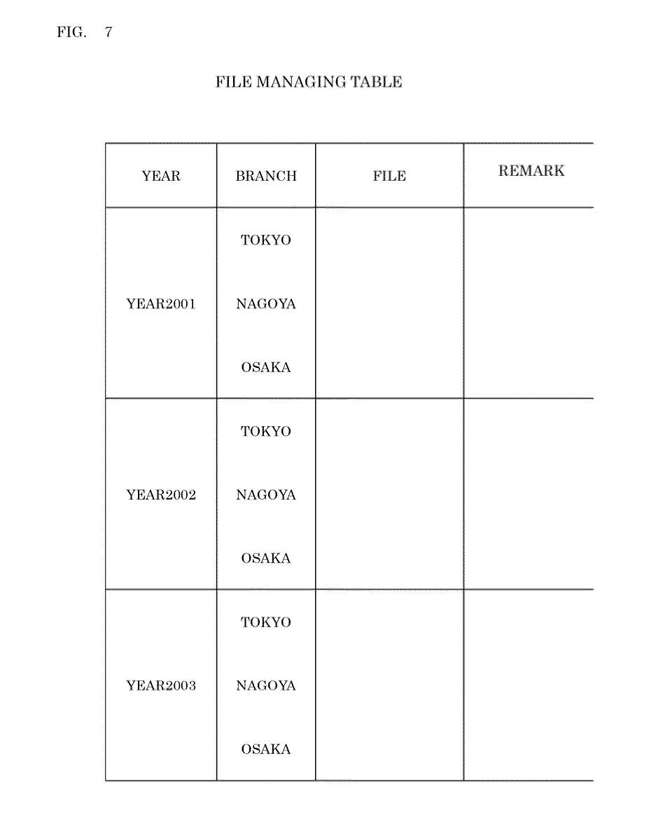

Users manage and store these CSV files, using two kinds of file managing table form shown in FIG. 5 and FIG. 6. In the file managing table form shown in FIG. 5, “2001”, “2002”, and “2003” are entered in a first row from the top of it as data names of the item name “YEAR”, that is a common condition of management target data CSV files, and “TOKYO”, “NAGOYA”, and “OSAKA” are entered in a first column from the left as data names of a common condition “BRANCH” of the management target data files. As the form of the file managing table form shown in FIG. 5, one file managing table form is created in all.

In the file managing table form shown in FIG. 6, “HOME”, “USA”, and “EU” are entered in a first row from the top of it as data names of the item name “DESTINATION”, that is a common condition of management target data CSV files, and “FIRST Q”, “SECOND Q”, and “THIRD Q” are entered in a first column from the left as data names of a common condition “QUARTER” of the management target data files. As the form of the file managing table form shown in FIG. 6, nine file managing table forms are created in all.

A user uses the document creating function and the format definition function to create and define these file managing table form in the embodiment apparatus. Users create a file information of the table form management application for each file managing table form shown in FIG. 5 and FIG. 6, and then drag & drops and pastes each icon representing each file information of each file managing table form shown in FIG. 6 into a cell on a file managing table form shown in FIG. 5.

In the specification the combination of file managing table form is named the composite file managing table form, wherein each file managing table form constituting it is connected hierarchically each other, an icon representing a file managing table form being pasted into a cell on another File managing table form as above, and further by designating an icon in a cell on a file managing table form, the corresponding file managing table form is opened and can be accessed.

In the specification, a file managing table form which is related as above to a cell included in another file managing table form, is named a “file managing table form of the disposing source”, while said file managing table form to a cell on which said “file managing table form of the disposing source” is related, is named a “disposing destination file managing table form”, in a composite file managing table form as defined above.

Into each constituting cell of a “file managing table source of the disposing source”, further an icon representing another file managing table form can be pasted. In a composite file managing table form, in general file managing table forms are related each other in the form of the tree structure with a arbitrary number of layers, by repeating the process relates a file managing table form to a cell constituting another file managing table form as described above.

A user subsequently relates each managing target CSV files to a composite file managing table form as described below. For example in the case a CSV file the common condition of which is “USA” for the item name “DESTINATION”, “SECOND Q” for the item name “QUARTER”, an “YEAR 2003” for the item name “YEAR” and “NAGOYA” for the item name “BRANCH”, he first has a file managing table form shown in FIG. 5, that is the “disposing destination file managing table form”, displayed on the display screen 20a, and then clicks thereon the icon of a file managing table form shown in FIG. 6, that is the “file managing table source of the disposing source” , which is pasted in the cell located in the column including the index word character string “YEAR2003” and at the same time located in the row including the index word character string “NAGOYA” to open the corresponding file managing table form file and display it on the display screen 20a.

Subsequently he drag & drops and pastes the icon of said CSV file into the cell located in the column including the index word character string “USA” and at the same time located in the row including the index word character string “SECOND Q” on a file managing table form shown in FIG. 6, that is “file managing table source of the disposing source” displayed on the display screen 20a.

Seeing first the file managing table form on which the corresponding icons of the managing target CSV files are pasted, he reads naturally the file common condition of each CSV data file as the set of the data names, one data name of the item “DESTINATION” written in the same row in which said icon is pasted and the other data name of the item “QUARTER” written in the same column in which said icon is pasted.

Further seeing the position at which an icon representing the file managing table form on which the icon of the managing target CSV file is pasted on, is pasted on the “disposing destination” file managing table form, he read in addition a data name of the item name “BRANCH” on the row including said position and a data name of the item name “BRANCH” on the column including said position, as the common condition of the management target file.

In general a method that is understandable to users to manage a plurality of files that have the same data configuration and different common condition each other, is to relate thus each data file to its common condition parameter in the form of a table form. In the system, a format of the file managing table form can be created freely for users to use easily. For example a table form managing data files shown in FIG. 5 is replaced by a table form shown in FIG. 7.

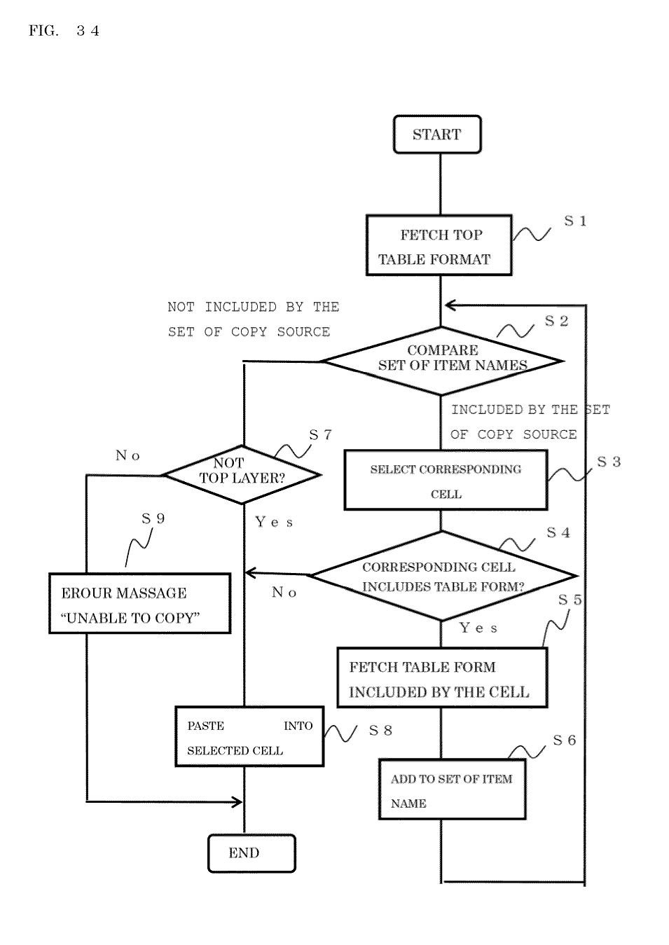

The file managing table form as described above is created with the document creating function in the embodiment apparatus. That is, users can freely create a document including a table form on the table form management application screen 33 shown in FIG. 33 with a known method using the “character input” button 81, the “ruled line” button 82, etc., displayed always in the lower edge portion thereof.

For example, after clicking and specifying the “character input” button 81, when a mouse pointer is positioned and clicked at a target position and characters are then input through the keyboard 12, a character string is generated on the document with the beginning position being the click position. After clicking and specifying the “ruled line” button 82, when the mouse pointer is positioned and clicked at a target position and the mouse pointer is moved while the mouse 14 is pressed down, a ruled line is drawn on the document with the both ends being the click position and the press-down released position of the mouse 14.

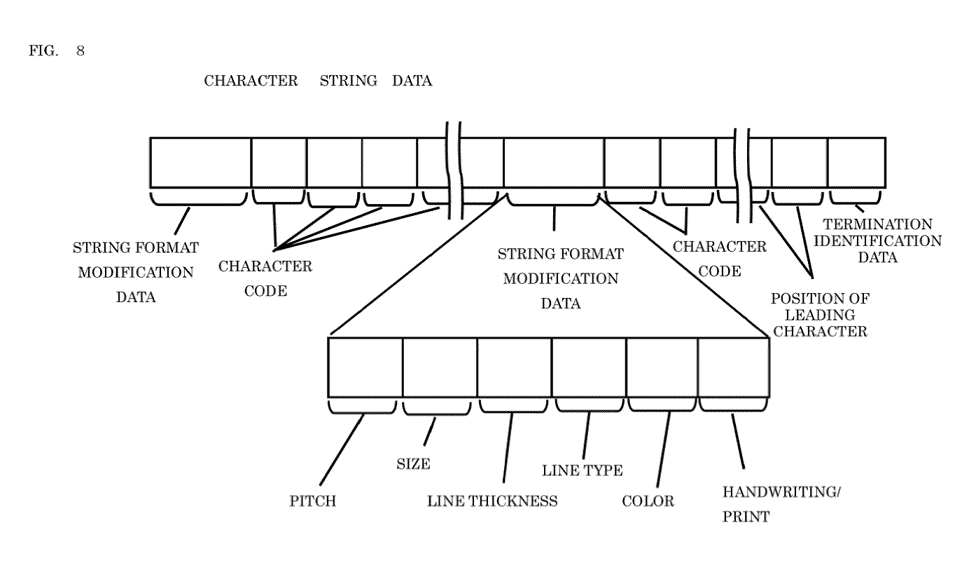

The document creating unit 37 of the system creates character string data, for example, in a format shown in FIG. 8 after a certain routine started in response to the specification of the “character input” button 81 recognizes the subsequently clicked position as the beginning position of the target character string. Set values preset in the apparatus may be registered for information such as character pitches, character types, and character sizes in the character string data.

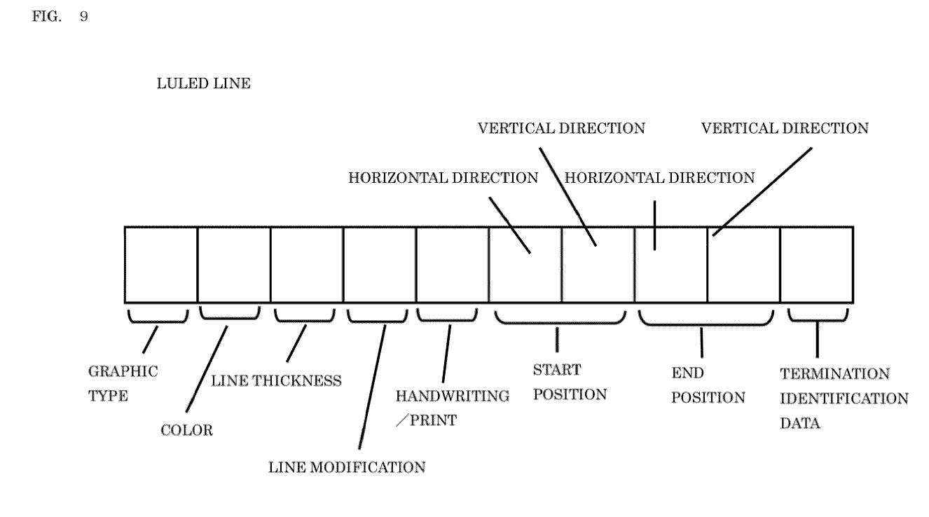

Ruled line data in a format shown in FIG. 9 for example are created after a certain routine started in response to the specification of the “ruled line” button recognizes the subsequently clicked position and the press-down released position as the both end positions of the target ruled line. Default set value may similarly be registered for information such as line types in the ruled line data.

Information created and displayed on one table form management application screen is managed by the environment control program as one piece of file information linked to the table form management application program. The ruled line data and the character string data created as above are stored in a certain area of the internal memory 16 allocated to the document data storage unit 39 provided in the file information corresponding to table form management application screen 33.

A document creating method of the embodiment apparatus maybe a method of creating a desired document on a paper sheet to input an image into the system. When a user inputs image data of a paper sheet through the scanner 10 of the apparatus, the system uses the known character recognizing and ruled-line recognizing functions provided in the document creating unit 37 to recognize character strings and ruled lines entered in the paper sheet to create and store corresponding character string data and ruled line data into the relevant document data storage unit 39.

Further a user operates as described below the format defining function for the file managing table form created as described above. The file managing table form may freely be created for user-friendliness as above. The format defining function is instead performed to fetch data from a freely created table format without multiple meanings in a fixed form.

The format defining function may continuously be performed after the document creating operation described above or may be performed when a corresponding icon is opened again by double-clicking the corresponding icon on the display 20a after a document is created and once saved on the external memory 18.

Now for example a file managing table form shown in FIG. 5 is created and displayed in 33 on 20a. When a user clicks 150 displayed always in the upper part of the 33, the system performs the following sequence in response to the designation.

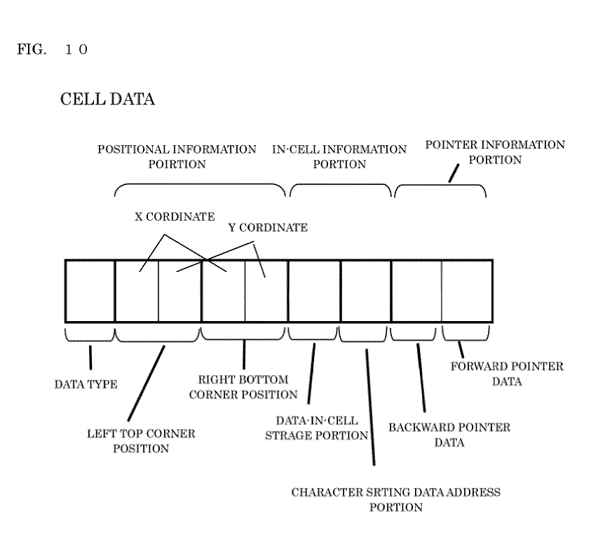

After recognizing cells that are rectangular areas serving as unitary data entry areas on the table form, cell data are created for respective recognized cells to define the cells and are stored in a predetermined area of the definition data storage unit 54. FIG. 10 shows an exemplary format of “cell data” representing one cell.

For example, cells are detected on the table form as follows. If a table is made up of ruled lines as in this example, the ruled line data of ruled lines making up the table are sequentially fetched to obtain the ruled-line positions delimited by the ruled lines or the extensions thereof in both the vertical and horizontal directions of the document. It is then searched whether each of four sides is a ruled-line portion for each grid of a matrix generated by these ruled-line positions; if a side is a ruled-line portion, the side is defined as a cell boundary; if a side is not a ruled-line portion, an adjacent grid of the corresponding direction is merged; and the same determination is repeated for the merged grid to identify four boundaries of a cell.

The system subsequently identifies the data character strings entered in all the cells on the table format and sets the addresses of the character string data into a “character string data address portion” in the corresponding cell data. The character strings entered in the cells may be identified in a known method by repeatedly checking cell data position information of a corresponding cell with position information of the character string data on the document.

The system also stores text code data in the character string data of the character strings entered in the cells into a “data-in-cell storage portion” in the corresponding cell data. Pointer information can also be stored in the “data-in-cell storage portion with a appropriate differentiating symbol appended.

After the cell data are created as above for all the cells on the table, the definition specifying unit 50 and the system then display the sub-screen 90 on the table form management application screen 33 to guide a user through the table format defining operation. The sub-screen 90 lists various definition items such as “1. FIELD”, “2. ITEM NAME”, and “3. REGISTERD WORD” as shown in FIG. 3.

In the table format defining operation, ranges and corresponding item names are specified for the icon disposing fields and the file common condition parameter entry areas on the table. The operation is performed by repeatedly clicking and specifying consecutive cell columns with the same item name and a character string of the item name one-by-one on the table and then specifying the respective corresponding definition item categories (such as “1. FIELD”, “2. ITEM NAME”, and “3. REGISTERED WORD”) on the sub-screen 90. The above individual specification operations may be performed in an arbitrary order.

The character string and the cell columns may differently be clicked and specified, for example, as in a known method as follows. The cell columns may be clicked and specified by a so-called drag operation, i.e., by bringing the mouse pointer to the cell columns to be specified and tracing the cell columns to be specified while the left button of the mouse 14 is clicked and pressed down.

The character string may be clicked and specified by bringing the mouse pointer to the character string to be specified, double-clicking and pressing down the left button of the mouse 14 to shift the system to a character string cursor display mode (character string specification mode), and then performing the drag operation of tracing the character string portion to be specified while the left button of the mouse 14 is pressed down.

If the entry of an item name is omitted on the table, a corresponding item name character string is additionally entered in a blank space adjacent to the upper or left side of the cell column direction of the corresponding data field area. The position adjacent to the upper or left side of the cell column direction of the corresponding data field area is particularly referred to as a “specific adjacent position” in this description. If no blank space exists at the “specific adjacent position” of the corresponding data field area, the character string may additionally be entered in an arbitrary blank space outside of the table adjacent to the corresponding data field area.

With regard to the correlation between item names and data fields, it is first assumed in an agreement with users that the system considers a character string specified to the “2. ITEM NAME” or “5. NON-KEY ITEM NAME” or a character string specified to the “3. REGISTERD WORD” and to the “ITEM NAME CATEGORY” located at the “specific adjacent position” as a corresponding item name for a data field area specified to the “1. FIELD”.

Subsequently, if a character string specified to the “2. ITEM. NAME” does not exist at the “specific adjacent position” of a data field area specified to the “1. FIELD”, a character string specified to the “2. ITEM NAME” adjacent to the corresponding data field area is considered as a corresponding item name.

If correlation between data fields and item names is not uniquely determined in the above procedure, a “linking line”, i.e., a symbol specifically reserved in the system is drawn as a symbol correlating both relevant elements for an appropriate one of combinations of data fields and item names.

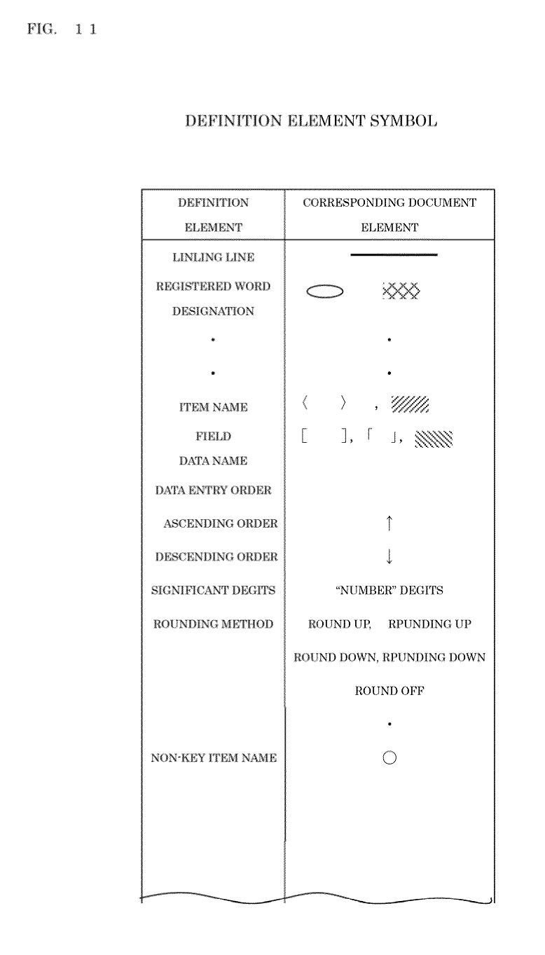

Certain symbols, graphics, or graphical features (such as background patterns) are reserved in this system and are correlated to and used for certain respective meanings in the format definition. FIG. 11 shows examples of definition element symbols that are specific reserved symbols. In this case, a line segment corresponds to the “linking line” that correlates constituent elements of definition with each other in the document. A table (not shown) correlating types of symbols and graphics with definition meanings is created in the definition specifying unit 50 of the system.

Character strings and line segments entered in the “definition mode” with the “definition” button specified may be “definition entry information” entered for the format definition handled differently from the entry information of the originally entered characters and strings. The “definition entry information” is stored in a specifically determined area in the document data storage unit 39 and is entered with modification information automatically added, which is preliminarily allocated to the “definition entry information”.

The modification information is allocated to the “definition entry information” on an “environment setting” screen (not shown) displayed by specifying an “environment setting” button 157 on the table form management application screen 33. In the case of this example, the “definition entry information” is differentiated by adding (blue) color. The additionally entered character strings and the line segments drawn for the above “linking lines” in the definition mode are entered as the (blue) colored “definition entry information” differentiated from the originally entered character strings and line segments.

If it is desirable to simply give a name to a data field in the above item name specifying operation, the “2. ITEM NAME” is selected when specifying the definition item category. If it is desirable to cause a certain process in accordance with an item name, the definition category “3. REGISTRATION WORD” is selected.

If an item name exists data of which is not the “key” for managing target file the icon of which is pasted in the icon disposing field, the character string representing the item name is clicked and specified, and then the “5. NON-KEY ITEM NAME” is designated on 90. This operation is performed, for example, in the case a data field of the item “SALES” is provided in the lowest row on the file managing table form shown in FIG. 5 in which “SALES” each year is to be written. But a promise being made with users that a file managing table form is not to be created on which the related data other than data of key item exist, the distinction of the “5. NON-KEY ITEM. NAME” on 90 can be omitted.

In the example in the file managing table form shown in FIG. 5, first the designation of the “1. FIELD” for each data field are performed, and then regarding the designation of the item names for the data field on the first column, a character string “BRANCH” entered as a index word of it adjacently to the upper side is directly used as an item name on the table form and is clicked and specified before the “2. ITEM NAME” is specified on the sub-screen 90.

Further for the data field in the first row, because entering of the index word is omitted, a character string “YEAR” is additionally added with “blue color” as the “definition entering information” at an arbitrary position outside of the table form adjacent to the first row of the table form, and the “2. ITEM NAME” is specified on the sub-screen 90, then being related to the corresponding data field with a linking line entered with “blue color” as the “definition entering information”.

For the item name of the icon disposing field, first, a term “TARGET” registered in the applied term dictionary 52 is additionally entered with “blue color” as the “definition entering information” in an arbitrary blank space outside of the table and then a linking line is drawn to link an arbitrary position within the corresponding icon disposing field. Subsequently the additionally entered item name character string “TARGET” is clicked and specified and the “3. REGISTERED WORD” is specified for it on the sub-screen 90.

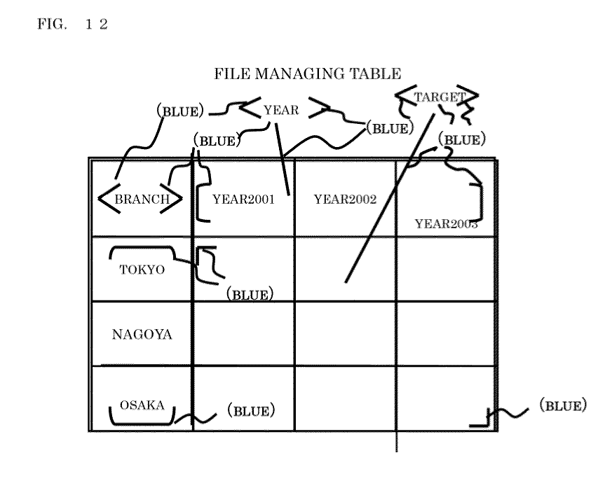

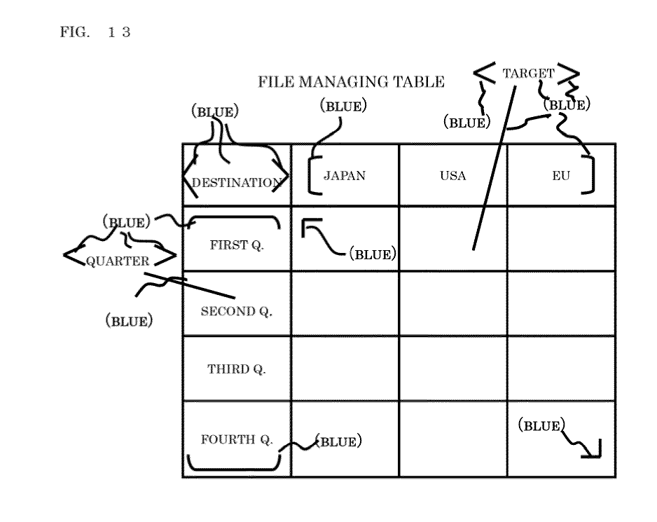

In the file managing table form shown in FIG. 6, also after the “1. FIELD” is specified for each data field, the designation of the item name is performed for each data field. The definition of the item name for the icon disposing field can also be performed in the same method as in the case of the file managing table form shown in FIG. 5. After the format definition, the file managing table forms shown in FIG. 5 or FIG. 6 is displayed in the form in which a symbol indicating the definition is appended as shown respectively in FIG. 12 or FIG. 13.

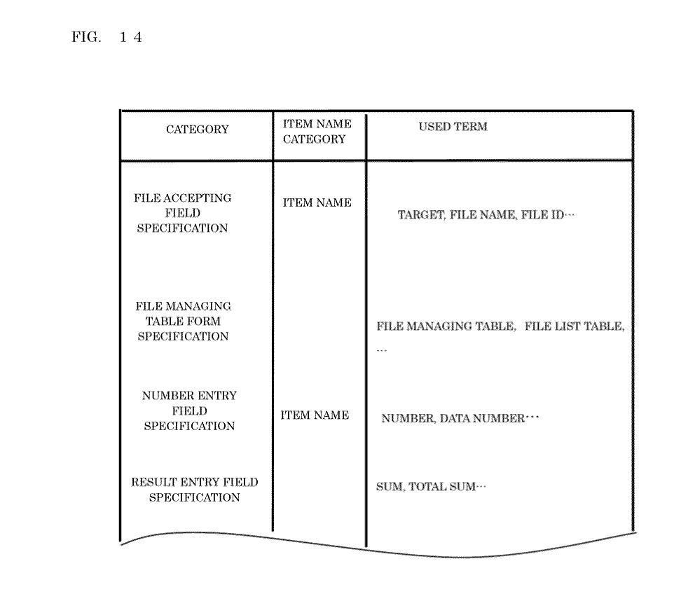

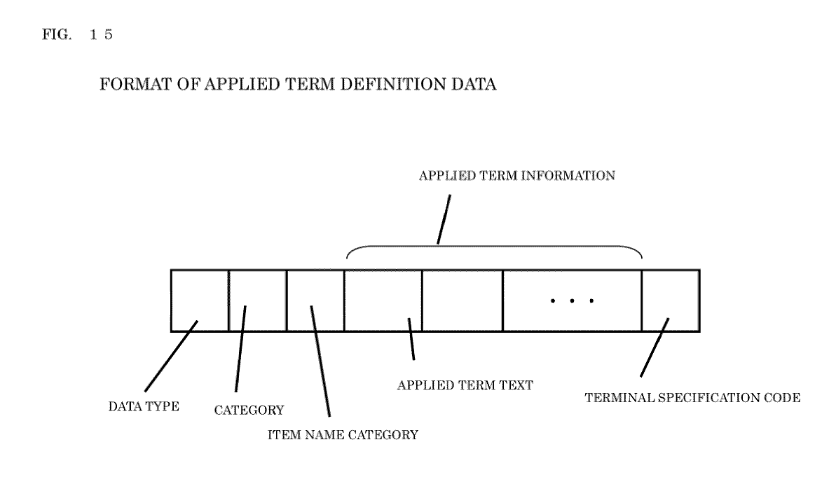

This system registers certain terms usually used by a user for the interfaces between humans into the applied term dictionary 52, which is a specific dictionary means capable of being referenced by both a user and the system and having registered meanings defined in accordance with usually understood meanings of the terms. FIG. 14 shows an example of registered contents of the applied term dictionary 52. FIG. 15 shows an example of the data format thereof. If a registered term of the applied term dictionary 52 has ambiguity or double meaning, a comment on term meaning is added in interface with a user of the dictionary means to ascertain the meaning.

A certain specification is given to a registered term of the applied term dictionary 52 on the document to determinably use the term as definition information to be construed in accordance with the registered meaning of the dictionary means, i.e., the usually understood meaning. After construing a term with this certain specification in accordance with the dictionary, the system also construes another piece of information specified on the document in association with a method determined depending on the construed meaning of the term to generate one piece of definition information for the system.

In the case of this example, the registered term “target” of the applied term dictionary 52 specified to the “3. REGISTERED WORD” on the document defines that the corresponding data fields is an icon disposing field correlated with data files in accordance with the usually understood word meaning.

The specification to the “2. ITEM NAME” may be performed instead of the above “3. REGISTRATION WORD”, provided with an agreement with a user such that a data field is always defined as the icon disposing field, if the term “TARGET” registered in the applied term dictionary 52 or a synonym thereof is entered at the above “specific adjacent position” or entered and correlated with a data field through the “linking line” as a index word of the data field.

Furthermore the specification to the “2. ITEM NAME” may be omitted under the above agreement. Further provided with an agreement with a user such that a data field for which no corresponding item name is related, is to be defined as a icon disposing field, the entering of the item name defining it as the icon disposing field, can be omitted.

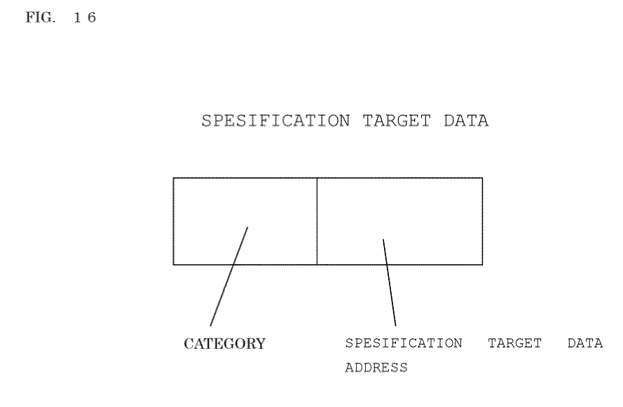

In response to the above specification operation, the system identifies the click specification target in accordance with the following process and then registers the click specification target to specification target data set as work data in the definition specifying unit 50. FIG. 16 shows a format of the specification target data. A corresponding code of the definition item category of the specification target is set in a “category” portion, and an address of the beginning cell data of the corresponding cell data chain described later is set in a “specification target data address” portion if the specification target is a cell column and an address of the corresponding character string data is set if the specification target is a character string.

In this system specified symbols, graphics, or graphical features are assigned respectively for each category (“. FIELD “2. ITEM NAME” etc.) of the definition item above described in the above definition element symbol table. When the definition item category of the click specification target is determined as above, the system erases the special display (click display) of the click-specified portion and displays a symbol, a graphic, or a graphical feature preliminarily allocated to each specified definition item. For example, those defined in the definition element symbol table shown in FIG. 11 are displayed for the specific display allocated to the definition items.

The system determines whether the click-specified target is a character string or a cell column based on the click-button press-down information from the mouse 14 and repeatedly checks the movement track position information of the mouse pointer against the character string data position information of the characters or the cell data position information of the cells in the table form management application screen 33 to identify the click specification target. The position information of the characters in the character string may individually be calculated based on the beginning position information and the character pitch information in the corresponding character string data.

If the click specification target identified as above is a cell column, a cell data chain is created by sequentially linking cell data of the constituent cells with forward pointer information and backward pointer information thereof, and an address of the beginning cell data is set in the “specification target data address” portion of the “specification target data”. If one data field forms a matrix of cells as in the case of the icon disposing field of this example, a chain may be created for each line of the upper edge in the cell data chain and the last cell of each line may be linked to point the beginning cell of the next line.

If the click specification target identified as above is a character string, an address of the character string is set in the “specification target data address” portion of the “specification target table”. If the click-specified character string is a partial character string of a character string having one piece of the character string data created, corresponding character string data may newly be created respectively for the click-specified partial character string and the remaining character string. The beginning positions of the character strings divided as above may be calculated based on the beginning position information and the character pitch information in the original character string data.

If a user performs the above defining specification for all the item names and the data fields on the document and then specifies an “execution” button 94 on the sub-screen 90, this causes the system to find a corresponding item name for each data field to create and generate “item definition data” correlating the both elements, then storing it into the definition data storage unit 54 in the corresponding file information allocation area.

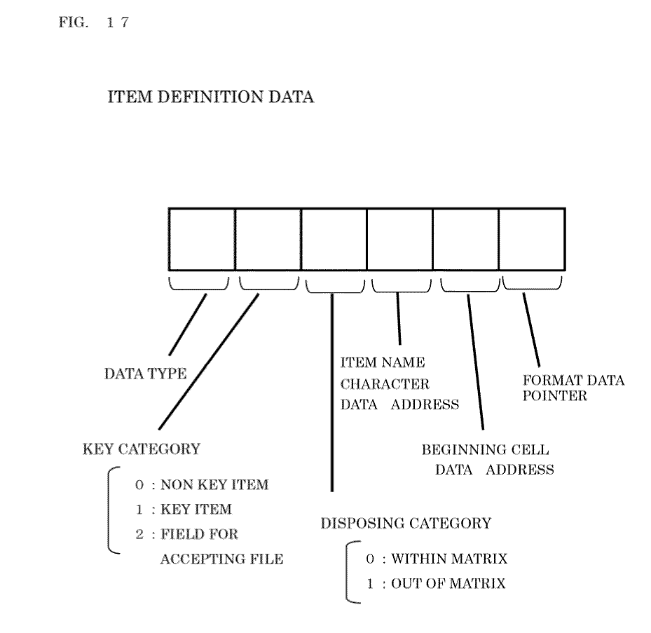

FIG. 17 shows a format of the item definition data. The character string data address of the corresponding item name character string is set in a “corresponding item name character string data address” portion, and the address of the beginning cell data of the cell data chain is set in a “beginning cell data address” portion. The character string data address and the beginning cell data address of the corresponding item name character string may be readout from the “specification target data address” portion of the “specification target table”.

A combination of the data field and the corresponding item name may be identified in the following order. First, a combination of the item name character string and the data field linked by the above linking line is identified from the item names and the data fields registered in the specification target data.

It may be determined that the item name character string and the data field area registered in the specification target data are disposed at predetermined positions of the both ends of each line segment entered as the above definition entry information. This determination may be performed by repeatedly checking the position information of the both ends of the corresponding ruled line data against the character string data of the item name character strings registered in the specification target data or the cell data position information of the data field constituent cells registered in the specification target data. In this example, a combination of the item name character string “FILE NAME” and the data field thereof is selected at this step.

A combination of the data field located at the above “specific adjacent position” and the item name is then identified from the item name character strings and the data fields remaining in the specification target data. This may be performed by repeatedly checking the character string data of the item name character string against the cell data position information of the data field constituent cells.

If two or more data fields located at the “specific adjacent position” are identified for a certain item name character string, a data field without another item name character string entered at the adjacent position thereof is selected. In this example, a combination of the item name character string “BRANCH” and the data field thereof in the first column is selected at this step. The neighboring relationship of the item name character string and the data field may also be identified by repeatedly checking the character string data of the item name character string against the cell data position information of the data field constituent cells.

An adjacently entered combination is then selected from the item name character strings and data fields remaining in the specification target data. In this embodiment, a combination of the item name character string “YEAR” and the data field thereof in the first line is selected at this step. Lastly, if a combination of the remaining item name and the data field is uniquely defined, the combination is selected. Further provided with an agreement with a user such that a data field for which no corresponding item name is related, is to be defined as the icon disposing field, a data field for which no corresponding item name can be recognized with, is identified as the icon disposing field.

After identifying the combinations of the data fields and the corresponding item names to create the item definition data, it is determined whether the item name character strings specified to the above definition item category “3. REGISTERED WORD” is the “TARGET” registered in the applied term dictionary 52 or a synonym thereof. If this determination is positive, the corresponding data field is considered as a icon disposing field, then the corresponding code “2” being set in the “category” field of the item definition data.

Further for the item name character strings specified to the definition item category “1. KEY ITEM NAME” is given, the corresponding code “1” is set in the “category” field of the item definition data, and for the item name character strings specified to the definition item category “4”. NON-KEY ITEM NAME” is given, the corresponding code “0” is set therein.

Next the “disposing category” is determined for each data field related to the item names as above. If each constituent cell of a data field is located adjacent to the icon disposing field or at a uninterrupted position to the icon disposing field with another data field or a entering cell of an item name disposed intermediately, the corresponding code “0” is set as “inner” in the “disposing category” field of the item definition data. If the judgment cannot be obtained, the corresponding code “1” is set as “outer” therein.

To do that each constituent cell is fetched one by one from each data field and the location thereof is compared repeatedly with the location of each constituent cell of each of the other data field and entering cells of the item name. The location of each cell can be read from the location information in cell data.

In the file managing table form shown in FIG. 5 or FIG. 6, for the icon disposing field icon definition data is generated wherein the code “2” is set as the “key category” information and the code “0” is set as the “disposing category” information, and for each of the other data fields icon definition data is generated wherein the code “1” is set as the “category” information and the code “0” is set as the “disposing category” information. Icon definition data generated as above are stored in the definition data storage unit 54 provided in the corresponding file. A storing area can be provided for each category of the disposing destination in the definition data storage unit 54.

The file managing table form may temporarily be saved by clicking the “save” button always displayed on the table form management application screen 33. If a saved name is input of a save operation guide screen (not shown) subsequently displayed and an “execution” button is specified on the save operation guide screen, the corresponding table form management application screen 33 disappears from the display screen 20a, and the all relevant data including the generated data of the table form management application activated currently is stored as a file information in a appropriate position in the external memory 18. And then instead the icon representing the file information of the corresponding file managing table form to be stored, is displayed at a appropriate position in the display 20a. The icon to be displayed is assigned with a image proper to the table form management application.

It is assumed that the environment control program generates “icon definition information” for the corresponding file information to be stored in the system and that icons are displayed on the desktop screen based on this information. “The icon definition information” is in a known method made up of ID (pointer) information, icon display position information on the display screen 20a or the desktop screen, pointer information for the corresponding main file information or the corresponding window screen, pointer information for image data representing the icon image, and “disposing destination pointer information” that is a pointer information to the windows screen on which the icon is pasted, or a pointer information to the corresponding file data etc.

When a icon of the table form management application is given double-clicking on the display screen 20a, in response to this operation, after the corresponding file information stored in the external memory 18 is loaded into an area allocated in the internal memory 16, the table form management application screen 33 is displayed on the display 20a and the corresponding table form management application program is activated. The activated table form management application program displays the content of the corresponding file information on the table form management application screen 33.

A managing target CSV file is managed as one file by the environment control program in a known method in the embodiment system; the file is represented by an icon displayed on the desktop screen; and if the icon is specified in a certain way on the display screen 20a, one window screen is generated on the display screen 20a to display contents of the corresponding file.

A user brings an icon into a desired position by the drag and drop operation in the desktop screen, in response to the drag and drop operation of the icon, the environment control program redisplays the icon image at the position of the drag and drop operation on the desktop screen in a known method and recognizes the windows screen of the application program in which the drag and drop destination position of the icon is included, among a plurality of windows screens of application program displayed on the desktop screen. Thereafter the corresponding file of the window screen of the application program is registered indicated by the “disposing destination pointer information” in the corresponding icon definition information and the corresponding application program is informed of the registration.

If the table form management application screen 33 is currently displayed on the desktop screen and an icon is dragged and dropped onto the table form management application screen 33, the corresponding table form management application program is notified by the above environment control program, calculates the icon pasted position on an icon paste target document (document with the file managing table form entered) as the “document icon position information”, and if the pasting destination position is included within the table form, recognizes the pasting destination cell of it. Thereafter the “icon pointer data” indicating the corresponding icon definition information is generated, then the address of it being set in the “character string data address storage portion” in the cell data of the cell into which the icon is pasted. In the case a application making language wherein one address storing portion cannot point different data forms of data, is used, a “icon pointer data address storage portion” is provided newly in the cell data, then different data forms of data being indicated thereby.

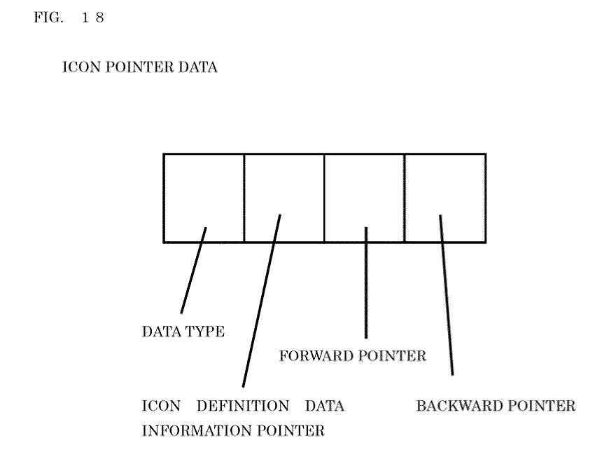

The “icon pointer data” includes the “icon definition information pointer” indicating the corresponding icon definition information, the “forwardpointer”, and the “backward pointer” as shown in FIG. 18. When a plurality of cells are pasted in a cell, a “icon pointer data chain” is generated wherein each icon pointer data is connected each other with the “forward pointer” and “backward pointer”, and then the address of the beginning icon pointer data of it is stored in the “character string data address portion” in the cell data of the cell into which the icon is pasted. The “related data pointer” in the icon pointer data is described below. In addition the “icon pointer data” of the table form management application or the address of it can be registered in the specified location within the corresponding file information itself.

The pasting destination cell of an icon may be obtained by repeating to compare the document position of each cell within the icon disposing field of the corresponding file managing table form with the “document icon position information” of said icon. The “document icon position information” of each icon within the icon disposing field is registered as the information in the corresponding cell data.

The “document icon position information” of an icon may be obtained by subtracting from the position of the corresponding icon on the desktop screen both a relative position of the corresponding table form management application screen 33 on the desktop screen and a relative position of the corresponding icon pasting target document on the corresponding table form management application screen 33.

The position of an icon on the desktop screen and the relative position of the table management application screen on the desktop screen are managed by the environment control program, and the relative position of the corresponding document within the corresponding table management application screen are managed by the corresponding table management application.

When an icon representing a file information of the “disposing source” file managing table form is pasted into a cell in the icon disposing field of the “disposing destination” file managing table form, first the file pointer information indicating the corresponding file information of the “disposing destination”, that is, the pasting destination file managing table form is set in the “disposing destination pointer information” in the icon definition information of the icon, and further the address of the “icon pointer data” of the corresponding icon is set in the “character string data address portion” or in the “icon pointer data address storage portion” within the cell data of the pasting destination cell (hereafter named the “disposing destination cell”) in the “disposing destination” file managing table form.

The details of the cell data are described below. An icon representing the file information of a managing target CSV data file is pasted on a file managing table form in the similar method. In addition the pointer information of the corresponding file of the disposing destination file managing table form and the cell data address of the disposing destination cell on the file managing table form can be registered in the “icon pointer data”.

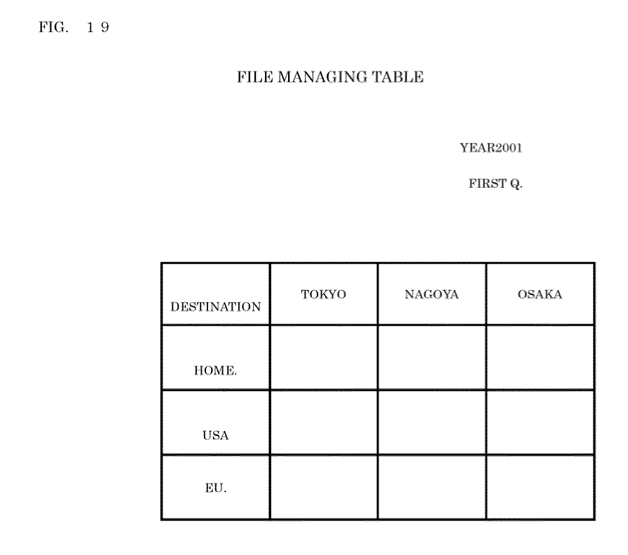

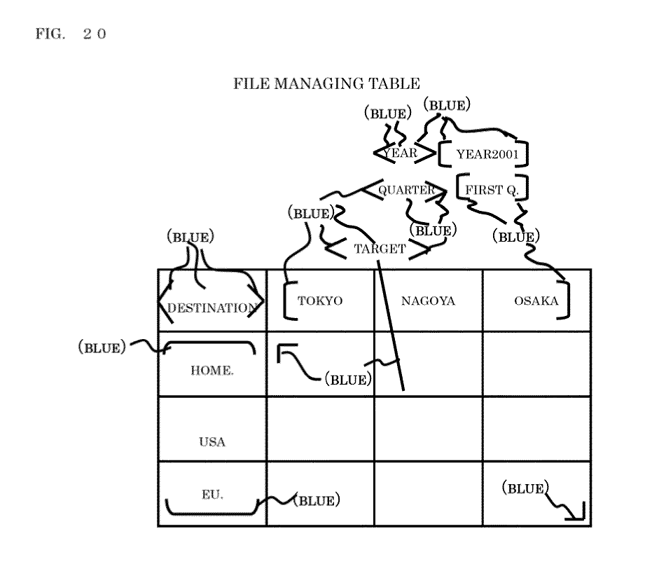

Next the batch copy function of icons of the system is explained. A user makes a file managing table form shown in FIG. 19 in order to manage the group of the CSV files described above in a different viewpoint from the management using the composite file managing table form

In the file managing table form shown in FIG. 19, “TOKYO”, “NAGOYA”, and “OSAKA” are entered in a first row from the top of it as data names of the item name “BRANCH”, that is a common condition of management target data CSV files, and “HOME”, “USA”, and “EU” are entered in a first column from the left as data names of a common condition “DESTINATION” of the management target data files.

Further, “YEAR2001”, a data name of the item “YEAR” and “FIRST Q”, a data name of the item name “QUARTER” are entered, next to each other over two rows in the upper right part outside of the matrix of the table form, as the “common condition” to be referenced for all the management target data files stored in the file managing table form.

As described above the file managing table form shown in FIG. 19 is created in the aim to be capable of fetching out various management targets obviously at a glance on one sheet of file managing table form, for which “FIRST Q” and “YEAR2001” are fixed conditions respectively regarding the item “QUARTER” and “YEAR”, and data names for the other item names varies.

Relating newly an icon of a management target CSV file to the file managing table form shown in FIG. 19 (pasting of a corresponding icon) is performed in the method of the “batch copy” of icons of management target files between file managing table forms if icons of management target files are heretofore stored on a file managing table form.

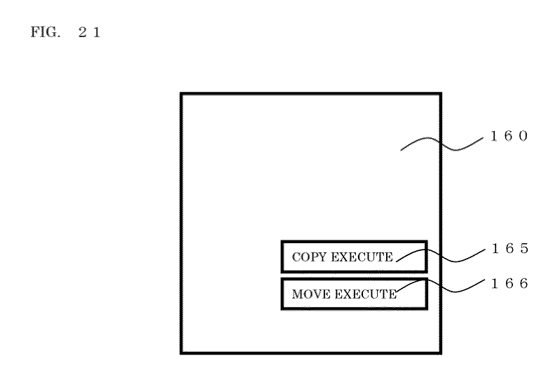

The batch copy of icons of management target files between file managing table forms is performed in the embodiment as described below. First the copy destination file managing table form shown in FIG. 19 is created similarly according to the method described above and then is displayed in 33 in 20a shown in FIG. 20.

After the designation of the “1. FIELD” for each data field are performed in the similar method as in the file managing table form shown in FIG. 5 or FIG. 6, and the designation of the item names for the data field is performed. As the item name of the data field on the first column of the table form, a character string “DESTINATION” entered as a index word of it adjacently to the upper side thereof is directly used and is clicked and specified before the “2. ITEM NAME” is specified on the sub-screen 90.

For the data field in the first row, because entering of the index word is omitted, a character string “BRANCH” is additionally added with “blue color” as the “definition entering information” at an arbitrary position outside of the table form adjacent to the first row of the table form, and the “2. ITEM NAME” is specified similarly on the sub-screen 90, then being related to the corresponding data field with a linking line entered with “blue color” as the “definition entering information”.

Regarding the icon disposing field, a term “TARGET” is additionally entered with “blue color” as the “definition entering information” in an arbitrary blank space outside of the table and designated as the “3. REGISTERED WORD” on the sub-screen 90, then being related to the corresponding data field with a linking line entered with “blue color” as the “definition entering information”.

A character string “YEAR2001” or “FIRST Q” which are entered outside of the matrix of the table form to represent the “common condition data” is clicked and specified respectively, then being designated as the “4. DATA NAME” on 90. Subsequently in the leftward adjacent part to each of the common condition strings, a character string “YEAR” or “QUARTER” is entered additionally respectively with “blue color” as the “definition entering information” and the “2. ITEM NAME” is specified similarly on the sub-screen 90.

In the agreement with users, data which are entered “outside of the matrix of the table form” and are provided with the item definition data described above are referenced as the related data especially as the “common condition” for each cell within the icon disposing field of the corresponding file managing table form. Entered data which is not located adjacent to the icon disposing field nor located at a linked position with another data field or a entering cell of an item name disposed intermediately as described above, is called data “outside of the matrix of the table form”.

A file managing table form which is provided with the format definition by the above designation operation, is displayed with the symbols representing the definition appended as shown in FIG. 20. Further the definition data generated is stored in the definition data storage unit 54 provided within the corresponding file as described above.

First as in the case of file managing table form shown in FIG. 5 or FIG. 6, for the icon disposing field icon definition data is generated wherein the code “2” is set as the “category” information and the code “0” is set as the “disposing category” information. Further for each of the other data fields icon definition data is generated wherein the code “1” is set as the “category” information and the code “0” is set as the “disposing category” information.

For each of the “common condition” defined outside of the matrix of the table form, icon definition data is generated wherein the character data address of the corresponding data name is set in the beginning cell data address storing portion instead of the beginning cell data address, and the code “1” is set as the “disposing category” information thereof and the code “1” is set as the “category” information thereof.

The icon batch copy function may be performed following directly the definition operation described above, or may be performed on a file managing table form opened again after it has been given the definition operation and stored in the external memory 18.

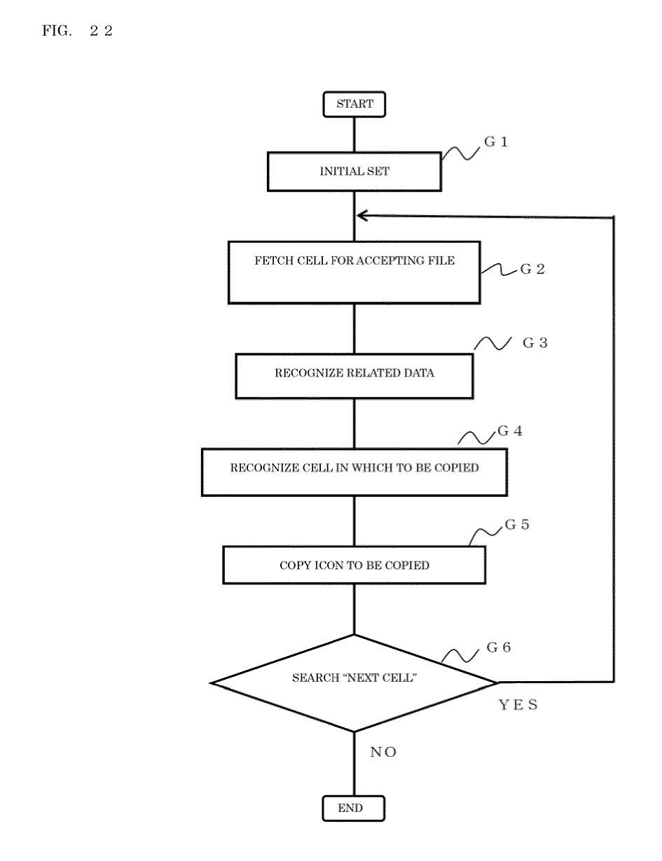

When a user specified a “input” button 151 always displayed on the table form management application screen 33 displaying the file managing table form of the copy destination, “the input tray 160 ” is displayed shown in FIG. 21. When he drags the icon of the file corresponding to the file managing table form shown in FIG. 12, that is the parent file managing table form of the copy destination, into “the input tray” 160 “and directly specified the “copy execute” button 165, the system initiates the “file icon batch copy process”.

In addition he may specify the “move execute” button 166 provided in the “input tray” 160 at this stage. In this method icons which are selected from the file managing table form of the copy source and disposed into the file managing table form of the copy destination are deleted from the file managing table form of the copy source as described below.

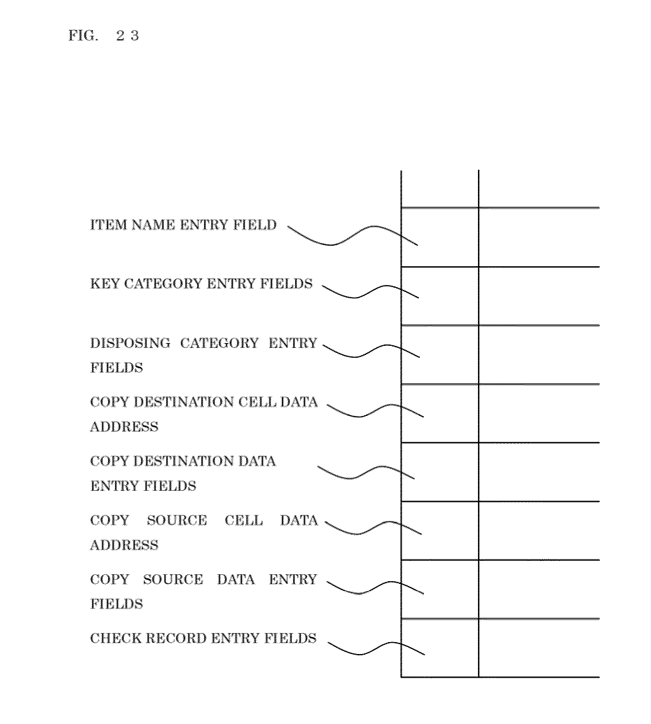

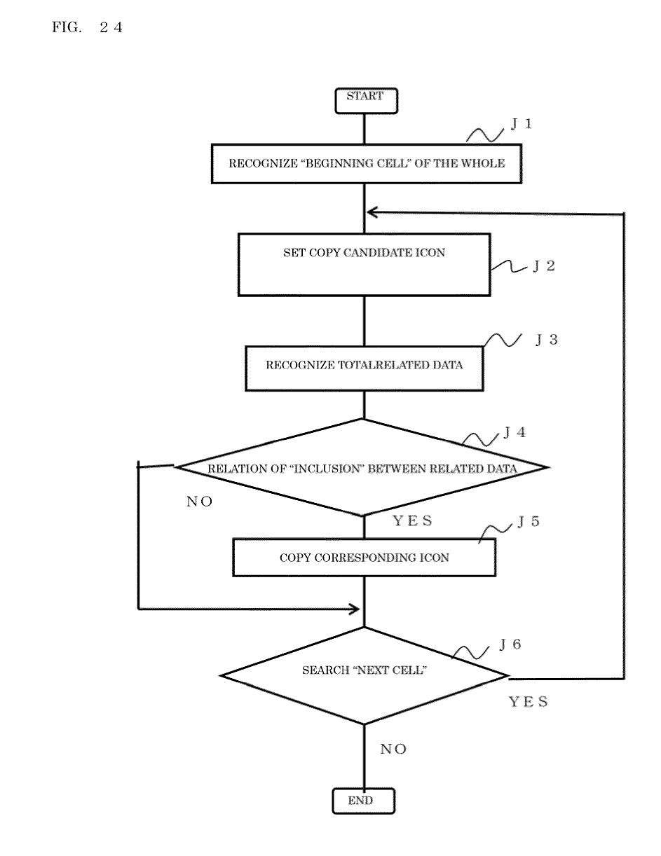

The details of the “file icon batch copy process” by the system is explained according to the sequence shown in FIG. 22. First as the initial process (Step G1), the copy work table (hereafter being called “work table”) the configuration of which is shown in FIG. 23 is generated. In the work table the related data recognized for each cell in the icon disposing field of the file managing table form of the copy destination and the related data recognized for each cell in the icon disposing field of the file managing table form of the copy source are set and then compared each other.

The item names of the record defined related to the data fields on the file managing table form. Of the copy destination are entered into the “item name entry fields” on the first row of the work table. In the case of this example, “BRANCH”, “YEAR”, “TARGET”, “DESTINATION”, and “QUARTER” are entered. A “key category” of the item name is entered into a key category entry field on the second row of the work table. A corresponding code “2” is entered in the field corresponding to the item name “TARGET” to indicate that this is the item name of the icon disposing field. For the other item names, if the corresponding item name is the key item name, the corresponding code “1” is entered in the field of the item name, and if the corresponding item name is not the key item name, the corresponding code “0” is entered in the field of the item name.

The disposing category of a data field on the file managing table form of the copy destination is entered into the “disposing category entry field” on the third row of the work table, the corresponding code “0” being entered if the data field is disposed “within the matrix of the table form” described above, the corresponding code “1” is entered if the data field is disposed “outside of the matrix” described above.

In the specification, a combination of data or cell storing the data which are to be referenced concurrently on a table form are named the “related data” especially. The address of the cell data of the cell within the icon disposing field of the file managing table form of the copy destination fetched currently or the cells storing the related data of said cell in the icon disposing field, are set in the “copy dest cell data address entry field” on the fourth row of the work table, further into the fields corresponding to the corresponding item name (the fields on the same column as the corresponding item name is entered).

The data content of the cell the cell data address of which is set on the corresponding column of the fourth row of the work table, are set in the “copy destination data entry field” on the fifth row of the work table. In the corresponding field of the item name “TARGET” therein, an “icon pointer data” indicating the icon definition information of the corresponding icon copied from the copy source is set.

The address of the cell data of the cell within the icon disposing field of the file managing table form of the copy source fetched currently or the cells storing the related data of said cell in the icon disposing field, are set in the “copy source cell data address entry field” on the sixth row of the work table.

The data content of the cell the cell data address of which is set on the corresponding column of the sixth row of the work table, are set in the “copy source data entry field” on the seventh row of the work table. In the corresponding field of the item name “TARGET” therein, an “icon pointer data” indicating the icon definition information of the icon pasted in the corresponding icon disposing field is set. In the other entry fields the corresponding related data is set respectively,

In the “check record entry field” on the eighth row of the work table the check record are set that a cell or data in the cell fetched from the file managing table form of the copy destination is compared with a cell or data in the cell fetched from the file managing table form of the copy source in the following process. Therein the “0” is entered as the initial value, and the code “1” is entered in the corresponding entry field of the item name regarding which the comparison is performed.

For example, the work table described above may be implemented as follows. A list data is provided for each data entry field on the work table, and stores thereon data in the corresponding data entry fields as well as row-direction point data and column direction point data such that the data in the adjacent data entry fields may sequentially be tracked in the row direction and the column direction.

In the initial process (step G1), after the formatting data of the work table is set as above, the corresponding data are set respectively in the “item name entry fields” on the first row, in the “key category entry fields” on the second row, or in the “disposing category entry fields” on the third row. Item definition data is fetched out one by one stored in the file data corresponding to the file managing table form of the copy destination, and then the corresponding data of the “item name” information, “key category” information, and “disposing category” information set in each icon definition data are read, then being set in the corresponding field of the work table. In addition in a agreement with users such that the related data which is not a key item name is not to be entered in a file managing table form, the setting of the “key category” information described above can be omitted.

In the case of this example, as the “item names” “BRANCH”, “YEAR”, “TARGET”, “QUARTER” AND “DESTINATION” are entered, and regarding the “key category”, “2” is set for the item name “TARGET” while “1” indicating the “key item” is set for the other item names. Regarding the “disposing category”, “0” indicating the “within the matrix” is set for the item name “BRANCH” and “DESTINATION”, while “1” indicating the “outside of the matrix” is set for the item name “YEAR” and “QUARTER”.

When a start position is set to a position of fetching the cell from the icon disposing field of the file managing table form of the copy source at the end of the initial setting process (step G1). For example, if the icon disposing field is in the form of matrix, the cell at the upper left corner of the icon disposing field is recognized as the cell at the start position of the fetching, the cell data address of it being set in the corresponding position in the “copy destination cell data address entry field” on the fourth row of the work table. The cell at the upper left corner of the icon disposing field can be recognized by fetching cell data for each cell within the icon disposing field and comparing the positional information set therein each other repeatedly.

Next an cell is recognized sequentially one by one in the icon disposing field of the file managing table form of the copy destination and then the cell data of it is set respectively on the “copy destination cell data address entry field” on the fourth row of the work table (Step G2).

With regard to the order of fetching the cells from the icon disposing field, for example, if the icon disposing field is a form of a matrix, the cell at the upper left corner of the icon disposing field may be defined as the cell at the start position of the fetching; the cells may sequentially be fetched from the left side in the same row; and the same operation may be repeated in the next lower row after all the cells are fetched in one row. The sequential fetching of the cells can be performed by repeating the comparison of the positional information in the cell data of each cell each other.

Subsequently for a cell fetched from the icon disposing field the related data is recognized on the table form, and is set respectively in the corresponding entry field on the work table (Step G3). First as the related data “within the matrix of the table form”, a cell (or data in the cell) located upward on the same column and leftward on the same row as the corresponding cell within the icon disposing field is recognized.

Among the icon definition data generated in the corresponding file, the icon definition information the “disposing category” information of which has the code “0” indicating “within the matrix of the table form” set is selected, and then on the basis of the beginning cell data pointer information set therein, cell data of the cells constituting the corresponding data field are sequentially fetched, and the positional information therein are compared repeatedly with the positional information of the corresponding cell within the icon disposing field so that the desired cell in the above positional relation with the cell within the icon disposing field is selected.

Further if icon definition data the “disposing category” of which has code data “1” indicating “outside of the matrix of the table form” set is found in the sequential fetching, the data name defined in said icon definition data is regarded as the related data “outside of the matrix of the table form”, that is, the related data common for each cell within the icon disposing field, then the data being set in the corresponding entry field in the work table.

For example, for the cell located on the third row from the top and on the third column from the left, on the file managing table form shown in FIG. 19, the combination of the related data “USA” for the item name “DESTINATION” and “NAGOYA” for the item name “BRANCH” are recognized “within the matrix of the table form”, and the related data “YEAR2001” for the item name “YEAR” and “THE FIRST Q” for the item name “QUARTER” are recognized “outside of the matrix of the table form”.

With regard to the related data recognized as above for the cell fetched from the icon disposing field currently, first the cell data address of the cell storing it is set in the corresponding field in the “copy destination cell data address entry field” on the fourth row of the work table, and then the related data itself is set respectively in the corresponding field in the “copy destination data entry field” on the fifth row of the work table.

The system next selects among managing-target files stored on the source composite file managing table form, files which are to be copied into a cell within the file disposing field of the destination table form concurrently fetched out. (Step G4). It is a way for that to select among managing-target files stored on the source file managing table form, files each related data of which is “included” by related data of the same item recognized for said cell within the file disposing field of the destination table form, said items being defined as “key items” on the destination table form.

That is to select a cell wherein the set of item names defined on the source table form includes the set of item names defined as key item on the destination table form and further data of each item name of the copy source is included by data of the same item name of the destination, said item names being defined as key item on the destination table form. The relation of “include” used herein includes the relation of equal between the both.

In addition on the case it is promised to users that all related data written in the file managing table form are regarded as data of key item, the above mentioned matching are executed for all the items defined on the table form.

Explaining as an example the above mentioned cell on the third row from the top and on the third column from the left in the file disposing field of the destination table form, files are retrieved among managing-target files stored on the source file managing table form wherein the set of items of related data thereon include the set consist of “DESTINATION”, “BRANCG”, “QUARTER”, and “YEAR”, and furthermore data for item “DESTINATION” include (or the same to) “USA”, data for item “BRANCH” include (or the same to) “NAGOYA”, data for item “QUARTER” include (or the same to) “first QUARTER”, and data for item “YEAR” include (or the same to) “YEAR2001”

Step G4 is executed by the sequence of recognizing total related data as a set of all related data recognized from the total of the composite table form for each managing target icon fetched out sequentially from the file managing table form, and next by the sequence of selecting icons the total related data of which is “included” in the meaning mentioned above by the related data of said cell of the destination table form.

Many method of fetching out each constituent element of the lowest layer in a tree type structure such as the composite file managing table form are common knowledge. To do this, it is a way to fetch out sequentially a file managing table form of the lowest layer on which managing target icons are pasted, and furthermore to fetch out sequentially constituent cell of the icon-disposed field of said file managing table form in predetermined order, and to recognize the related data described above for each cell fetched out.

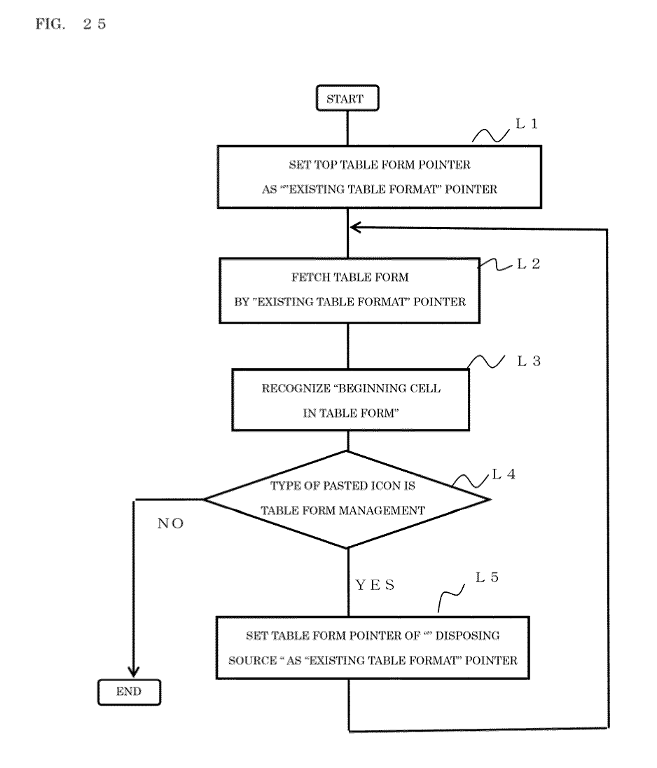

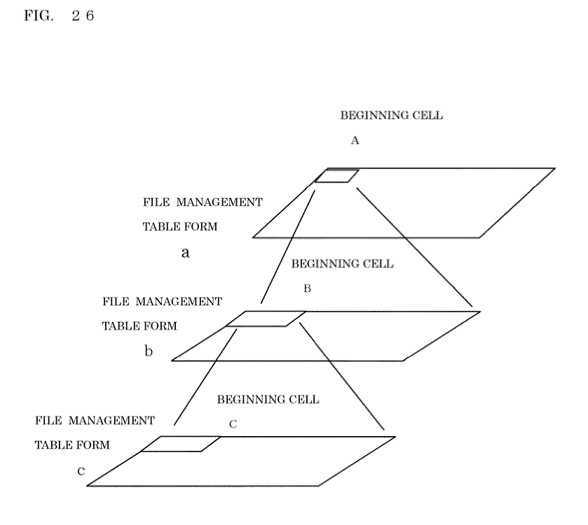

Step G4 is executed according the sequence illustrated FIG. 24. In said sequence “beginning cell” to be first fetched from the source file managing composite table form of hierarchical type is recognized as initial set (Step J1). Step J1 is executed according the sequence illustrated FIG. 25. In Step J1 first as the initial setting, information data pointer indicating the “top” file managing table form of the hierarchical composite file managing table form is set on “the pointer of the existing file managing table form”, the existing file managing table form” representing the file managing table form concurrently fetched and in processing (Step L1).

The “top” file managing table form of the hierarchical composite file managing table form can be recognized as the table form designated as the source table form by an user operation to drag its icon into said tray 160. A “top” file managing table form of a hierarchical composite file managing table form is generally recognized as a table form which has no icon representing it, or as a table form, the icon of which is not pasted onto another file managing table form, that is recognized as a table form wherein a file designated by “the destination pointer information” in the corresponding icon definition information is not of the type of “the table form management application”.

Next the corresponding file data is fetched into the internal memory-16 based on “the existing pointer of the managing table form” to open the corresponding file managing table form (Step L2), and the address of the cell data of “the beginning cell” is set in “existing cell data pointer” provided at a specified position in the internal memory-16, wherein the “beginning cell” is specified as the cell is to be first fetched out from the icon-disposing field in the file managing table form is recognized on basis of a determined criterion. For example, the cell located at the upper-left corner of the icon-disposing field as mentioned above (Step L3).

Next the corresponding icon definition data is fetched on the basis of the icon pointer data, the address of which is set on the character data address storage portion or the icon pointer data address storage portion of the recognized “beginning cell”, and the application type information thereof recognized (Step L4). Then if the determined application type is “the table form management application”, the pointer information to the file data itself corresponding to said icon is set onto “the pointer to the existing managing table form” (Step L5).

To execute Step L4 on the case where plural icons are pasted in one cell, it is a way to fetch out the icon definition data indicated by the icon pointer data located at the beginning of the corresponding icon pointer data chain.

Next the process control returns to Step L2 wherein the corresponding file managing table form is opened based on the “the existing pointer of managing table form” renewed just now, and then “the beginning cell” is recognized using the same method (Step L3). Till an application kind other than the kind of “the table form management application” is determined in the next step L4, the steps following L5 are repeated.

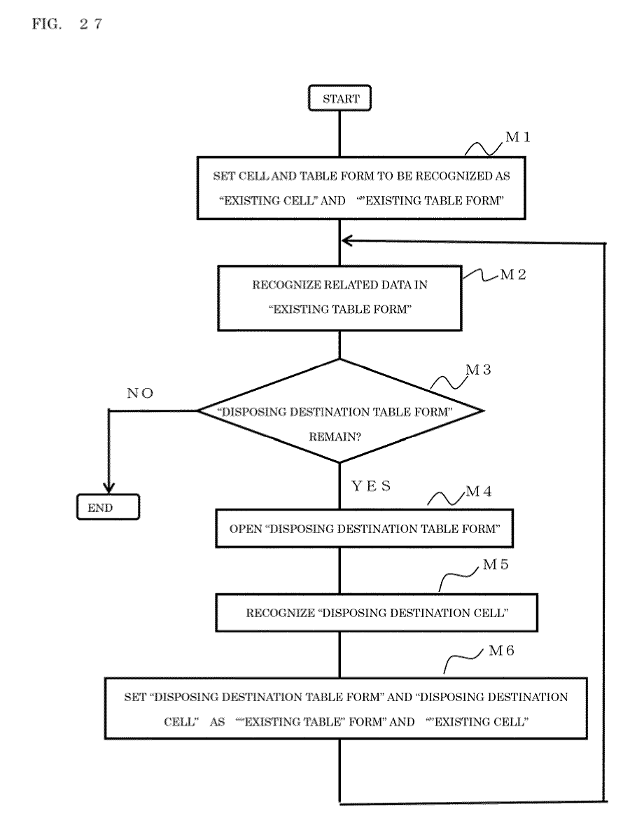

Thus for example regarding a hierarchical composite file managing table form illustrated as a pattern in FIG. 26, “the beginning cell” A is recognized in the top file managing table form a, next “the beginning cell” B is recognized in the file managing table form b represented by the icon pasted into the cell A, and next “the beginning cell” C is recognized in the file managing table form c represented by the icon pasted into the cell B. The file managing table form c being a lowest file managing table form in the hierarchical composite file managing table form, the cell C on the file managing table form c is recognized as “the beginning cell” of the total hierarchical composite file managing table form.

At the time Step J1 is exited, the file managing table form in which “the beginning cell” of the total composite file managing table form, the destination output of the process is located, is opened in the internal memory 16 as “the existing managing table form” indicated by “existing managing table form pointer”, and furthermore “the beginning cell” of the total composite file managing table form itself is set as the existing cell” indicated by “the pointer to “the existing cell”.

Next the data representing “existing managing table form” and “existing cell” as described above is set respectively as the data for “the copy candidate file managing table form” and “the copy candidate cell” in the composite file managing table form as described below (Step J2).

That is, the address of “the pointer to existing managing table form” is set on “the pointer to the copy candidate table form file” and the address of “the pointer to the existing cell data” is set on the corresponding field in the “copy source cell data address entry field” on the sixth row of the work table. Furthermore “the icon pointer data” is set on the corresponding field in the “copy source data entry field” on the seventh row of the work table, wherein the address of “the icon pointer data” is set on the “character string data address storage portion” in the cell data indicated by “the pointer to the existing cell data”, or on the icon pointer data address storage portion.

On the case plural icons are pasted on the copy source cell, each of the icon pointer data is fetched out from the icon pointer data chain, and based on it the new icon pointer sharing as a pointed destination the same icon definition information with it is generated, wherein the address of the beginning constituent data of the icon pointer data chain is set on the “character string data address storage portion” in said cell data or on the icon pointer data address storage portion. Then the generated icon pointer data is connected each other sequentially to form a new icon pointer data chain, the beginning data of which is set on in the “copy source data entry field” on the seventh row of the work table.

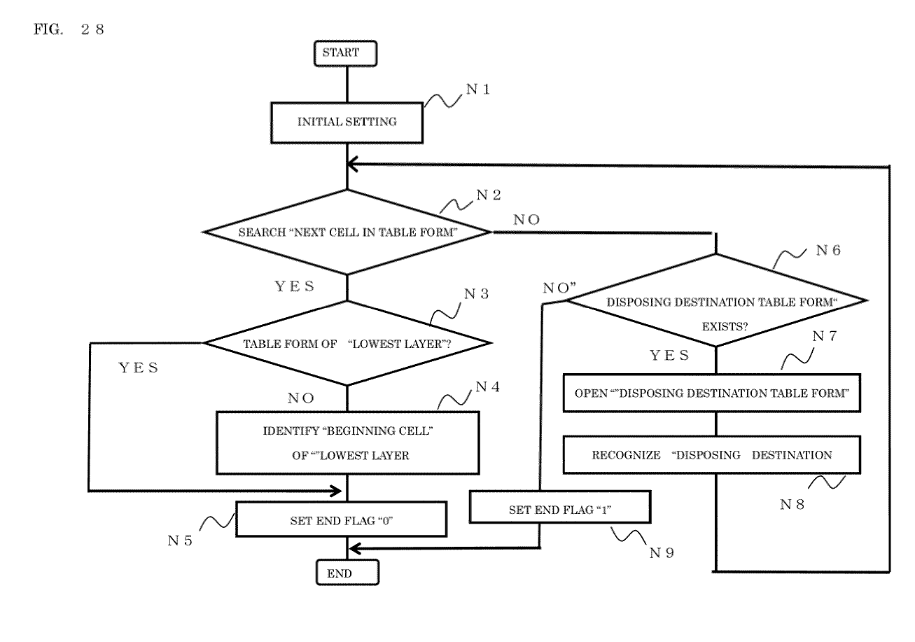

Next the total related data regarding the whole of the hierarchical composite file managing table form is recognized for “the copy source candidate cell” set in Step J2 as described above (Step J3). Step J3 is executed according to the sequence illustrated in FIG. 27.

In Step J3, first as the initial set process of said step, the cell data address of “the copy source candidate cell” and the file pointer of the “the copy source managing table form”, which are fetched out, are set respectively onto “the existing cell data pointer ” and “the existing managing table form pointer”, the parameters indicating the current processing target in said sequence (Step M1). At the starting time of said sequence (Step G4), “the beginning cell” described above and the address of the file managing table form the icon of which is disposed in the beginning cell are set onto these parameters.

Next on “the existing managing table form” the related data are recognized for “the existing cell” within the icon-disposed field (Step M2). First the related data are recognized on “the existing managing table form” on a file managing table form where the corresponding managing target icon is pasted. Related data recognized from the corresponding file managing table form for a cell within the icon deposing field are obtained using the relative positional relation on the table form as described in the explanation of the Step G3 above.

The related data recognized are respectively set on the corresponding field in the “copy source data entry field” on the seventh row of the work table, while the cell data address of the cell storing the related data are respectively set on the corresponding field in the “copy source cell data address entry field” on the sixth row of the work table.

Next it is judged that “the disposing destination managing table form” onto which the icon of “the existing managing table form” is pasted (Step M3), and if “the disposing destination managing table form” exists the corresponding file data is opened. (Step M4). “The disposing destination managing table form” onto which the icon of “the existing managing table form” is pasted can be recognized based on “the destination pointer information” in the icon definition information of the icon representing “the existing managing table form”, the icon definition information being fetched out based on “icon pointer data” registered in the corresponding file data of “the existing managing table form”.

Next on said newly fetched out “the disposing destination managing table form”, “the disposing destination cell” is recognized onto which the icon corresponding to “the existing managing table form” is pasted (Step M5). Said “disposing destination cell” onto which the icon representing “the existing managing table form” is pasted, can be recognized as the cell, wherein the icon definition information indicated by the “icon pointer data” corresponding to said cell, is the same as the icon definition information indicated by “the self icon pointer data” of “the existing managing table form”, the address of icon pointer data being set in “the character string data address storage portion” or “the icon pointer data storage portion” in cell data for each cell within the icon disposing field of said “disposing destination managing table form”.

Next “disposing destination managing table form” and” disposing destination cell” is set respectively as “existing managing table form” and “existing cell” (Step M6), and then the process returning to Step M2, the related data are recognized and set on the worktable as described above. As long as “the disposing destination cell” is judged to exist in the following Step M3, the procedure after Step L4 is repeated. IF “the existing managing table form” is judged to be the top file managing table form without “disposing destination cell”, the procedure is terminated.

The total related data which are recognized from the whole hierarchical composite file managing table form for a cell of the copy source are thus obtained as those to which related data recognized for each layer are summed up, each layer being sequentially ascended in the file managing table form, in the method wherein each related data is sequentially added into the “copy source data entry field” on the seventh row of the work table.

In order to retrieve a file stored in a file managing table form on a retrieval condition, it is a way to repeat matching the total related data recognized for each cell in the composite file managing table form as described above to said retrieval condition, regarding total related data as data to be referenced concurrently at a time to reference a file the icon of which is disposed in said cell. In case that retrieval condition for a file is provided in the form of a product of plural items, it is a way to find an icon, wherein regarding each item of said retrieval condition, data included by corresponding data constituting said condition is sure to exist among total related data of said icon.

As a special case of what described above, in case of copying a file stored in a composite file managing table form to another file managing table form, it is a way to find an icon for each cell of the copy destination and to copy the icon into said cell, the total related data of said icon including data included by related data of each key item recognized for said cell.

Explaining a case of a CSV file, a managing target the icon of which is pasted for instance in a cell on the third row from the top and on the third column from the left of the file managing table form of the copy source illustrated in FIG. 6, first the combination of data consisting of “the SECOND Q.” for the item “QUARTER”, “USA” for the item “DESTINATION is recognized as the related data on the disposing source file managing table form.

Next in case the icon indicating said disposing source file managing table form is pasted onto a cell on the third row from the top and on the third column from the left of the disposing destination file managing table form illustrated in FIG. 5, the combination of data consisting of “YEAR2002” for the item “YEAR”, “NAGOYA” for the item “BRANCH” is recognized as the related data from the disposing destination file managing table form and therefore regarding said managing target CSV file the sum of the both combination of the related data above described is recognized as the total related data of the whole composite file managing table form.

Next related data recognized as described above for cells within the icon disposing fields fetched out respectively from the file managing table forms of the copy source and the copy destination file managing table form are compared with each other on the work table (Step J4).

The comparison between related data has only to be made regarding the key items defined on the copy destination file managing table form now fetched out. Two data which are set on the same column and set respectively on the fifth row and the seventh row of the work table are compared. In the case now described, the comparison between related data are made regarding item names “BRANCH”, “YEAR”, “DESTINATION”, and “QUARTER”.

If the “inclusion” relation described above is judged between data for each item names used for the comparison in the judgment of Step J4, an icon pointer data is generated and is set on the corresponding field in the “copy destination data entry field” on the fifth row of the work table, said icon pointer data indicating the same icon definition information as the icon pointer data set on the corresponding field in the “copy source data entry field” on the seventh row of the work table (Step J5).

On the case plural icons have been already pasted in a cell selected as above, a constituent data of an icon pointer data chain is fetched out sequentially, the beginning icon pointer data of which is set on the corresponding field in the “copy source data entry field” on the seventh row of the work table, and a new icon pointer data is generated which indicates the same icon definition information as the fetched icon pointer data indicates. Then the generated icon pointer data is connected with each other sequentially so as to make an icon pointer data chain, and the beginning icon pointer data is set on the corresponding field in the “copy destination data entry field” on the fifth row of the work table.

In addition if a plurality of icons are selected from the copy source in the whole of Step G4, an icon pointer data generated for each of the selected icons is connected sequentially to the icon pointer data chain, the beginning icon pointer data of which is set on the corresponding field in the “copy destination data entry field” on the fifth row of the work table.

Thus for instance regarding the cell located on the third row from the top and on the third column from the left of the copy destination table form illustrated in FIG. 19, the cell located on the second row from the top and on the third column from the left of the copy destination table form illustrated in FIG. 6, or the CSV file pasted in said cell is selected, having the same total related data as said cell of the above destination side, wherein the icon representing said selected table form is pasted in the cell located the third row from the top and on the second column from the left of the copy destination table form illustrated in FIG. 5.

If in the comparison between the related data, the “inclusion “relation as above described is not recognized between data regarding each item name used for the comparison, Step J5 is skipped and Step J6 searching the next cell” in the icon disposing field is directly executed.

If “the next cell in the icon disposing field” can be fetched out in step J6, the process returns to Step J2 wherein the data linked to the cell are set in the corresponding field for “the copy candidate cell” of the work table and then the procedure following Step J3 are repeated. If “the next cell in the file disposing field” cannot be fetched in Step J6, the whole procedure of Step G4 is terminated, all cells within the icon disposing field being fetched out.

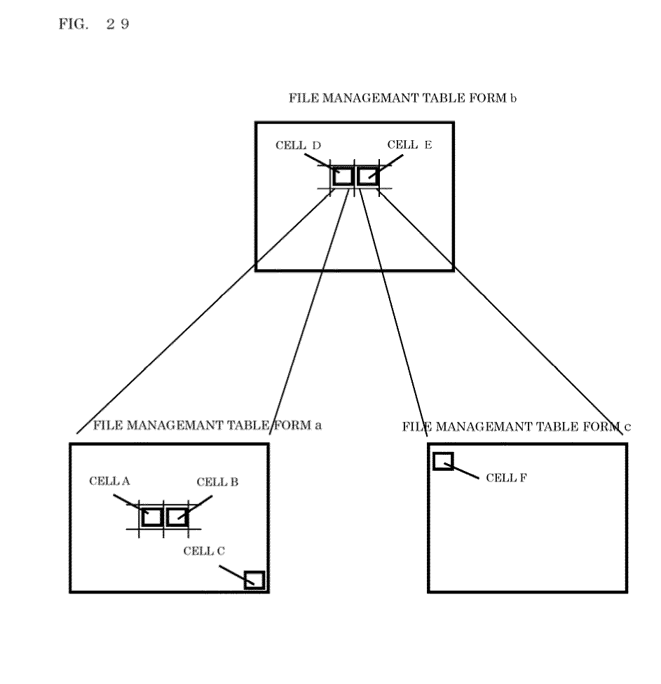

In Step J6 “the next cell” to be fetched out next is recognized for the “copy candidate file managing table form” and the “copy candidate cell” now fetched out from the copy source hierarchical composite file managing table form. Step J6 is executed by the procedure illustrated in FIG. 28, if each file managing table form on which each managing target icon is pasted belong to the same layer in said composite file managing table form.

The “copy source candidate managing table form” is set indicated by the “copy candidate managing table form file pointer” as the designated input data as described above, while the cell data address of the “copy candidate cell” is set on the corresponding field in the “copy source cell data address entry field” on the sixth row of the work table.

First as the initial set, the file pointer to the “copy candidate managing table form” and the cell data address of the “copy candidate cell” as the designated input data is set respectively on the “existing managing table form pointer” indicating the “existing managing table form” and on the “existing cell data pointer” indicating the “existing cell”, the “existing managing table form” and the “existing cell” being targets of the process at the present time (Step N1).

Next the “next cell in the table form” is searched for the “existing cell” in the icon disposing field on “existing managing table form” according to a determined order (Step N2). The searching order is determined according to the method determined in Step L3 included in the procedure of Step J1 (FIG. 25) as described above.

For instance the cell at the left top corner of the icon disposing field being chosen as the “beginning cell” in Step L3, a cell neighboring on the right of said cell is set as the “next cell in the table form” if it exists, and if the “existing cell” is on the extreme right in the icon disposing field, the cell on the next row and on the extreme left of the icon disposing field is set as the “next cell in the table form”.

If the “next cell in the table form” can be searched in Step N2, said searched cell is set as the “existing cell”, and it is judged if the “existing managing table form” is the “lowest file managing table form” in the hierarchical composite managing table form (Step N3). The “lowest managing table form” in a hierarchical composite managing table form is identified as a table form, in the icon disposing field of which icons of managing target files are pasted.

If the “existing table form” is of the “lowest” layer in the hierarchical composite managing table form, the “next cell in the table form” recognized as above is set as the “next cell” that is the output of the whole of the procedure, “0” being set on the “end flag” (Step N5) and then the whole procedure is terminated.

Now the file managing table form designated as the “existing table form” at the start of the whole procedure must be the “lowest” managing table form, icons of managing target files being pasted thereon. Therefore if the “next cell in the table form” can be fetched within the icon disposing field of the same table form for the cell designated “existing cell” at the start of the procedure as the input of it, the fetched “next cell in the table form” is to be recognized as the “next cell” that is the output of the whole of the procedure.

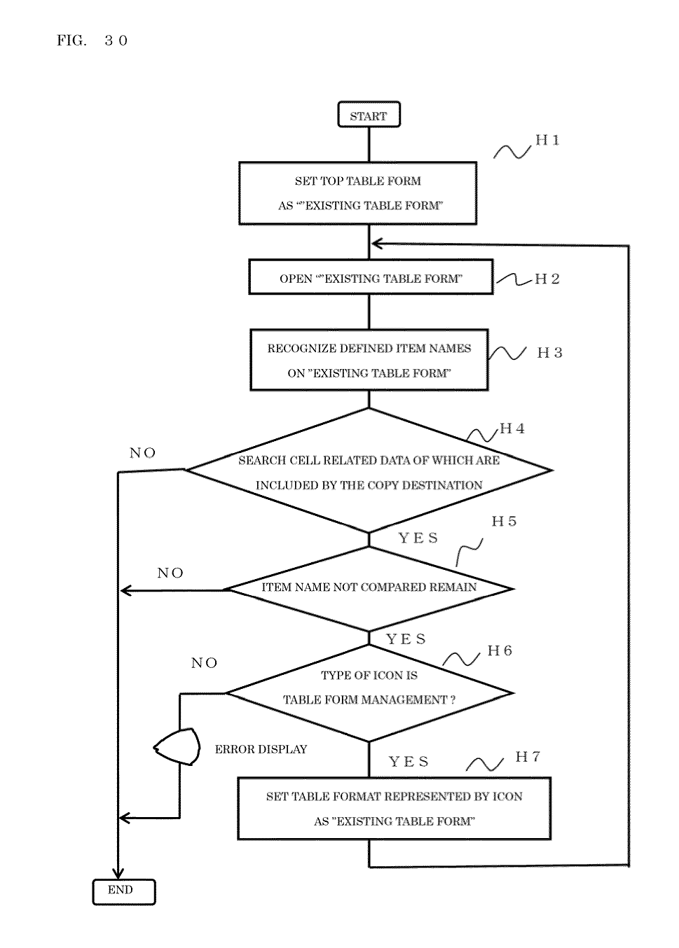

For instance in the FIG. 29 which illustrates a frame format of a hierarchical file managing table form, when the cell A on the file managing table form a is assumed to be the “existing cell” that is the input of the procedure, the “next cell” that is the output of the procedure is to be the cell B, the “next cell in the table form”.

In the case the “existing managing table form” is not of the “lowest” layer in the judgment of Step N3, Step N4 is executed, and the cell recognized therein is set as the “next cell”, “0” being set on the “end flag” (Step N5), and then the whole procedure is terminated. Step N4 is explained herein below.

In the case the “next cell in the table form” cannot be searched on the same table form, that is, the “existing managing table form”, the input of the procedure is the “end cell”, the cell fetched out last from the icon disposing field of the same managing table form (the bottom right cell in the icon disposing field, according the determined example) in the judgment of Step N2, it is judged if a “disposing destination managing table form” for the “existing managing table form”, that is, a file managing table form on which the icon of the “existing managing table form” is pasted exists (Step N6), and then if a “disposing destination managing table form” for a “existing managing table form” exists, the “disposing destination managing table form” is opened (Step N7). A “disposing destination managing table form” for a “existing managing table form” can be recognized in the same method as in Step M3 as described above.

Next a “disposing destination cell” onto which the icon representing the “existing managing table form” is pasted is searched on the opened disposing destination managing table form (Step N8). The “disposing destination cell” onto which the icon representing the “existing managing table form” is recognized in the same method as in Step M5 as described above.

Next, at this point the corresponding file pointer of the “disposing destination managing table form” newly opened and the cell data address of the “disposing destination cell” recognized newly thereon are set respectively on the “existing managing table form pointer” and the “existing cell data pointer”.

Next, the process returning to Step N2, a “next cell in the table form” for the new “existing cell” is recognized in the same method as described above on the new “existing managing table form”, and then if a “next cell in the table form” can be recognized, Step N3 and the following steps thereof are executed.

Next if in the judgment of Step N3 the “existing managing table form” is judged not to be of the “lowest layer”, the “beginning cell of the managing table form tree” is recognized, the top managing table form of the tree is the managing table form, the icon of which is pasted into the “next cell in the table form” now recognized, and then the “beginning cell of the managing table form tree” is set as the “next cell”, the output of the procedure (Step N4), and “0” is set on the “end flag” (Step N5), terminating the total procedure.

The “beginning cell of the managing table form tree” developed from the “next cell in the table form” can be recognized in the same method as in the procedure illustrated in FIG. 25. Furthermore, at this stage the “next cell” is set as the “existing cell”, while the file managing table form on which the “next cell” exists is set as the “existing managing table form”, that is, the “existing managing table form pointer” and the “existing cell data pointer” are renewed respectively by the corresponding pointer data.

In the case the “existing managing table form” is fetched out on ahead as a “disposing destination managing table form” for the “existing managing table form” which is the initial input of the procedure as described now, the “existing managing table form” is judged not to be of the “lowest layer” in Step N3, Step N4 is executed.

For instance in FIG. 29 above illustrated, in case the “existing cell” on the “existing managing table form” a, the input of the procedure is set on the cell at the bottom right corner of the icon disposing field, the “next cell in the table form” cannot be recognized, and therefore the “disposing destination cell” D of the “existing managing table form” a being recognized on the “disposing destination managing table form” b, the cell E which is the “next cell in the table form” for the cell D is recognized. Then the “beginning cell” of the managing table form tree is recognized, wherein the “existing managing table form” the icon of which is pasted into the cell E is of the top layer of the managing table form tree. In the case described now the cell F located at the top left corner in the icon disposing field of the managing table form c is recognized as the “next cell”, that is, as the “beginning cell in the managing table form tree” the top layer of which is the managing table form c the icon of which is pasted into the cell E.

In Step N7 the “disposing destination managing table form” is opened and if in Step N2 subsequent thereto, the “next cell in the table form” cannot be recognized for the “disposing destination cell” into which the icon of the former “managing table form” is pasted on the opened “disposing destination managing table form”, that is, if said “disposing destination cell” is the “end” cell in said “disposing destination managing table form”, the process returns to Step N6 again.

If a “disposing destination managing table form” is obtained for the “existing managing table form” in Step N6, the next “disposing destination managing table form” is opened, and thereafter the same sequence is repeated. The sequence consisting of Step N2, Step N6, Step N7, and Step N8 is repeated on the condition that the “next cell in the table form” is not obtained in Step N2 and further a “disposing destination managing table form” is obtained for the “existing managing table form”.

In the condition a “disposing destination managing table form” is not obtained for the “existing managing table form” in the judgment of Step N6 in the repeating of the sequence starting from Step N2 as above, that is, in the condition the “existing managing table form” is the “top” file managing table form, the “existing cell” that is the input of the total procedure is the “end cell” of the whole hierarchical managing table form, and therefore the “next cell” that is the output of the total procedure, cannot be recognized in the whole hierarchical composite managing table form. So in the case “1” is set on the “end flag” (Step N9), and the total procedure is terminated.

In the parent procedure to which Step N6 belong illustrated in FIG. 24, if the “end flag” that is the output of Step J6 is “1”, the total procedure is terminated, if “end flag” is “0”, the process returns to Step J2.

At the stage Step J6 is terminated, the “next cell” of the total procedure, that is the output of said step, is set, indicated by “existing cell data pointer”, while the file managing table form on which the “next cell” exists, is opened as the “existing managing table form” on the internal memory 16, indicated by the “existing managing table form pointer”.

In Step J2 the cell data address of the “next cell” recognized as described above, is set on the corresponding field in the “copy source cell data address entry field” on the sixth row of the work table, while the file data pointer to the file managing table form on which the “next cell” exists, is set on the “copy candidate managing table form file pointer”, and then after Step J3 the same process is executed.

In the above description the case wherein one icon is pasted into one cell within the icon disposing field of a copy source composite managing table form, is explained. The case wherein plural icons are pasted into one cell within the icon disposing field of a copy source composite managing table form, is also explained in a similar way. In this case as described above, the address of the beginning data of the “icon pointer data chain” made for the plural icons pasted into a cell in the icon disposing field of the copy source managing table form, is set on the “character string data address storage” in the cell data of said cell.

In the case a plurality of icons are pasted into a cell, Step J6 is executed as follows only in the case the corresponding managing table form is not of the lowest layer. That is, Step N2 which searches the “next cell in the table form” in Step J6, finds typically an icon indicated by the next icon pointer data in the icon pointer data chain related to said cell and then executes Step N3 and the following steps for the file managing table form corresponding to the icon recognized. In order to judge that said cell is of lowest layer, a specified flag is used, on which “0” is set in Step N1 and “1” is set after Step N6.

If the current icon pointer data is the end of the icon pointer data chain in the sequence above described, the “next cell in the table form” is recognized for said cell in the method as described above, and then an icon indicated by the beginning data in the icon pointer data chain related to the recognized “next cell in the table form”, is found, and subsequently for the managing table form related to the recognized icon Step N3 and the following steps are executed in the same method. If the “next cell in the table form” cannot be recognized, Step N6 and the following steps are executed in the same method.

When the corresponding cell is selected on the file managing table form of the copy source for a cell on the copy destination file managing table form in Step G4, subsequently the icons pasted into the selected cell on the copy source managing table form are copied to the corresponding cell on the copy destination file managing table form (Step G5).

As described above, the icon pointer data of the icon pasted into the cell selected on the copy source table form is set in the “copy destination data entry field” on the fifth row of the work table at the stage when Step G4 is terminated. First, the corresponding icon definition information is fetched out based on said icon pointer data, the environment program being requested to do so, and then a new icon definition information is generated in the internal memory 16 on the basis of said fetched icon definition information as follows.

That is, a new icon definition information is generated wherein the icon definition information recognized on the internal memory 16 is copied, and then on the “disposing destination pointer information” therein, the pointer information of the corresponding file data of the copy destination file managing table form is set, while the position n the desktop screen of the copy destination cell is set “icon positional information” therein.

The position of corresponding copy destination cell on the desktop screen can be recognized, adding the both of the relative position of the corresponding table form management application screen 33 in the desktop screen, and the relative position of the document wherein the corresponding icon is pasted in the corresponding table form management application screen 33, to the position of said copy destination cell in said copy destination table form. The position of the copy destination cell in the copy destination table form is read from the positional information registered in the cell data address, set now in the corresponding field for an icon in the “copy dest cell data address entry field” on the fourth row of the work table.

Furthermore “icon pointer data ” indicating the address of the icon definition information generated newly as described above, is generated, and then the address of said icon pointer data is set in the “character string data address storage portion “, or the icon pointer data address storage portion in the cell data of the cell within the icon disposing field of the copy destination.

Now, when an user as an operation starting the procedure, specifies the “input button “151, and drags the icon of the parent file managing table format from which icons are fetched out into the “input tray “160 which is displayed following the user's above operation and then specifies the “move execute “button 166 provided in the “input tray “160, the system recognizes the cell data of the cell from which icons are fetched out, the address of which is set on the corresponding field for an icon in the “copy source cell data address entry field” on the sixth row of the work table, and deletes both the icon pointer data pointed by them and the icon definition information pointed by said icon pointer data.

If the number of icons copied into the corresponding cell in the copy destination table form is plural, each icon definition information is fetched out one by one which is indicated by each data constituting the icon pointer data chain, the beginning data of which is set in the corresponding field for an icon on the corresponding field in the “copy destination data entry field” on the fifth row of the work table, and then a new icon definition information is generated by copying said fetched out icon definition information in the method described above, and subsequently an icon pointer data chain connecting each icon pointer data which indicates said generated icon definition information is generated, the address of the beginning data of said icon pointer data chain being set on the “character string data address storage portion”, or on the “icon pointer data storage portion” in the cell data of the cell within the icon disposing field of the copy destination.

After icons on the copy source table form are copied into one cell fetched out from the copy destination as described above, data set in each field in the “copy dest cell data address entry field” on the fourth row of the work table and in the “copy destination data entry field” on the fifth row of the work table are deleted, and then the “next cell” is searched in the icon disposing field of the copy destination table form (Step G6).

That is, for example, according to the method determined as described above, it is judged if the cell neighboring rightward to said cell in the table form exists within the icon disposing field. If the judgment is obtained, the cell neighboring rightward is set as the “next cell”. Otherwise it is judged if the next row below the row on which said cell is located exists in the icon disposing field. If the judgment is obtained, the cell on the extreme left on the next row within the icon disposing field is set as the “next cell”. Otherwise, it is determined that the “next cell” cannot be recognized within the icon disposing field, and the procedure illustrated in the FIG. 22 is terminated. When the “next cell” is searched as described above, the process control returns to step G2, and the same sequence is repeated till it reaches Step G6.

When a plurality of icons representing managing target files selected from the copy source are copied into one cell on the copy destination table form in Step G5, the size of said cells are varied automatically. In addition, in the case a plurality of icons of managing target files are copied into one cell on the copy destination, the plurality of icons copied into one cell being included in a folder, the icon representing said folder can be pasted in the corresponding cell.

In a case wherein in the “character string data address storage portion” in a cell data of a cell in which the address of said icon pointer data is to be set, the address of another icon pointer data is already set, or in a case data to be set therein is an icon pointer data chain consisting of a plurality of icon pointer data as described above, the procedure generating said folder newly is started. That is the information body of the folder generated is provided with the icon pointer data chain itself, the beginning data of which is set in the “character string data address storage portion” in the cell data of said cell. Owing to the procedure, each cell within the icon disposing field with a fixed definite size is provided. In the above description, the example is explained wherein the managing target of a composite file managing table form is a file, which the environment control program handles as a unit of application data. The folder, which is the measure of grouping files described above by the environment program can be the managing target of a composite file managing table form.

With a hierarchical composite managing table form being a copy or move destination, icons pasted on another file managing table format can also be disposed therein collectively in the same method as the method wherein icons on a hierarchical composite file managing table form as the copy source are copied or moved as described above.

In the specification managing target icons are disposed on a file managing table format of the lowest layer constituting a composite file managing table form, the procedure is repeated, wherein according to the sequence illustrated in FIG. 22, for each cell constituting the icon disposing fields fetched out one by one from each file managing table forms of the lowest layer constituting the composite file managing table form of the copy destination, the total related data is recognized from the total composite file managing table form, and then file icons are identified from the copy source file managing table format, the total related data for which is included by the total related data for the corresponding destination cell recognized as described above, subsequently being copied into said cell of the copy destination.

Each partial procedure constituting the procedure illustrated in FIG. 22, is executed as follows, in the case the copy destination is a composite file managing table form. First item names defined in connection with data fields on the whole composite file managing table form of the copy destination, are recognized, then being registered in the worktable described above along with the “key type” and the “disposing type” in Step G1. That is, each file managing table form constituting the whole of the composite file managing table form of the copy destination is fetched out one by one, which is started at the top file managing table form, and then item names defined thereon and their corresponding “key type” and “disposing type” are recognized. The method of recognizing sequentially each element constituting a tree structure such as a composite file managing table form, is generally known.

The setting of the starting point in fetching each cell within the icon disposing field from file managing table form of the copy destination, which is to be next executed in Step G1, is executed according to Step J1 in the procedure illustrated in FIG. 24 described above in the case the copy destination is a composite file managing table form. Further Step G3 is executed according to the sequence of Step J3 in the procedure illustrated in FIG. 24 described above, in the case the copy destination is a composite file managing table form.

Further in the specification wherein each file managing table form on which managing target icons are to be pasted, is of the same layer in the composite file managing table form of the copy destination, Step G6 is executed according to the sequence of Step J6 in the procedure illustrated in FIG. 24 described above. Thus in the embodiment apparatus, file icons pasted on a hierarchical composite file managing table form can be copied collectively onto another hierarchical composite file managing table form.

In the specification each file managing table form on which managing target icons are pasted, is not of the same layer in the composite file managing table form, the following method is executed. That is, each file managing table form constituting the composite file managing table form. Of the copy destination is fetched out one by one by known methods, which is started at the top file managing table form, and then the set of the item names of the total related data is recognized thereon.

The set of the item names constituting the total related data on a file managing table form constituting a composite file managing table form, can be obtained as a sum of a set of item names constituting the related data defined on each of the file managing table forms, wherein each of said file managing table forms is sequentially provided by following the “file managing table form of the disposing destination” on which an icon of each file managing table form is pasted, beginning from the file managing table form itself fetched out currently to the top file managing table form. The method following the “disposing managing table form” sequentially to the top file managing table form, is described above.

Therein a set of file managing table forms is recognized among each file managing table form constituting the composite file managing table form of the copy destination, wherein the set of item names recognized on said set of file managing table forms is included by the set of item names constituting the related data recognized for the copy target icon, and further is the largest set among the sets included as above.

Next among file managing table forms constituting the composite file managing table form of the copy destination, a file managing table form satisfying the condition as described above is fetched out one by one, and for each cell within the icon disposing field of the fetched file managing table form, the total related data is sequentially recognized from the whole composite file managing table form, and then the cell, the recognized total related data for which includes the related data of the copy targets, is found as the copy destination cell. That is, the cell is found, wherein each data of key item constituting the total related data for said cell on the copy destination, includes the corresponding data of the related data of the copy target.

If the copy destination cell can be found as described above, the address of the icon pointer data indicating the icon definition information of the copy target icon, is set on the “character string data address storage portion” in the cell data of the corresponding copy destination cell. If the copy destination cell cannot be found using the above method, for each icon of managing target file which is pasted on the corresponding copy souse file managing table form, the corresponding “copy destination cell” is searched according to the above method, the found icon being copied into the cell.

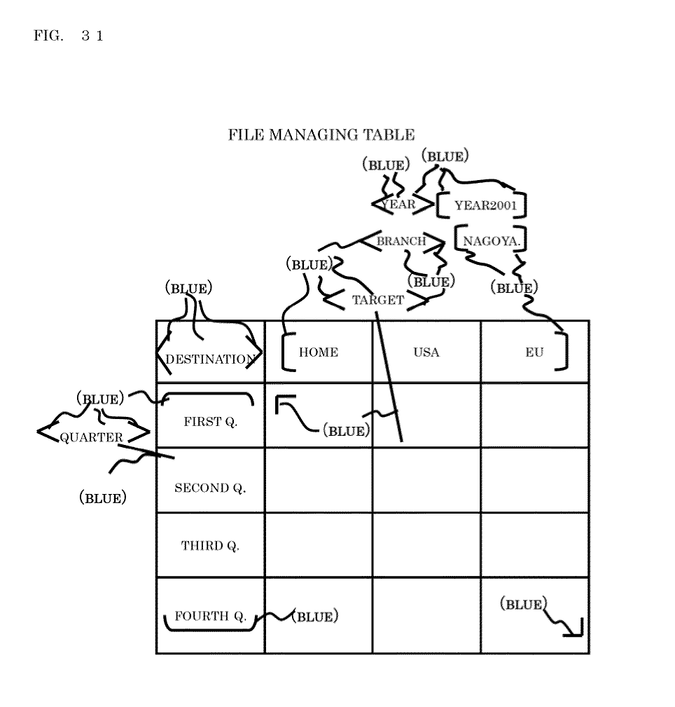

Step G4 can be executed according to the sequence illustrated in FIG. 30. But if Step G4 is executed according the sequence, in Step G1 data “0” indicating “not check” are set as initial data in all fields constituting the “field for check record” located in the eighth row of the worktable.

In the sequence illustrated in FIG. 30, first as the initial setting process, the top file managing table form of the copy source hierarchical composite file managing table form being set as the “existing managing table form”, its file body data is set on the “existing managing table form pointer” provided in the internal memory to indicate the “existing managing table form” (Step H1). That is, the pointer information to the file body data of the file managing table form dragged into the input tray 160 is set therein.

Next based on the “existing managing table form pointer” described above the file body data of said file managing table form is fetched into the copy source file data storing area in the internal memory 16 (Step H2).

Next on the copy source table form fetched out as described above, item names, each of which is defined forming a couple with each data or each data field thereon, are recognized, and then data “1” are set as the “check flag” on the fields corresponding to the recognized item names in the “check record entry field” located in the eighth row of the work table (Step H3). That is, the item definition data made on the copy source table form fetched out currently is fetched out one by one, and then the “item name” information therein is referred.

In the case of the example described now, the flag data are set in the fields corresponding to the item names, “BRANCH” and “YEAR”, which are defined on the “disposing destination” file managing table form, that is, the file managing table form of the copy source fetched out currently.

Subsequently, among cells within the icon disposing field on the copy source table form fetched out currently, cells are recognized, the related data of which are in the relation as described below with the related data of the cell in the icon disposing field fetched out currently on the copy destination table form (Step H4).

That is, cells within the icon disposing field of the copy source are recognized, each related data of which are “included” by the corresponding data of the copy destination, regarding each item name which is defined on the file managing table form of the copy source fetched out currently, and further is defined as a “key item” on the file managing table form of the copy destination. The “inclusion” relationship between data described now includes the relation of “sameness” of data.

Regarding the cell in the icon disposing field located on in the third row from the top and in the third column from the left on the copy destination table form described above, among cells in the icon disposing fields on the destination file managing table form (F5) fetched of the copy source currently, cells are retrieved, wherein its related data associated with an item name, “branch” or “year” defined on the destination file managing table form of the copy source is “included (including “same”) “respectively by data “NAGOYA” or data “YEAR2002”.

Step H4 can be described, for example using the procedure similar to the procedure illustrated in FIG. 24 as described above. First, the fetching location of a cell in the icon disposing field of the file managing table form of the copy source fetched out currently, is set at the starting location (Step J1), and then cells in the icon disposing field are fetched one by one sequentially (Step J2), and the related data of each cell fetched is recognized (Step J3).

The starting location of fetching cells in the icon disposing field can be set on the cell at the left top corner of the icon disposing field as in the case of the file managing table form of the copy destination as described above. The order of fetching cells in the icon disposing field can be the same as in the above case of the file managing table form. Recognition of the related data can be executed in the same manner as in the case of the file managing table form of the copy destination as described above.

The cell data address of an cell in the icon disposing field and the cells storing the related data of said cell in the icon disposing field fetched from the file managing table form of the copy source are set respectively on the corresponding field in the “copy source cell data address entry field” on the sixth row of the work table, while data in the cell in the icon disposing field and the related data are set respectively on the corresponding field in the “copy source data entry field” on the seventh row of the work table. As the data in the cell in the icon disposing field, the icon pointer data itself is set, the address of which is set in the “character string data address storage portion” in said cell data.

Subsequently two set of related data are compared on the worktable as described above, each set being obtained respectively for a cell in the icon disposing field fetched from the file managing table form of the copy source, and for another cell within the icon disposing field fetched from file managing table form of the copy destination. (Step J4)

The comparison between the set of related data is executed only regarding key items defined on the file managing table form of the copy source fetched currently. It can be performed by comparison between two data located in the same column, one located in the fifth row and the other located in the seventh row on the worktable. In the case described now, the comparison between the set of related data is performed only regarding item name “BRANCH” and “YEAR”.

If in the judgment of Step J4, the relation of “inclusion described above” between data is recognized for each item names used for the comparison, icon pointer data set on the corresponding field for an icon in the “copy source data entry field” on the seventh row of the work table, are copied into on the corresponding field for an icon in the “copy destination data entry field” on the fifth row of the work table (Step J5), and then the next cell in the icon disposing field is searched (Step J6).

If in the above comparison between related data the relation of “inclusion” between data described above, is not necessarily recognized for each item names used, Step J6 is directly executed. If the next cell in the icon disposing field can be searched out in the step, the process control returning to Step J2, which fetches the cell data of said searched cell, Step J3 and its following steps are repeated. If the nest cell in the icon disposing field cannot be searched in Step J6, all cells are fetched out in the icon disposing field, the whole procedure of Step H4 being terminated.

If a cell satisfying the above condition cannot be recognized in Step H4, the corresponding cell in the icon disposing field on the copy destination is provided with the error message display indicating “unable to bi copied”, then the whole procedure of Step G4 being terminated. To display the said error message indicating “unable to be copied”, the corresponding cell is provided with a specified surface modification information including a specified color.

Regarding an icon that is pasted in a cell recognized as described above on the disposing destination file managing table form of the copy source fetched out currently at the stage when Step H4 is terminated, its icon pointer data is set on the corresponding field in the “copy destination data entry field” on the fifth row of the work table.

Next the procedure illustrated in FIG. 30 is explained again. Therein after Step H4 is terminated, it is judged that regarding some key item names which are registered the “item name entry fields” on the first row of the work table, that is, are defined on the file managing table form of the copy destination, corresponding data read from the file managing table form of the copy destination are not compared with corresponding data of the file managing table form of the copy source (Step H5).

To do this, it is judged that among the entry fields for “check record” in the eighth row of the wk, some fields have the initial setting “0” set therein. In the case the flag data “1” are set in all the entry fields for “check record” in the eighth row of the wk, that is, in the case regarding all the key item names defined on the file managing table form of the copy destination, corresponding data thereof are compared with corresponding data of the copy source, the corresponding cell on the file managing table form of the copy source is retrieved for the cell fetched currently on the file managing table form of the copy destination, then Step G4 being terminated. Also in the case the icon type of the icon despised in the cell retrieved is table form management application, said icon is copied in the same method as described above in Step G5 following.

In the case among the entry fields for “check record” on the eighth row of wk, some fields have the initial setting “0” set therein in the judgment of Step H5, that is, in the case some item names data of which is not yet compared with data of the copy source, the application type of the icon recognized is judged (Step H6). The application type of said icon can be judged based on the “application type information” registered in the corresponding icon definition information, said icon definition information being fetched based on the “icon pointer data” that is set on the corresponding field in the “copy destination data entry field” on the fifth row of the work table.

If the type of said icon is judged to be table form management application, the access information for the file body corresponding to said icon, is obtained (Step H7, then the process control returns again to Step H2 of opening the file corresponding to said icon, and thereafter the sequence to Step H6 described above is repeated on the newly opened table form.

In step H7 above described, the icon definition information is fetched base on the “icon pointer data” that is set on the corresponding field in the “copy destination data entry field” on the fifth row of the work table, and then the “file body pointer info” therein is set on the “existing managing table form pointer”.

In the case the icon type is not judged to be the table form management application in Step H6, the corresponding cell in the icon disposing field of the copy destination is provided with the error message display indicating “unable to be copied”, then Step G4 being terminated.

In the example of the cell in the icon disposing field located on the third row from the top and on the third column from the left on the copy destination table form described above, in Step H4, an cell in the icon disposing field located on the third row from the top and on the second column from the left on the icon disposing file managing table form (F5) of the copy source fetched now, is recognized as the cell sharing with said cell in the icon disposing field of the copy destination, the related data of “NAGOYA” and “YEAR2001” respectively regarding the item of “BRANCH” and “YEAR” defined thereon.

As the item names, “DESTINATION” and “QUARTER” are left set as “not compared” in the judgment of Step H5, the process proceeds to Step H6. As the icon type is judged to be the “table form management application” in Step H6, after setting of the corresponding file info by Step H7, the process returns to Step H2 opening the file corresponding said icon, then the corresponding disposing source file managing table form (F6) being fetched out.

Subsequently Step H3 and Step H4 are executed in the same method also on the file managing table form (F6) of the icon disposing source fetched out, and consequently the cell in the icon disposing field located on the second row from the top and on the third column from the left is recognized as the cell sharing “USA” and “FIRST Q.” respectively as the related data of the item “DESTINATION” and the item “QUARTER”, with said cell of the copy destination (the cell in the icon disposing field located on the third row from the top and on the third column from the left).

In Step H5 following the above, it is judged that regarding all the key item names defined on the file managing table form of the copy destination, data of the copy destination are compared with data of the copy source, then the whole of the procedure is terminated.

In the above description, the case regarding the proceeding of Step H4 one icon is selected from the copy source composite managing table form is explained. But a plurality of icons can be selected in Step H4. As described above one icon pointer data is generated for each icon selected, and therefore if a plurality of icons are selected in one execution of Step H4, an icon pointer data chain is generated wherein the corresponding icon pointer data are connected each other by the forward pointer and the backward pointer, then the beginning icon pointer data of the chain is set on the corresponding field in the “copy destination data entry field” on the fifth row of the work table described above.

In step H7, a “file pointer chain” is generated in the same method, wherein “file pointers” are connected each other, each “file pointer” being generated as information for accessing to the corresponding file, regarding each icon pointer data constituting the icon pointer data chain. In Step H2, each “file pointer” is fetched one by one from the “file pointer chain”, then the corresponding file being opened sequentially. The “file pointer” is set in the icon definition information indicated by the corresponding icon pointer data.

In Step H4, when a plurality of icons are further selected, then an icon pointer data chain being generated on each file managing table form of the icon disposing source represented by each opened file data, icon pointer data chains are connected each other each icon pointer data chain being generated for each file managing table form of the icon disposing source, by the “forward pointer” and the “backward pointer”, the beginning data of the whole icon pointer data chain is set on the corresponding field in the “copy destination data entry field” on the fifth row of the work table.

The above proceeding being repeated, an icon pointer data chain connecting icon pointer data for all icons representing selected managing target files at the end of Step G4, its beginning data is set on the corresponding field in the “copy destination data entry field” on the fifth row of the work table.

Using the above sequence illustrated in FIG. 30, desired icons can be fetched out by a retrieval condition input specially by a user from a composite file managing table form. For example, if he specifies the “retrieval button” 183 always displayed on the table form management application screen 33 displaying the file managing table form that is a retrieval target, the system displays the retrieval condition input screen 185.

The retrieval condition input field 186 is provided corresponding to each of the entered item name 187 on the retrieval condition screen 185, into which a user can input data corresponding to its item name. A plurality of data can be input within the input field 186 for an item names, and as a default rule, regarding the plurality of data input within the input field 186 for an item name, the sum of the data are recognized as the retrieval condition for the corresponding item name, and further the product of the data input in the fields associated different item names is recognized as the total retrieval condition.

Each item names constituting the sum set of item names defined on all file managing table forms constituting said composite file managing table form preliminarily by the system, is entered as a item name 187 displayed on the retrieval condition input screen 185 by the system. The method wherein each element constituting a tree-type structure such as the composite file managing table form is recognized sequentially is generally known.

When the user specifies the “execute” button 89 on the retrieval condition input screen 185 after inputting of a retrieval condition data thereon, the system sets the input data for each item name on the corresponding field in the “copy destination data entry field” on the fifth row of the work, and then selects appropriate icons from the copy source composite file managing table form according to the seq of Step G4 described above.

The selected icons are fetched out in the way, wherein their icon pointer data are set respectively on the corresponding field in the “copy destination data entry field” on the fifth row of the work table. If the number of the selected icons is plural, the icon pointer data chain described above is set therein. Subsequently the system displays the appropriate retrieval result output subscreen on the display screen 20a, and then display the selected icons therein.

Copying or moving of icons of external objects (managing target files, folders, or the file managing table form) onto a hierarchical composite file managing table form, can be executed by the method wherein the copy destination location is searched, which is started from the top table form of the hierarchical file managing table form, based on the sequence shown in FIG. 30.

First it is the premise that external objects of the copy target are provided with a set of data related to a corresponding item names as the attribute of the said objects which is interpreted as the product of the constituent data. For instance said data can be related data recognized on a specially provided file managing table form, into which the corresponding object is disposed as described below. Or it can be data extracted from an file managing table form as the attribute of the object of the file managing table form itself as described later.

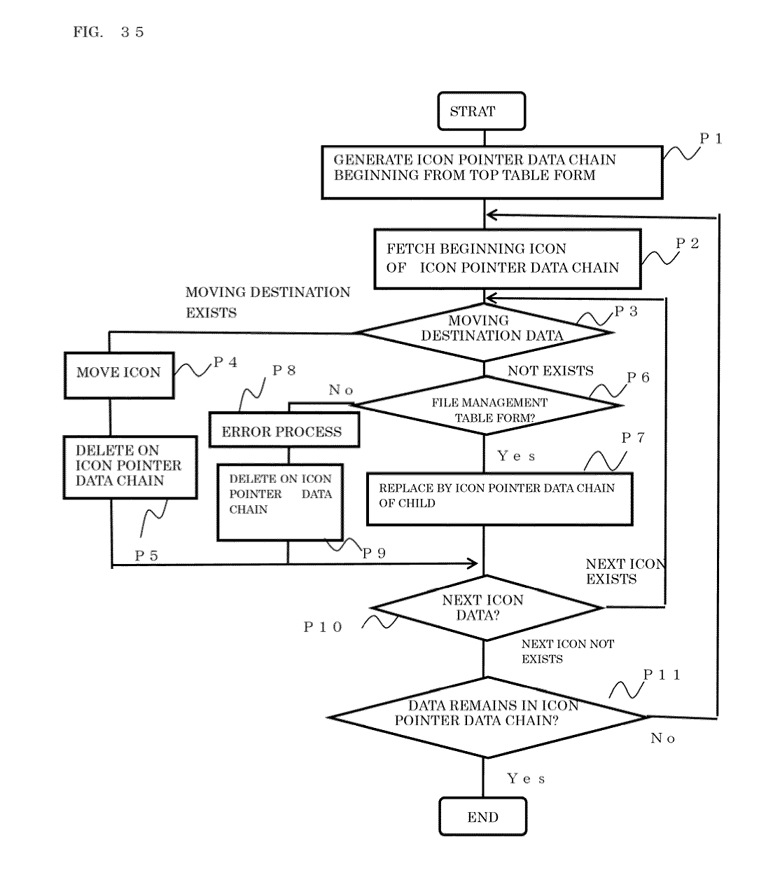

In the description below, the method therefore is explained using FIG. 34. First the top constituent file managing table form is fetched from a file managing table form of the copy destination (Step S1), and then it is judged that an item name exists which is defined as a key item name on said top file managing table form and at the same time is not included by a set of item names of related data provided to the copy source icon. (Step S2)

If the judgment of Step S2 is not obtained, related data is recognized for each icon pasting cell on a table form fetched currently from the copy destination (hereafter being called the “existing table form.” of the copy destination), and then an icon pasting cell is selected wherein each data constituting the related data of said cell is respectively the same as the data, or includes the data of the same item name provided to said copy source icon (Step S3). The comparison of data between a copy destination cell and a copy source cell is executed only for item names defined as key item as in the case described above.

Next it is judged that an icon representing a file managing table form is pasted in the icon pasting cell selected as above on the copy destination table form (Step S4), and then if an icon representing a file managing table form is not pasted in said selected cell, the copy source icon is pasted in said cell (Step S9), then the total procedure being terminated.

If an icon representing a file managing table form is pasted in the selected icon pasting cell in the judgment of Step S4, the new file managing table form represented by said icon is fetched as the next “existing table form” (Step S5), and the set of key item names defined on the “existing table form” is recognized (“Step S6).

Subsequently the process returning to Step S2, if the set of key item names defined on the “existing table form” is included by the set of constituent item names of the attributed data provided to the copy source icon, thereafter step S3 and the steps following it is repeated for the “existing table form”.

In the case an item names exists which belongs to the set of key item names recognized as above on the copy destination, and at the same time does not belong to the set of item names of the copy source icon, in the judgment of Step S2, it is judged that the rank of the layer of the “existing table form” is not the top (Step S7). If the rank is not the top, the file managing table form fetched in Step S3 previously executed (that is the “parent” of the “existing table form) and said cell selected thereon is fetched (Step S8), and then the copy source file icon is disposed into said fetched cell (Step S9), then the total sequence being terminated.

If the “existing table form” is of the top layer in the judgment of Step S7, it is considered that the copy source icon cannot be copied or moved on the file managing table form of the copy destination, and then the notification of it is returned to the system (Step S10), then the total sequence being terminated.

In Step S9, the corresponding icon definition information and the icon pointer data pointing it are generated as described above, said generated icon pointer data is pointed by the cell data of the move destination cell, while the handling info such as the pointer of a file info corresponding to the object represented by said copy source icon (a file managing table form or a managing target file), is set in said generated icon definition information.

An icon disposed on a specially provided file managing table form can be treated as an external icon provided with attributes as described above. For example an icon arbitrarily selected on a specially provided file managing table form or hierarchical file managing table form by a user, can be copied into a appropriate cell on another hierarchical file managing table form of the copy destination.

That is, when he designates an icon for example by clicking with mouse 14 on a file managing table form displayed in the table form management application screen 33 on the display screen 20a, and then clicks the “auto dispose” button 190, the system displays the “disposing tray” 191 shown in FIG. 21.

When the user drags into the “disposing tray” 191 an icon representing another copy hierarchical file managing table form of the copy destination, and subsequently specifies the “execute” button 193 provided in the “disposing tray” 191, the system recognizes the related data or the total related data as described above for the icon designated as the copy target on the file managing table form of the copy source, and executes the sequence shown in FIG. 34 as above, so as to recognize the appropriate disposing destination cell on the file managing table form of the copy destination and dispose said icon therein. If an icon disposed on a hierarchical file managing table form is selected as the copy target, the total related data for said icon can be recognized as described above.

After the system recognizes as above the disposing destination cell designated by the user, the system, displaying the file managing table form of the disposing destination, which contains said cell in the table form management application screen 33, can provide said cell with a special display indicating that said cell is a disposing destination recognized by the function. If the copy destination is a hierarchical file managing table form, the file managing table form of the disposing destination is the file managing table form fetched in the last execution of Step S8 in the sequence of FIG. 34.

In addition, a user can copy or dispose all icons of the file type other than the type of the file managing table form (managing target icons), which are disposed on a file managing table form or a hierarchical file managing table form, into a appropriate cell on another provided hierarchical file managing table form.

If the copy source is not a hierarchical file managing table form, the related data for each constituent cell sequentially fetched from the corresponding icon disposing field is recognized, and then said related data, regarded as the attribute data for the copy source recited in the sequence shown in FIG. 34, are compared with the total related data for each cell on the file managing table form of the copy destination, then the appropriate disposing destination cell being recognized.

Therein, if the copy source is a hierarchical file managing table form, after from the copy source each constituent element thereof (a file managing table form or a managing target object) is fetched sequentially, and among the fetched icons the file type of which are not the type of the file managing table form, are selected, the total related data are recognized for each of said selected icon with the method as described above, and then the appropriate cell of disposing destination on the file managing table form of the copy destination can be recognized with the method shown in FIG. 34. In general the methods of fetching the constituent elements from a tree structure sequentially, are publicly known in various examples.

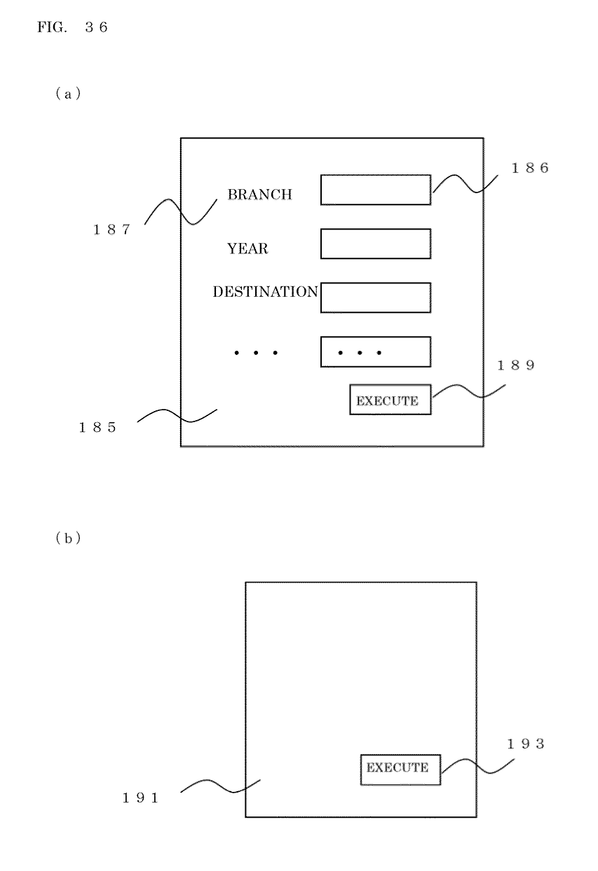

The proceeding of outputting a file managing table form constituting a copy source composite file managing table form from said composite file managing table form, said output file managing table form being a copying unit, can be executed with the sequence as explained below. That is, each file managing table form constituting a copy source composite file managing table form is fetched out one by one without the duplication of fetching beginning from the top layer, and then the appropriate cell into which the corresponding icon representing said fetched file managing table form is disposed, within the file managing table form of the copy destination is found with the sequence shown in FIG. 34, then said icon being copied into said cell. The method of fetching a constituent file managing table form sequentially from the copy source, is known publicly as the method of fetching constituent elements sequentially from a tree structure in various examples. For example it can be executed with a sequence shown in FIG. 35 as below.

Regarding a file managing table form the pasting location of which cannot be recognized within the copy destination among file managing table form fetched from the copy source, each file managing table form which represents the “child” of said fetched file managing table form (each “child” file managing table form represented by each icon pasted in said file managing table form of the copy source) is fetched, and then for each “child” file managing table form described above the appropriate pasting location of its corresponding icon within the copy destination is recognized repeatedly.

In the sequence shown in FIG. 35, first on the top file managing table form of the copy source composite file managing table form, each icons pasted in the icon disposing field is fetched, and then each icon pointer data of said each icon is connected each other so as to from an icon pointer data chain described above (Step P1).

Next for each icon pointed by each constituent of the icon pointer data, the sequence from Step P2 to Step P11 described below, is repeated. In each executing of said sequence, first each icon is fetched based on the icon pointer data chain, which is started from the icon of the beginning icon pointer data (Step P2), and then the disposing cell of the copy destination is recognized for said fetched icon with the sequence shown in FIG. 34 (Step P3). If the disposing cell can be recognized, said copy source icon is copied into said recognized cell (Step P4), and then the corresponding icon pointer data is deleted from the icon pointer data chain (Step P5).

If the disposing cell cannot be recognized in Step P3, it is judged that said copy source icon represents a file managing table form (Step P6). If said icon represents a file managing table form in said judgment, each icon disposed on said managing table form, representing the “child” thereof, and each “child” icon is connected to each other so as to form an icon pointer data chain described above. Subsequently with the icon pointer data chain generated newly by connecting each child icon, an icon pointer data is replaced on the whole original icon pointer data chain generated above for said file managing table form, wherein the replaced icon pointer data has pointed the icon representing said file managing table form (Step P7).

If said copy source icon does not represent a file managing table form in the judgment of Step P6, the corresponding icon pointer data is connected to the “icon pointer data chain unable to be moved” grouping icons that are unable to be moved (Step P8), and is deleted from the icon pointer data chain on which said icon pointer data has been incorporated (Step P9). Said “icon pointer data chain unable to be moved” is displayed for users in a form of appropriate message, after all icons within the copy source are moved or copied.

After any step among Step P5, Step P7, and Step P9, described above is terminated for an icon fetched from said icon pointer data chain, another icon located at the next to said icon on said icon pointer data chain is recognized (Step P10), and then for the next icon the sequence following Step P3 described above is repeated.

In the case the next icon on the icon pointer data chain is not found in Step P10, that is, the above sequence is terminated for the end icon on the current icon pointer data chain, it is judged that regarding the current icon pointer data one icon pointer data or more than one icon pointer data constituting said icon pointer data exists or exist (Step P11). If said judgment is obtained, the beginning icon on the current icon pointer data chain is fetched (Step P2), the sequence following Step P3 is repeated. In the case the judgment of Step P11 is not obtained, that is, in the case the current icon pointer data chain is “empty”, the total procedure is terminated.

In the above the example is explained wherein related data are previously entered in the fields provided for them on a file managing table form of the copy destination. In the case related data are not previously entered in all fields provided for them, icons on other file managing table form can be copied therein as described below.

First regarding data fields for related data to be entered on the file managing table form of the copy destination, each continuous set of cells for data sharing the same item names to be entered, can be defined in the same method described above as the data field associated said item name.

In the case, now explained, wherein data referenced as related data are not necessarily entered on the file managing table form of the copy destination, the total procedure can be executed by the system as below. A managing target icon is fetched out sequentially from the file managing table form of the copy source, and then for each icon fetched the appropriate pasting cell is recognized on the copy destination. That is, for each managing target icon fetched from the copy source, related data for said icon are compared with those of the cells fetched out sequentially from the file managing table form of the copy destination according to a predetermined method.

The method of fetching a cell sequentially from the file managing table form of the copy destination is, for example as below. That is, searching rightward of a next cell is sequentially repeated in the same row starting from the beginning cell of the icon disposing field, and then if the next cell cannot be found in said row, in the next row searching rightward of a next cell is sequentially repeated starting from the cell on the extreme left in said row.

In the case the lower end or the right end of the file managing table form of the copy destination is in the form of the free end, that is, for each data field constituting said file managing table form, only a subset of cells beginning from the upper end or the left end within all cells constituting said data field, is generated, the sequential search of a next cell within a row described above, is stopped at the cell located to the immediate right of the group of cells into which icons from the copy source have already been moved or copied, the sequential search within the next row is started. And the fetching of the next row sequentially executed is also stopped at the location neighboring on the bottom of the group of cells into which icons from the copy source have already been moved or copied.

In the case the low end or the right end of the file managing table form of the copy destination is the free end described above, the sequential search of a next cell described above is executed always along with judging if a cell data is generated at the next searched position. Therein if a cell data is not generated at said position, a cell data is newly generated, and then is added to, or inserted at the corresponding position of the corresponding cell data chain.

Now the position of the newly generated cell is determined based on the previous cell in the sequential cell search described above, the direction of the current sequential search (if the existing cell is neighboring on the right or on the bottom of the previous cell), and the horizontal and vertical size of the generated cell. In the specification that the horizontal and vertical size of all constituent cells within a continuous icon disposing field are the same, the horizontal and vertical size of the generated cells can be determined accorded to said common size.

Also in the case the file managing table form of the copy source or the file managing table form of the copy destination is a composite file managing table form, managing target icons or cells on table form of the lowest layer can all be fetched from it sequentially according to the method described above, and then the related data of them are recognized.

The comparison of related data or total related data between a copy source icon and a copy destination cell, is executed only for key item names data of which are entered in the corresponding data field of the copy destination. Therein if the inclusion relation between data described above is judged for all item names referenced, said cell is determined as the copy destination cell.

Subsequently at the time said icon on the file managing table form of the copy source is copied into said cell on the file managing table form of the copy destination, if some related data are recognized on the file managing table form of the copy source and at the same time are not entered previously in the copy destination, said icon are copied in the corresponding position along with said related data. Said related data are entered in the cell included by the data field of the corresponding item name and located in the same row and in the same column as said copy destination cell of said icon is located in, on the file managing table form of the copy destination.

The copying of related data is also executed along with the judgment if the cell data of the cell in which to be copied is generated in the same method as described above. Therein if the cell data of the cell for the related data is not generated, the corresponding cell data is newly generated, then being added to, or inserted at the corresponding position of the corresponding cell data chain.

In the case the copy destination is composite file managing table form, the copy destination cell of said icon being the starting point, its disposing table form and disposing cells on said table form are sequentially tracked back according to the method described above, wherein in each tracked disposing table form each data of item names defined on said table form among the corresponding related data, is entered in the cell located in the relation described above with the corresponding disposing cell within the corresponding data field.

Once data entered on the copy source is copied into a field for related data on the copy destination as above, thereafter in recognizing related data for each cell fetched from the copy destination, data copied previously from the copy source is also referenced as related data. The above sequence is repeated for each icon of the copy source, wherein at the same time when said icon is copied, the corresponding data on the copy source are also copied in all of the cells for the related data on the copy destination.

After all of the managing target icons are copied onto the copy destination, in each data field for related data data entered therein are sorted according a predetermined order. Therein for each data sorted in the data field for related data, the other data (cells) on the same row or on the same column with said cell being at a right angle towards the corresponding data field are also sorted so as to remain in the same positional relation with said corresponding sorted related data. The phrase of being at a right angle towards a data field mentioned herein means a placement of being at a right angle towards the disposing direction of each data within said data field.

In the case the copy destination is a composite file managing table form, and all table forms belonging to the same layer are made in the form of the same format, as a default specification each related data must be sorted according to the same order on all table forms of the same layer. The phrase of the same format herein means the arrangement of table forms wherein each data field of the same item name is located in the same relative position among corresponding table forms. Table forms of the same layer can be fetched out from a composite file managing table form according to the method described below.

Also in cases other then for each file managing table form constituting the copy destination a composite file managing table form, all the constituent cells are provided and therein all the related data are entered previously. Copying or moving of external objects (a file managing table form or managing target objects) onto a composite file managing table form can be executed fundamentally according to the sequence shown FIG. 34, wherein each step of the sequence is executed modified as below.

Under the premise that the format of each file managing table form, that is, the constitution of item names defined on each file managing table form constituting the composite file managing table form of the copy destination now used for the explanation, is the same for each layer, first a user makes one file managing table form for each layer as the format info representing the format info of all file managing table form belonging to the corresponding layer, and then pastes the icon representing said file managing table form into an appropriate cell within the icon disposing field of the file managing table form of the disposing destination (for example the left top cell of the icon disposing field).

The system adds the rank number of each layer (for example the rank counted from the top layer) to the corresponding file managing table form info made for said layer as the key info thereof, said info being registered in the corresponding file info storing as described above the format info of the corresponding file managing table form (regarding data, character string data and ruled line data constituting a table form, and item definition data).

The rank number of each layer can be recognized as the repeating number of the sequence wherein on the existing representative format of a layer the icon of the “child” representative format is found, then the icon being opened as the next existing format, required to reach said layer starting from the top layer.

First in Step S2 the constitution of the item names defined on the corresponding file managing table form can be recognized by referencing the format info of the file managing table form registered related to the corresponding rank of layer. The corresponding rank of layer can be recognized by repeating the sequence wherein the rank number is increased by 1 in Step S5 fetching the file managing table form of the next layer below after in Step S1 fetching the top layer 0 is set as the rank number.

And in Step S3, as described in the above case wherein an icon pasting position is found on a copy destination table form where related data are not yet entered, an icon pasting cell is searched sequentially rightward in the same row the beginning cell of the icon disposing field being the starting point, and if it cannot be found in said row, it is searched rightward from the cell on the extreme left in the next row.

Therein, as in the above case related data provided to the copy source icon are at the same time entered in the corresponding cells, and in the case no cell is provided at the disposing position of said copy source icon and its related data, the corresponding cell data is newly generated, and then they are entered into said cell.

In addition in the case a cell is newly provided at the disposing position of the copy source icon, in Step S5, a file managing table form of the next layer below is newly generated and the icon representing said file managing table form is pasted into said newly provided cell. The format info of the newly generated file managing table form is obtained as that of the next layer below for the current layer, by fetching the format info which is generated related to the corresponding layer rank, based on the rank of the corresponding layer recognized by counting from the top layer, and copying it.

When an icon representing a file managing table form is pasted onto another composite file managing table form, the total related data which are recognized for the “icon disposing cell” from the whole of said composite file managing table form, can be registered as the “common condition of said pasting target file managing table form, in the corresponding icon pointer data or in the corresponding file data. In addition said “common condition” recognized therein can be written and displayed in the form of the couple of the item name and the data name at the appropriate position “outside of the matrix” of said file managing table form.

For example, when the icon representing the file managing table form shown in F6 is pasted into the cell located in the third row from the top and in the second column from the left on the file managing table form shown in F5, the system recognizes as the total related data obtained for said “icon disposing cell” from the whole of said composite file managing table form, the data name “YEAR2001” for the item name “YEAR”, and the data name “NAGOYA” for the item name “BRANCH”, and then said recognized data are stored as its “common condition” in the icon pointer data or the file body data corresponding to the pasting target icon.

The system further writes additionally and displays the couple of the item name and the data name recognized in the above, that is, the couple of the character string “YEAR” and the character string “YEAR2001”, and the character string “BRANCH” and the “NAGOYA”, at the appropriate position on the upper right side out of the matrix of the file managing table form shown in F6.

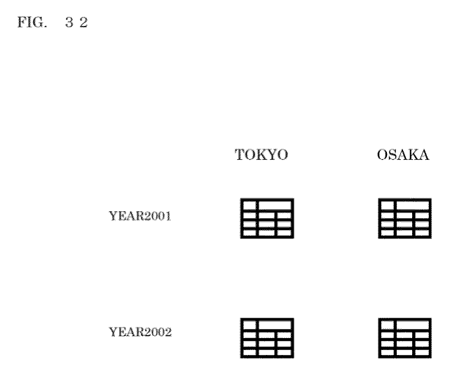

The item name character string “YEAR” and “BRANCH” is written respectively at the adjacent position leftward on the same row with the corresponding data name character string “YEAR2001” and NAGOYA”, and the symbol of “item name indicating” and “data name indicating” described above is added respectively to the item name character string and the data name character string written. Displaying the common condition as described above on the file managing table form shown in F6 is shown in FIG. 31.

When an icon is dragged onto the table form management application screen, the environment control program finds said dragging dest table form management application screen, and then notifies the corresponding table form management application program of said dragging, then the corresponding table form management application executing the following proceeding based on the notification.

First for the dragged icon, the sequence of Step J3 shown in FIG. 27 described above is executed, and then the total related data for said icon is recognized from the whole of the composite file managing table form of the dragging destination. For example the “item name” and the “key type” of the recognized related data is entered respectively in the “item name entry fields” on the first row and in a key category entry field on the second row of the work table. The character string of the “data name” is entered in the “copy destination data entry field” on the fifth row of the work table.

Next couples of an item name and a data name constituting each related data recognized as above are connected each other with pointers, then the beginning data being pointed, for example by the “related data pointer” within the corresponding icon pointer data. And the corresponding character string data is generated respectively for an item name and a data name constituting each related data. The corresponding code sequence is set in the “code sequence info” of said character string data, while the writing position thereof determined as below is set in the “position information” of said character data.

Writing position of the item name and the data name constituting a related data on document can be determined, for example as follows. First, regarding the data name of an arbitrary related data its writing position of the vertical direction is set as the position appropriately distant upward from the upper boundary of the matrix of said file managing table form, while its writing position of horizontal direction is determined with the left extremity of said character string appropriately distant leftward from the right boundary of the matrix of said file managing table form.

The item name corresponding to said data name which is positioned as above, is positioned in the same row (at the same height) with said data name character string, with its right extremity appropriately distant leftward from said data name character string. In the case a plurality of related data are recognized, for another arbitrary related data next fetched, its position can be determined so as to be appropriately distant upward from the position of related data last fetched.

Subsequently the symbols representing the “item name indicating” and “data name indicating” are written respectively added to the item name character string and the data name character string of each related data the writing position on the document of which are determined as above. For an item name character string, to write additionally, for example, the symbol “<” and “>” at the both extremity of said character string, first the both extremity of said character string is recognized, and then the adjacent position outside of said character string is determined as the writing position of the added symbols, then the corresponding character string data for each added symbol being generated. Also for the symbol representing the data name character string, the character string data representing it is generated in the same method.

Next, for the couple of the item name and the data name of each related data recognized as above, the item definition data is generated. The address of the character string data of said item name is set in the “item name character string address” of said item definition data, while the address of the character string data of said data name in the “beginning cell data address” of said item definition data. In addition the corresponding code info representing the key type set at the corresponding field of the work table is set in the “key type” of said icon definition data, and the code “1” representing “outside of the matrix” is set in the “disposing type” of the icon definition data. The icon definition data generated as above is stood in the predetermined location within the corresponding file data.

Thus the “common condition data” obtained for a pasting target file managing table form the corresponding icon of which is pasted onto another composite file managing table form, is recognized within the corresponding file data as the icon definition data the “disposing type” of which has the code “1” representing “outside of the matrix” set therein.

The method described above being used, also in the case a file managing table form constituting a composite file managing table form is fetched out of the composite file managing table form and is managed independently, the related data recognized for each file the icon of which are pasted on said file managing table form after the fetching, is just the total related data as it is without change, which are recognized for them on said composite file managing table form before the fetching.

In the case the icon of a file managing table form shown in F6 which is pasted in the cell located in the third row from the top and the second column from the left on the other file managing table form shown in F5, is for example dragged into a folder provided appropriately by a user, out of the corresponding table form management application screen, the related data recognized, for example for the cell in the icon disposing field located in the second row from the top and in the second column from the left on said fetched file managing table form, is also after the fetching by dragging operation, is the set of related data obtained as the sum by adding “NAGOYA for the item “BRANCH” and “YEAR2001” for the item “YEAR to the set consisting of “FIRST Q” for the item “QUARTER and “DOMESTIC” for the item “DESTINATION”, recognized from the matrix on said fetched file managing table form, that is, is the same as the total related data recognized for said cell before the fetching in the time said fetched file managing table form was pasted in said composite file managing table form.

Consequently in the case said fetched file managing table form being designated as the copy source, each icon pasted thereon is copied again into the file managing table form shown in FIG. 19, an icon pasted in the cell in the icon disposing field on the second row from the top and on the second column from the left described above, is copied into the cell in the icon disposing field in the second row from the top and in the third column from the left on said copy destination table form, as is the same as formerly in the time said icon was disposed in said composite managing table form.

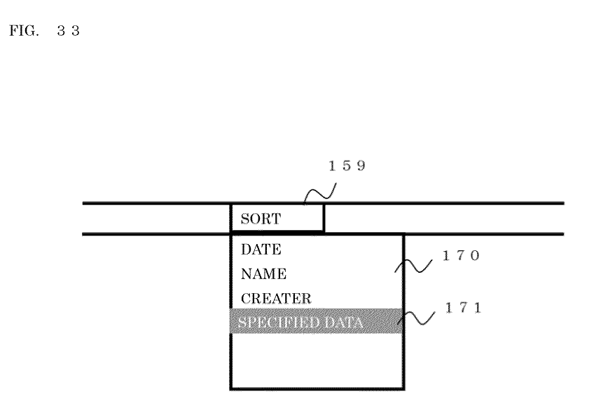

In the case there are a plurality of table forms on which the common condition are defined, another table form is generated automatically, on which for each of said table forms the common condition data of it and the icon representing it are disposed in a mutual positional relation the both of which are referenced at the same time based on a disposing rule of table form. For example for each table form commonly with the format shown in F6, the common condition of which is for the item “YEAR” and BRANCH”, respectively “YEAR2001” and “TOKYO”, “YEAR2001 and “OSAKA”, or “YEAR2002” and “OSAKA”, the corresponding icon is disposed in the form shown in FIG. 32.

A user drags a group of icons representing the table forms which the he wants to display, into a table form management application screen 33, and then clicks the “sort” button 159 always displayed on said screen, the “sort ordering menu 170” shown in FIG. 33 is displayed. When the “designated data order” button 171 in the “sort ordering menu 170” is clicked, the table form management application program executes the next seq.

First the common condition of the table form represented each icons dragged into the corresponding table form management application screen, is recognized, and then the data of each item belonging to the common condition data is listed up from the corresponding table form. In the example now explained, the data “YEAR2001” and “YEAR2002” are listed up for the item YEAR”, while the data “TOKYO” and “OSAKA” are listed up for the item “BRANCH”.

If the number of the item constituting the common condition is two in the example now explained, the direction of data for each item is assigned appropriately to the vertical direction or the horizontal direction, and a matrix consisting of cells is generated and written in the appropriate place on the document, wherein the number of the constituting cells in the vertical direction or in the horizontal direction is respectively the number of the data of the item assigned to the corresponding direction.

Next among the data listed up for each item name, the data belonging to the item the data disposing direction of which is assigned to the horizontal direction, are disposed and written respectively in the appropriate order within a row adjacent upward to the matrix of the table form, while the data belonging to the item the data disposing direction of which is assigned to be the vertical direction, are disposed respectively in the same way within a column adjacent leftward to the matrix.

Next for each icon to be disposed, the column including the corresponding data to said icon on the row adjacent upward to the matrix, and the row including the corresponding data to said icon on the column adjacent leftward to the matrix, are recognized, then said icon being disposed in the cell at the intersection of the column with the row above recognized.

In the case the number of item names constituting the common condition data is three or four, in the other row adjacent upward or in the other column adjacent leftward to the data sequence for the appropriately selected two item names disposed as above, the data sequence of the remaining item name is respectively disposed, wherein for each data disposed now, the whole of the data sequence disposed previously adjacent downward or rightward to said newly disposed data sequence, is copied repeatedly within the same row or column. In the case the number of item names constituting the common condition data is more than four, the above proceeding is repeated.

For each icon, the column including the data corresponding to said icon in each data sequence disposed horizontally upward to the table form matrix, and the row including the data corresponding to said icon in each data sequence disposed vertically leftward to the table form matrix, are recognized, then in the cell at the intersection of said column with said row, said icon being disposed.

As described above, for a file managing table form for which the common condition data is defined, the icon representing it can be disposed automatically on another file managing table form. As the method of copying icons disposed on a file managing table form into another file managing table form, the icon representing the file managing table form of the copy source itself can be copied into the copy destination file managing table form so as to attain the purpose, instead of the method described above wherein each managing target icon on the file managing table form of the copy source is fetched and copied one by one into a recognized cell on the destination. First the common condition data of a copy target file managing table form is recognized. The common condition data of the file managing table form can be recognized as the data provided with the item definition classified into “outside of the matrix” as described above on a file managing table form made by a user, or can also be generated by the system in the method the icon representing said file managing table form is disposed into another file managing table form as described above.

As described above an icon can be copied onto another file managing table form including a composite file managing table form based on the related data recognized on a file managing table form onto which said icon is pasted. In the case the copy target is a file managing table form, the icon of said file managing table form is copied into the appropriate copy destination, based on the common condition data for said file managing table form recognized as described above, regarded as the corresponding related data.

For example in the case a copying of managed icons between file managing table forms is designated by a user, wherein the composite file managing table form the beginning file managing table form of which is the file managing table form shown in F5, is the copy destination, while the file managing table form shown in FIG. 31 is the copy target, the icon of said file managing table form of the copy destination can be found on said beginning file managing table form on the ground that the set of the item names defined on the beginning file managing table form of the composite file managing table form of the copy destination (“BRANCH” and “YEAR”), equals to the set of the item names of the “common condition data” on the copy target file managing table form (“BRANCH” and “YEAR”), (that is, the set of the item names of said beginning file managing table form is the most large set included by the set of the item names constituting said common condition data)

On said beginning file managing table form, the related data for the cell on the third row and the second column (“YEAR2001” for the item “YEAR”, “NAGOYA” the item “BRANCH”) equal to (include) the common condition data of the copy target file managing table form (“YEAR2001” for the item “YEAR”, “NAGOYA” for the item “BRANCH”), then said cell being recognized as the copy destination position for the icon of said copy target file managing table form.

In many composite file managing table form, each file managing table form which constitutes it and belongs to the same layer, has the same format as in the above example wherein into all cells within the icon disposing field of the table form shown in F5, icons of table forms of the same format shown in F6 are pasted.

Owing to the fact in a composite file managing table form all file managing table forms belonging to the same layer have the same format, the same related data can be recognized for the cell located at the same relative position of each file managing table form belonging to the same layer, so that a user can achieve a easy-to-understand multi-item management of files.

The same format between file managing table forms mentioned herein means that a data field of the same item name is located in the same position in each file managing table form.

Consequently in making a composite file managing table form, by adding a kind of copy operation to an icon which represents a file managing table form and is pasted into a cell of another file managing table form, a user can make the system generate automatically file managing table forms having the same format as the format of the file managing table form represented by said icon, an then paste the icon representing each generated file managing table form into each of the other cells within the icon disposing field of said file managing table form wherein said icon is pasted.

For example of user operation, a user clicks an icon representing an arbitrary file managing table form previously pasted into a cell within icon disposing field of another file managing table form, and subsequently clicks the “copy” button 153 located in the upper part of the screen, first each of the other cells within said icon disposing field, a file data representing a file managing table form of the same format as said copied file managing table form and the corresponding icon definition information are respectively generated, and then a icon pointer data indicating said icon definition information is set in the corresponding cell data. Into said file data generated for each cell, the character string data, the line data and the item definition data generated for said copied file managing table form are whole copied.

In addition the method below can also be employed, that is, for each cell within the icon disposing field of all file managing table forms belonging to the same layer with said file managing table form into which said copied icon is pasted in the corresponding composite file managing table form, the table form having the same format as the format of said copied file managing table form can be generated, then an icon representing said generated file managing table form being pasted into the corresponding cell. Herein the same layer in a means the sameness of the number of the intermediate file managing table forms followed to reach the corresponding file managing table form from the top file managing table form.

In said composite file managing table form, each file managing table form belonging to the same layer as the layer of said file managing table form on which said copied icon is pasted, is fetched sequentially, and then for each cell within the icon disposing field of said fetched file managing table form, a file data representing the same format as the format of said copied file managing table form, and a corresponding icon definition information are generated by the same method, then the address of the icon pointer data indicating said icon definition information being set in the corresponding cell data.

In a composite file managing table form the method of fetching all constituent file managing table form and of recognizing the layer of each of said fetched file managing table forms in it, has variously became known publicly. For example, the number of times of following the next file managing table form by the above method sequentially from said file managing table form to the top file managing table form, is counted, wherein in each time the file managing table form onto which the icon of the current file managing table form is pasted, is recognized as the next file managing table form.

In addition, therein for the cell into which the icon of said file managing table form copied as above, is pasted, the total related data can be recognized from the whole of said composite file managing table form, and then being appended to the corresponding file data as the “common condition data” of the table form represented by said copied icon as described above. Further the recognized “common condition data” can be written and displayed in the form of the couple consisting of an item name and a data name in a position outside of the matrix of the table form as described above.

The present invention uses a program or software for implementing the above functions of the present invention. This software maybe installed into the system of the present invention through an arbitrary medium, for example, an accumulation medium or online. Therefore, embodiments of the present invention include an act of delivering an accumulation medium having stored thereon software for implementing the present invention for business purposes and an act of installing the software into the system online.

1. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;
said method comprising the steps of:
repeating a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;
recognizing the sum of the related data recognized on each file managing table form followed as above, as the total related data to be referenced as the attribute of an icon in said cell selected first;
recognizing the cell on a second file managing table form specially provided into which an icon in said cell designated first on said hierarchical file managing table form is to be copied or moved, or the cell on said second file managing table form an icon in which is to be moved or copied into said cell on said hierarchical file managing table form,
by comparing the total related data above recognized with related data recognized for each cell within the icon disposing field on said second file managing table form; and
copying or moving said icon between said cell on said hierarchical file managing table form and said cell on the second file managing table form.

2. The method of claim 1, further comprising the steps of:
recognizing the total related data for each icon recognized sequentially in a first hierarchical file managing table form, that represents file information other than those of the type of file managing table form;
recognizing the total related data for each cell within the icon disposing field of each file managing table form of the lowest layer in a second hierarchical file managing table form, recognized sequentially; and
copying or moving said icon from said first hierarchical file managing table form into said second hierarchical file managing table form.

3. The method of claim 1, further comprising the steps of:
recognizing the total related data for each icon recognized sequentially in a first hierarchical file managing table form, that represents file information other than those of the type of file managing table form;
setting the top file managing table form of a second hierarchical file managing table form provided in addition as the icon disposing destination, as the “existing file managing table form” that is a processing target of the following steps;
judging if the set of item names constituting the related data defined on the “existing file managing table form” is not included by the set of item names constituting the total related data for an icon on said first hierarchical file managing table form;
if the above judgment is not obtained, reading index words for each cell within the icon disposing field of the “existing file managing table form” as the related data of an icon disposed in said cell based on a determined rule;
recognizing subsequently on the “existing file managing table form” a cell each related data for which includes the corresponding related data of the same item name for an icon of the first hierarchical file managing table form;
fetching subsequently as the “existing file managing table form”, the “child” file managing table form the icon of which is disposed in said recognized cell;
returning subsequently to the above judgment; and
if the above judgment is obtained, copying or moving said icon on said first hierarchical file managing table form into the corresponding cell in the “parent” file managing table form wherein the icon of the “existing file managing table form” is disposed.

4. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method outputting an icon to satisfy an outputting condition prepared in the form of the product of data for each item, from a hierarchical file managing table form that is obtained by repeating to paste an icon specified for a file managing table form onto another file managing table form,
wherein an icon of file information is managed located in a relation with index words of the table format defined as the related data representing the attribute of said file information;
said method comprising the steps of;
setting the top file managing table form as the existing file managing table form;
reading index words for each cell within the icon disposing field of said file managing table form” constituting said hierarchical file managing table form, as the related data of an icon disposed in said cell based on a determined rule;
recognizing on said file managing table form a cell each related data for which is included by the corresponding data of the same item name of the outputting condition, by comparing related data for each cell within the icon disposing field of said file managing table form with the corresponding data of the outputting condition regarding each item name;
judging if regarding all item names constituting the outputting condition, above comparison of data thereof with the corresponding data of each cell within the icon disposing field of each file managing table form fetched from said hierarchical file managing table form is not yet done;
if the above judgment is obtained, fetching another file managing table form represented by the icon disposed in said recognized cell on said file managing table form;
returning to the above step of reading index words on the existing file managing table form; and
else if the above judgment is not obtained, outputting the definition information represented by the icon disposed in said recognized cell on the existing file managing table form, into a specially provided area in the data memorizing means.

5. The method of claim 4, wherein the related data is recognized for each cell within the icon disposing field of a second file managing table form specially provided, and then an icon output from said hierarchical file managing table form is copied or moved into the appropriate cell on the second file managing table form based on the recognized related data for it as the outputting condition.

6. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;
said method comprising of the steps:
setting the top file managing table form of said hierarchical file managing table form, as the “existing file managing table form” that is a processing target of the following steps;
judging if the set of item names constituting the related data defined on the “existing file managing table form” is not included by the set of item names constituting the attribute data provided for said disposing target icon;
if the above judgment is not obtained, reading index words for each cell within the icon disposing field of the “existing file managing table form” as the related data of an icon disposed in said cell based on a determined rule;
recognizing subsequently on the “existing file managing table form” a cell each related data for which includes the corresponding data of the attribute data, provided for an disposing target icon;
fetching subsequently as the “existing file managing table form”, the “child” file managing table form the icon of which is disposed in said recognized cell;
returning subsequently to the above judgment; and
if the above judgment is obtained, copying or moving said disposing target icon into the corresponding cell in the “parent” file managing table form wherein the icon of the “existing file managing table form” is disposed.

7. The method of claim 6, wherein the related data is recognized for each cell within the icon disposing field of a second file managing table form specially provided, and then an icon disposed in each cell is copied or moved into the appropriate cell on the corresponding file managing table form included in said hierarchical file managing table form, based on the recognized related data for said cell as the attribute data condition of said icon.

8. The method of claim 6, further comprising the steps of:
displaying the file managing table form including the disposing destination cell in the screen, and
providing said disposing destination cell or the icon moved or copied therein with a special display.

9. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method copying or moving a icon representing a file managing table form onto another file managing table form,
wherein in a file managing table form, an icon is managed located in a relation with index words of the table format defined as the related data representing the attribute of said icon;
said method comprising the steps of:
recognizing as the attribute data of said file managing table form itself, data that is defined as the related data on a copy source file managing table form or a copy destination file managing table form, and further is written located apart from the matrix of the icon disposing field, and further located at a determined relational position with the icon disposing field;
recognizing subsequently on said copying destination file managing table form or said moving destination file managing table form, a cell each related data for which includes the corresponding data of said attribute data, by repeating a comparison of said attribute data with related data recognized for each cell within the icon disposing field of said destination file managing table form; and
copying or moving an icon representing said copying source file managing table form or said moving source file managing table form into the corresponding cell.

10. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method providing the common condition recognized for a file managing table form, wherein an icon is managed located in a relation with index words of the table form defined as the related data representing the attribute of said icon;
said method comprising the steps of:
receiving a copying or moving operation by a user of an icon representing a first file managing table form into the icon disposing field of a second file managing table form;
reading the index words for a cell that is the copying or moving destination of the disposing target icon representing the first file managing table form” on the second file managing table form, as the related data of said icon based on a determined rule;
providing the recognized related data with information that represents the related data distinguished from the other written information; and
writing said related data provided with the distinguishing information at the location that is apart from the icon disposing field and in the predetermined relation with the icon disposing field on the first file managing table form, the copying or moving target as the common condition data of said file managing table form.

11. The method of claim 1, wherein related data written at the corresponding position outside of the matrix of the table format on the first file managing table form is written in the form of the couple consisting of the item name and the data name, and further an written item name and a written data name is provided respectively with a specified indication that represents the item name or the data name.

12. A method in an information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said method making a hierarchical file managing table form that is obtained by repeating to paste an icon specified for a file managing table form onto another file managing table form,
wherein an icon of file information is managed located in a relation with index words of the table format defined as the related data representing the attribute of said file information;
said method comprising the steps of:
receiving a designation of a specified operation for a designated file managing table form constituting a first composite file managing table form;
recognizing each file managing table form belonging to the same layer as said designated file managing table form in the composite file managing table form;
generating a file data representing a second table form designated specially, for each cell within the icon disposing field of each file managing table form recognized above; and
disposing an icon corresponding to said file data in the corresponding cell.

13. A method in an information processing apparatus, having an user operation environment;
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;

14. An information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said apparatus copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;
said apparatus comprising:
a means that is repeats a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;
a means that recognizes the sum of the related data recognized on each file managing table form followed as above, as the total related data to be referenced as the attribute of an icon in said cell selected first;
a means that recognizes the cell on a second file managing table form specially provided into which an icon in said cell designated first on said hierarchical file managing table form is to be copied or moved, or the cell on said second file managing table form an icon in which is to be moved or copied into said cell on said hierarchical file managing table form,
by comparing the total related data above recognized with related data recognized for each cell within the icon disposing field on said second file managing table form; and
a means that copies or moves said icon between said cell on said hierarchical file managing table form and said cell on the second file managing table form.

15. An information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said apparatus outputting an icon to satisfy an outputting condition prepared in the form of the product of data for each item, from a hierarchical file managing table form that is obtained by repeating to paste an icon specified for a file managing table form onto another file managing table form,
wherein an icon of file information is managed located in a relation with index words of the table format defined as the related data representing the attribute of said file information;
said apparatus comprising:
a means that sets the top file managing table form as the existing file managing table form;
a means that reads index words for each cell within the icon disposing field of said file managing table form” constituting said hierarchical file managing table form, as the related data of an icon disposed in said cell based on a determined rule;
a means that recognizes on said file managing table form a cell each related data for which is included by the corresponding data of the same item name of the outputting condition, by comparing related data for each cell within the icon disposing field of said file managing table form with the corresponding data of the outputting condition regarding each item name;
a means that judges if regarding all item names constituting the outputting condition, above comparison of data thereof with the corresponding data of each cell within the icon disposing field of each file managing table form fetched from said hierarchical file managing table form is not yet done;
a means that fetches another file managing table form represented by the icon disposed in said recognized cell on said file managing table form if the above judgment is obtained;
a means that returns to the above step of reading index words on the existing file managing table form; and
a means that outputs the definition information represented by the icon disposed in said recognized cell on the existing file managing table form, into a specially provided area in the data memorizing means, else if the above judgment is not obtained.

16. An information processing apparatus, having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said apparatus copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;
said apparatus comprising:
a means that sets the top file managing table form of said hierarchical file managing table form, as the “existing file managing table form” that is a processing target of the following steps;
a means that judges if the set of item names constituting the related data defined on the “existing file managing table form” is not included by the set of item names constituting the attribute data provided for said disposing target icon;
a means that reads index words for each cell within the icon disposing field of the “existing file managing table form” as the related data of an icon disposed in said cell based on a determined rule if the above judgment is not obtained;
a means that recognizes subsequently on the “existing file managing table form” a cell each related data for which includes the corresponding data of the attribute data, provided for an disposing target icon;
a means that fetches subsequently as the “existing file managing table form”, the “child” file managing table form the icon of which is disposed in said recognized cell;
a means that returns subsequently to the above judgment; and
a means that copies or moves said disposing target icon into the corresponding cell in the “parent” file managing table form wherein the icon of the “existing file managing table form” is disposed if the above judgment is obtained.

17. A computer control program and/or a medium encoded with the program for use with a computer having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said program and/or a medium copying or moving a management target icon from/into a hierarchical file managing table form that is obtained by repeating to paste an icon specified for a file managing table form onto another file managing table form,
wherein an icon of file information is managed located in a relation with index words of the table format defined as the related data representing the attribute of said file information;
said program and/or a medium comprising the steps of :
repeating a process that recognizes the corresponding index words of the table format for a constituent cell within the icon disposing field of a file managing table form constituting said hierarchical file managing table form, based on a determined rule for the related data of the icon disposed in the cell, and then recognizes the parent file managing table form and the cell wherein the icon representing said file managing table form is disposed, from said file managing table form selected first to the top file managing table form of the hierarchical file managing table form;
recognizing the sum of the related data recognized on each file managing table form followed as above, as the total related data to be referenced as the attribute of an icon in said cell selected first;
recognizing the cell on a second file managing table form specially provided into which an icon in said cell designated first on said hierarchical file managing table form is to be copied or moved, or the cell on said second file managing table form an icon in which is to be moved or copied into said cell on said hierarchical file managing table form, by comparing the total related data above recognized with related data recognized for each cell within the icon disposing field on said second file managing table form; and
copying or moving said icon between said cell on said hierarchical file managing table form and said cell on the second file managing table form.

18. A computer control program and/or a medium encoded with the program for use with a computer having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said program and/or a medium outputting an icon to satisfy an outputting condition prepared in the form of the product of data for each item, from a hierarchical file managing table form that is obtained by repeating to paste an icon specified for a file managing table form onto another file managing table form,
wherein an icon of file information is managed located in a relation with index words of the table format defined as the related data representing the attribute of said file information;
said program and/or a medium comprising the steps of:
setting the top file managing table form as the existing file managing table form;
reading index words for each cell within the icon disposing field of said file managing table form” constituting said hierarchical file managing table form, as the related data of an icon disposed in said cell based on a determined rule;
recognizing on said file managing table form a cell each related data for which is included by the corresponding data of the same item name of the outputting condition, by comparing related data for each cell within the icon disposing field of said file managing table form with the corresponding data of the outputting condition regarding each item name;
judging if regarding all item names constituting the outputting condition, above comparison of data thereof with the corresponding data of each cell within the icon disposing field of each file managing table form fetched from said hierarchical file managing table form is not yet done;
if the above judgment is obtained, fetching another file managing table form represented by the icon disposed in said recognized cell on said file managing table form;
returning to the above step of reading index words on the existing file managing table form; and
else if the above judgment is not obtained, outputting the definition information represented by the icon disposed in said recognized cell on the existing file managing table form, into a specially provided area in the data memorizing means.

19. A computer control program and/or a medium encoded with the program for use with a computer having an user operation environment,
wherein file information is represented by an icon, that is an image specified for each type of file information on its display screen, and further by a specified designation to the corresponding icon by a user, is set in its memorizing means wherein the corresponding process can be executed, while a screen displaying the content of said file information is provided on its apparatus screen;
said program and/or a medium copying or moving an icon representing a file information specially prepared as the copying target, the attribute data of which are provided in the form of the product of data for each item, onto a hierarchical file managing table form that is obtained by repeating to paste an icon specified for a file managing table form onto another file managing table form,
wherein an icon of file information is managed located in a relation with index words of the table format defined as the related data representing the attribute of said file information;
said program and/or a medium comprising the steps of :
setting the top file managing table form of said hierarchical file managing table form, as the “existing file managing table form” that is a processing target of the following steps;
judging if the set of item names constituting the related data defined on the “existing file managing table form” is not included by the set of item names constituting the attribute data provided for said disposing target icon;
if the above judgment is not obtained, reading index words for each cell within the icon disposing field of the “existing file managing table form” as the related data of an icon disposed in said cell based on a determined rule;
recognizing subsequently on the “existing file managing table form” a cell each related data for which includes the corresponding data of the attribute data, provided for an disposing target icon;
fetching subsequently as the “existing file managing table form”, the “child” file managing table form the icon of which is disposed in said recognized cell;
returning subsequently to the above judgment; and
if the above judgment is obtained, copying or moving said disposing target icon into the corresponding cell in the “parent” file managing table form wherein the icon of the “existing file managing table form” is disposed.
